(19) United States
(12) Patent Application Publication
(10) Pub. No.: US 2026/0196001 A1
(43) Pub. Date: Jul. 9, 2026

(54) ENVIRONMENT PROCESSING FOR HEAD-MOUNTED SYSTEMS

(71) Applicant: Meta Platforms Technologies, LLC, Menlo Park, CA (US)

(72) Inventors: Vladimir Gluzman Peregrine, Hingham, MA (US); Daniel Rolf, Berlin (DE); Yoav Goldstein, Menlo Park, CA (US); Zachary Dawson, Menlo Park, CA (US); Andrew Kim, Vancouver (CA); Dhwaj Agrawal, Redwood City, CA (US); Diogo Cunha, Zurich (CH); Phillip Michael Simon, Oakland, CA (US); Stephen Madsen, Menlo Park, CA (US); Mohammad Keshavarzi, Zurich (CH); Marcelo Simoes Wolf, Zollikon (CH); Mantas Zurauskas, Redmond, WA (US); Jindou Shi, Redmond, WA (US)

(21) Appl. No.: 19/439,975

(22) Filed: Jan. 5, 2026

Related U.S. Application Data
(60) Provisional application No. 63/742,796, filed on Jan. 7, 2025.
(60) Provisional application No. 63/743,098, filed on Jan. 8, 2025.
(60) Provisional application No. 63/756,333, filed on Feb. 10, 2025.
(60) Provisional application No. 63/768,723, filed on Mar. 7, 2025.
(60) Provisional application No. 63/816,094, filed on Jun. 2, 2025.

(51) Int. Cl. G06T 19/00; G06F 21/32; G06T 19/20; G06V 20/20

(52) U.S. Cl. CPC G06T 19/006; G06F 21/32; G06T 19/20; G06V 20/20; G06T 2219/2004

(57) ABSTRACT

The disclosed systems and methods may include a method for client-side route computation using a partitioned, non-atomic way. Another method may include a method for server-side partitioned computation of z-curve-based polyline circle covers for a road network. Another method may include a method for generating and positioning interactive virtual trophies in artificial reality environments. Another method may include a method for interactive spatial reasoning-based mixed reality scene generation. Another method may include a method for biometric authentication using polarization-sensitive cameras. Various other methods, systems, and computer-readable media are also disclosed.

### CROSS REFERENCE TO RELATED APPLICATION

This application is a claims the benefit of U.S. Provisional Application No. 63/742,796, filed Jan. 7, 2025, U.S. Provisional Application No. 63/743,098, filed Jan. 8, 2025, U.S. Provisional Application No. 63/756,333, filed Feb. 10, 2025, U.S. Provisional Application No. 63/768,723, filed Mar. 7, 2025, and U.S. Provisional Application No. 63/816,094, filed Jun. 2, 2025, the disclosures of each of which are incorporated, in their entirety, by this reference.

### BRIEF DESCRIPTION OF THE DRAWINGS

The accompanying drawings illustrate a number of example embodiments and are a part of the specification. Together with the following description, these drawings demonstrate and explain various principles of the present disclosure.

FIG. 1 is a block diagram illustrating an example of a system architecture for client-side route computation using a partitioned, non-atomic way, according to some embodiments.

FIG. 2 is a flow diagram illustrating an example of an algorithm for client-side route computation using a partitioned, non-atomic way, according to some embodiments.

FIG. 3 is a block diagram illustrating an example of a system architecture for server-side partitioned computation of z-curve-based polyline circle covers for a road network, in accordance with some aspects of the subject technology.

FIG. 4 is a flow diagram illustrating an example of an algorithm for server-side partitioned computation of z-curve-based polyline circle covers for a road network, in accordance with some aspects of the subject technology.

FIG. 5 is a block diagram illustrating an overview of an environment in which some implementations of the disclosed technology can operate.

FIG. 6 shows a mixed reality interface which supports techniques for generating and positioning interactive virtual trophies in artificial reality environments in accordance with various aspects of the present disclosure.

FIG. 7 shows a mixed reality interface which supports techniques for generating and positioning interactive virtual trophies in artificial reality environments in accordance with various aspects of the present disclosure.

FIG. 8 illustrates an example of a process flow that supports generating and positioning interactive virtual trophies in artificial reality environments in accordance with various aspects of the present disclosure.

FIG. 9 shows a block diagram of an apparatus that supports generating and positioning interactive virtual trophies in artificial reality environments in accordance with various aspects of the present disclosure.

FIG. 10 shows a block diagram of a trophy positioning component that supports generating and positioning interactive virtual trophies in artificial reality environments in accordance with various aspects of the present disclosure.

FIG. 11 shows a diagram of a system including a device that supports generating and positioning interactive virtual trophies in artificial reality environments in accordance with various aspects of the present disclosure.

FIG. 12 shows a flowchart illustrating methods that support generating and positioning interactive virtual trophies in artificial reality environments in accordance with various aspects of the present disclosure.

FIG. 13 shows a flowchart illustrating methods that support generating and positioning interactive virtual trophies in artificial reality environments in accordance with various aspects of the present disclosure.

FIG. 14 shows a flowchart illustrating methods that support generating and positioning interactive virtual trophies in artificial reality environments in accordance with various aspects of the present disclosure.

FIG. 15 depicts a block diagram of an example configuration for interactive spatial reasoning-based mixed reality scene generation, in accordance with an illustrative embodiment.

FIG. 16 depicts a flowchart of an example process for interactive spatial reasoning-based mixed reality scene generation, in accordance with an illustrative embodiment.

FIG. 17 illustrates a flowchart of an example prediction flow for biometric authentication.

FIG. 18 is an illustration of an example artificial-reality system according to some embodiments of this disclosure.

FIG. 19 is an illustration of an example artificial-reality system with a handheld device according to some embodiments of this disclosure.

FIG. 20A is an illustration of example user interactions within an artificial-reality system according to some embodiments of this disclosure.

FIG. 20B is an illustration of example user interactions within an artificial-reality system according to some embodiments of this disclosure.

FIG. 21A is an illustration of example user interactions within an artificial-reality system according to some embodiments of this disclosure.

FIG. 21B is an illustration of example user interactions within an artificial-reality system according to some embodiments of this disclosure.

FIG. 22 is an illustration of an example wrist-wearable device of an artificial-reality system according to some embodiments of this disclosure.

FIG. 23 is an illustration of an example wearable artificial-reality system according to some embodiments of this disclosure.

FIG. 24 is an illustration of an example augmented-reality system according to some embodiments of this disclosure.

FIG. 25A is an illustration of an example virtual-reality system according to some embodiments of this disclosure.

FIG. 25B is an illustration of another perspective of the virtual-reality systems shown in FIG. 25A.

FIG. 26 is a block diagram showing system components of example artificial- and virtual-reality systems.

FIG. 27A is an illustration of an example intermediary processing device according to embodiments of this disclosure.

FIG. 27B is a perspective view of the intermediary processing device shown in FIG. 27A.

FIG. 28 is a block diagram showing example components of the intermediary processing device illustrated in FIGS. 27A and 27B.

FIG. 29A is front view of an example haptic feedback device according to embodiments of this disclosure.

FIG. 29B is a back view of the example haptic feedback device shown in FIG.

FIG. 29A according to embodiments of this disclosure.

FIG. 30 is a block diagram of example components of a haptic feedback device according to embodiments of this disclosure.

FIG. 31 an illustration of an example system that incorporates an eye-tracking subsystem capable of tracking a user's eye(s).

FIG. 32 is a more detailed illustration of various aspects of the eye-tracking subsystem illustrated in FIG. 31.

FIG. 33 is an illustration of an example fluidic control system that may be used in connection with embodiments of this disclosure.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within the scope of the appended claims.

### DETAILED DESCRIPTION OF EXAMPLE EMBODIMENTS

Features from any of the embodiments described herein may be used in combination with one another in accordance with the general principles described herein. These and other embodiments, features, and advantages will be more fully understood upon reading the following detailed description in conjunction with the accompanying drawings and claims.

### Client-Side Route Computation Using a Partitioned, Non-Atomic Way

Routing graphs for extensive geographic regions, such as entire continents, present significant challenges due to the vast amount of data involved. Computing, storing, and distributing these graphs to clients can be resource-intensive, often requiring substantial computational power and storage capacity. One effective solution to this problem is partitioning the routing graphs. By dividing the graphs into smaller, more manageable partitions, it becomes possible to leverage distributed processing techniques, such as MapReduce, to compute these partitions more efficiently. This approach not only accelerates the computation process but also facilitates the delivery of routing data to clients in smaller, more digestible segments as needed.

However, partitioning routing graphs introduces its own set of challenges, particularly when it comes to ensuring efficient computation of routes that span multiple partitions. A key issue is avoiding excessive data duplication while maintaining the ability to compute cross-partition routes seamlessly. Effective strategies must be developed to manage the boundaries between partitions, ensuring that the routing information remains accurate and efficient without redundant data storage. This requires sophisticated algorithms and data structures that can handle the complexity of cross-partition routing, ensuring that the overall system remains scalable and efficient even as the geographic scope of the routing graph expands.

The subject disclosure is directed to a pedestrian routing graph for use with smart glasses and head-mount devices (HMDs) to power the routing to these devices. The subject disclosure is directed to a pedestrian routing graph for use with smart glasses and HMDs to power the routing of these devices. Routing graphs for wide geographic areas (e.g., an entire continent) can be resource-intensive to compute, store and distribute to clients because they involve lots of data. Enabling them to be partitioned can enable them to be computed more quickly using distributed processing such as map-reduce and delivered to clients in small partitions as needed. The challenge is how to ensure routes that cross partition boundaries can still be computed efficiently and without excessive data duplication.

In some implementations, the subject technology retrieves partitions from the Internet. Then the ways and nodes are retrieved from a partition. Finally routing graphs are routed on partitioned routing. The subject technology has several industrial applications, for example, in logistics or courier application to help delivery drivers and/or couriers walk from a vehicle to the specific location where a package needs to be dropped off.

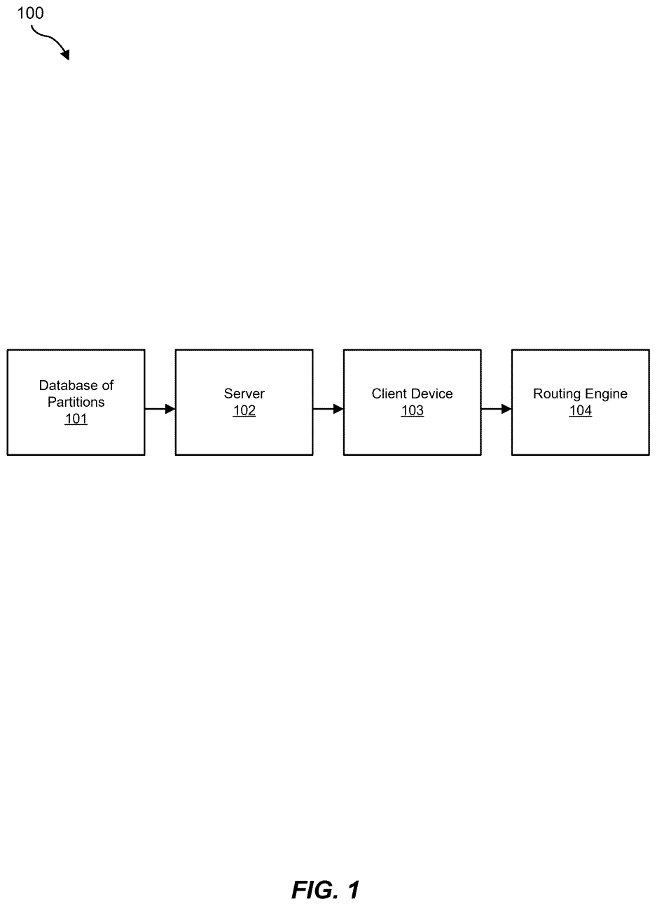

FIG. 1 is a block diagram illustrating an example of a system architecture 100 for client-side route computation using a partitioned, non-atomic way, according to some embodiments. The system includes one or more servers 102 coupled to a database of partitions 101 and a client 103 (e.g., a smart phone, an HMD, computer, tablet, and so on) including a routing engine 104.

In some implementations, the data can be served partition-by-partition to the client on the server, for example, by the following:
getPartitionFromServerByID(ID):
   1. RESULT=request server to send Partition with ID
   2. Return RESULT
getPartitionFromServerByPoint(POINT):
   1. RESULT=[ ]
   2. For each PARTITION:
   a. If PARTITION contains POINT:
      i. Add PARTITION to RESULT
   3. Return RESULT

Alternately, multiple partitions can be served at a time by using an ID:
getPartitionsFromServerByIDs (IDS):
   1. RESULT=request server to send Partitions with ID in IDS
   2. Return RESULT

It should be noted that querying by point or geometry can be optimized by using geospatial indexing techniques such as r-trees or quadtrees.

In some implementations, ways and nodes are retrieved from a partition, as described below. A partition contains a database of Nodes and Ways. One can define the following method:
getRoutingNodeFromPartition (PARTITION, ID):
1. RESULT=read RoutingNode with ID from PARTITION.database
2. Return RESULT
getRoutingWayFromPartition (PARTITION, ID):
1. RESULT=read RoutingWay with ID from PARTITION.database
2. Return RESULTds:

In some implementations, routing can be done on a partitioned routing graph. Given an origin and a destination is as nodes in the routing graph, the following algorithm can be used to compute a route between them:
1. Run Dijkstra's algorithm on the following virtual graph:
a. Start vertex=ORIGIN_NODE_ID
b. End vertex=DESTINATION_NODE_ID
c. Expand vertex=(NODE_ID):
i. RESULT=[ ]//empty array
ii. PARTITION=getPartitionFromServerByPoint (NODE.coordinates)
iii. NODE=getRoutingNodeFromPartition (PARTITION, NODE_ID)
iv. For each WAY_ID in NODE.WAYS:
1. WAY=getRoutingWayFromPartition (PARTITION, WAY_ID)
2. For each ADJACENT_NODE_ID that precedes or succeeds NODE_ID in WAY.NODES:
a. Add ADJACENT_NODE_ID to RESULT
v. Return RESULT

It is noted that 1) Instead of retrieving individual partitions on the fly, we can also use getPartitionsFromServerByGeometry( ) once to fetch all partitions relevant to a given route computation (for example, a bounding box), and use a local cache to retrieve the routing node and ways. 2) Because of how ways and nodes were assigned to partitions, we are guaranteed that a partition fetched by a node's coordinates will include any ways that contain the node.

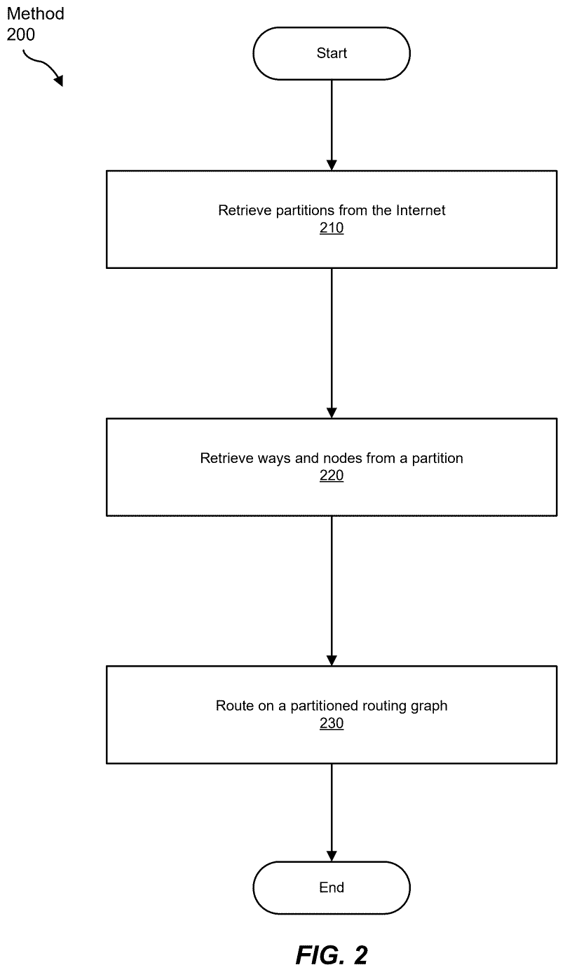

FIG. 2 is a flow diagram illustrating an example of an algorithm 200 for client-side route computation using a partitioned, non-atomic way, according to some embodiments. The algorithm 200 includes process steps 210 to 230.

In process step 210, partitions are retrieved from the Internet, as described above. In this context, a partition can be understood as a segment or subset of data that has been divided for easier management and processing. This is common in distributed systems where data is split into partitions to improve efficiency and scalability. These partitions are often stored across multiple servers or nodes, and the technology retrieves them as needed.

In process step 220, the ways and nodes are retrieved from a partition, as described above. Once a partition is retrieved, the next step involves extracting ways and nodes from it. In graph theory and network analysis, a node represents a point or vertex, while a way represents a connection or edge between nodes. For example, in mapping applications, nodes could represent locations, and ways could represent roads connecting these locations. The technology processes the partition to identify and extract these elements, which are essential for constructing a graph.

In process step 230, routing graphs are routed on partitioned routing. These graphs are then used for partitioned routing, which involves determining the optimal paths or routes within the partitioned data. This method is particularly useful in large-scale networks where routing needs to be efficient and scalable. By partitioning the data and routing within these partitions, the system can manage and navigate complex networks more effectively.

### Server-Side Partitioned Computation of Z-Curve-Based Polyline Circle Covers for a Road Network

Road networks and derived data products for wide geographic areas, for example, an entire continent, can be resource-intensive to process and distribute to clients because they involve lots of data. In navigation, this also applies to the general problem of locating a geo-coordinate on the road network. This problem is also known as reverse-geocoding or point-matching.

Road networks and the data products derived from them, especially those covering extensive geographic areas like entire continents, present significant challenges in terms of processing and distribution due to the sheer volume of data involved. This complexity is particularly evident in navigation systems, where the task of pinpointing a specific geo-coordinate on a road network, commonly referred to as reverse-geocoding or point-matching, is a notable example. The resource-intensive nature of these processes underscores the need for efficient solutions to manage and utilize such vast amounts of data effectively.

The subject disclosure is directed to a solution for applying z-curve-based polyline circle covers to partitioned road networks. Road networks and derived data products for wide geographic areas such as an entire continent can be resource-intensive to process and distribute to clients because they involve lots of data. In navigation, this also applies to the general problem of locating a geo-coordinate on the road network. This problem is also known as reverse-geocoding or point-matching. The subject technique applies Z-curve-based polyline circle covers to partitioned road networks. A common challenge with partitioned data sets is to ensure accurate results in areas near partition boundaries. The subject technology can be useful for any pedestrian navigation application and logistics or courier systems to help delivery drivers and/or couriers walk from a vehicle to the specific location where a package needs to be dropped off.

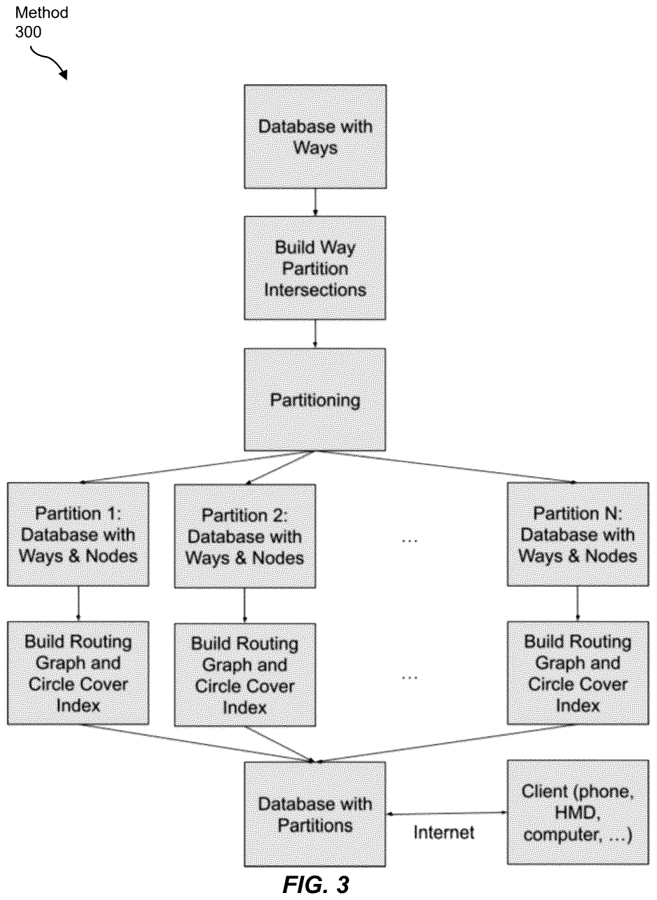

FIG. 3 is a block diagram illustrating an example of a system architecture 300 for server-side partitioned computation of z-curve-based polyline circle covers for a road network, in accordance with some aspects of the subject technology. The system includes a database of ways, based on which build-way partition intersections are derived and used in partitioning the road network. The partitioning includes building a number of partitions such as partition 1, partition 2 . . . partition N. In each partition, two databases are formed. The first database is a database formed with ways and nodes and the second database is a database formed of a routing graph and a circle cover index. The databases of partition 1, partition 2 . . . partition N are collectively used in a database with partitions, which also receives data from a client (e.g., a phone, an HMD, a computer, and the like) over the Internet.

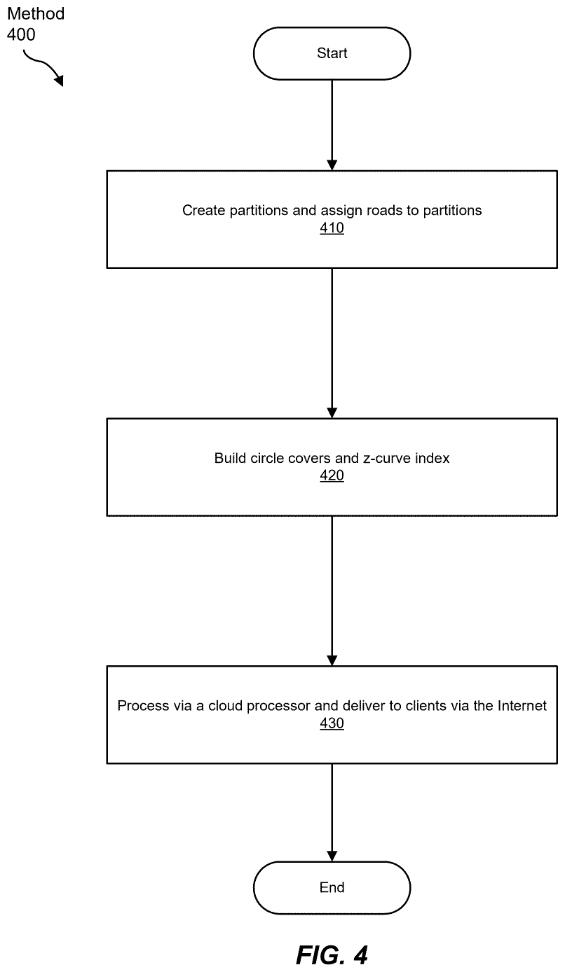

FIG. 4 is a flow diagram illustrating an example of an algorithm 400 for server-side partitioned computation of z-curve-based polyline circle covers for a road network, in accordance with some aspects of the subject technology. The algorithm 400 includes process steps 410, 420 and 430.

In process step 410, partitioning and assigning roads to partitions is completed. The definition of a partitioning scheme and the approach to assigning roads to partitions are described in a patent application entitled “client-side route computation using a partitioned, non-atomic way.”

In process step 420, circle covers and a z-curve index are built. The z-curve index is a method used in computer science to map multidimensional data to one dimension while preserving the locality of the data points. This is achieved by interleaving the binary representations of the coordinates of the points. For example, for a point ((x, y)) with binary coordinates (x=1010) and (y=0110), the z-curve index would interleave these to form (10011010).

In process step 430, cloud processing and delivery to clients via the Internet are performed. Given a database of roads, potentially covering a wide area, the database is partitioned and then an indexer is run to compute a circle-cover index for each partition and store them in a database. A partition can be a continent, country, state, city, or a grid-tile. A server in the cloud will transfer the index for a given region to a client on-demand.

### Generating and Positioning Interactive Virtual Trophies in Artificial Reality Environments

In the field of interactive media and gaming, users may engage with artificial reality technologies, such as virtual reality and mixed reality, to experience immersive digital worlds. These technologies may allow users to interact with virtual objects and elements that are overlaid upon or integrated within their perception of the physical world. Virtual trophies, which may serve as rewards for user achievements within software applications, may be presented within these artificial reality spaces. Users may receive these trophies based on specific accomplishments and may view them within the context of a virtual space. The technologies may also support real-time interaction and social connectivity, enabling users to share and experience content simultaneously with others. The artificial reality platforms may provide a means for users to input commands and make selections that influence their digital surroundings, potentially altering the placement and appearance of virtual objects within the interactive space.

A method for generating and positioning interactive virtual trophies in artificial reality environments is described. The method may include generating a virtual trophy based on an achievement by a first user in a software application, wherein the virtual trophy is unique to the achievement. The method may include providing a virtual environment to the first user through a first device. The method may include receiving an input from the first user, the input comprising a location within the virtual environment. The method may include positioning the virtual trophy within the virtual environment at the location in response to receiving the input. The method may include providing the virtual environment to a second user through a second device, wherein the first user and the second user both perceive the virtual trophy to be positioned at the location within the virtual environment.

A system configured for generating and positioning interactive virtual trophies in artificial reality environments is described. The system may include a processor and memory coupled with the processor. The system may include instructions stored in the memory and executable by the processor to cause the system to generate a virtual trophy based on an achievement by a first user in a software application, wherein the virtual trophy is unique to the achievement. The instructions when executed by the processor may further cause the system to provide a virtual environment to the first user through a first device and receive an input from the first user, the input comprising a location within the virtual environment. The instructions when executed by the processor may further cause the system to position the virtual trophy within the virtual environment at the location in response to receiving the input. The instructions when executed by the processor may further cause the system to provide the virtual environment to a second user through a second device, wherein the first user and the second user both perceive the virtual trophy to be positioned at the location within the virtual environment.

Another system for generating and positioning interactive virtual trophies in artificial reality environments is described. The system may include means for generating a virtual trophy based on an achievement by a first user in a software application, wherein the virtual trophy is unique to the achievement. The system may include means for providing a virtual environment to the first user through a first device. The system may include means for receiving an input from the first user, the input comprising a location within the virtual environment. The system may include means for positioning the virtual trophy within the virtual environment at the location within the virtual environment in response to receiving the input. The system may include means for providing the virtual environment to a second user through a second device, wherein the first user and the second user both perceive the virtual trophy to be positioned at the location within the virtual environment.

A non-transitory computer-readable medium storing code for generating and positioning interactive virtual trophies in artificial reality environments is described. The code may include instructions executable by a processor to generate a virtual trophy based on an achievement by a first user in a software application, wherein the virtual trophy is unique to the achievement. The code may include instructions executable by a processor to provide a virtual environment to the first user through a first device. The code may include instructions executable by a processor to receive an input from the first user, the input comprising a location within the virtual environment. The code may include instructions executable by a processor to position the virtual trophy within the virtual environment at the location in response to receiving the input. The code may include instructions executable by a processor to provide the virtual environment to a second user through a second device, wherein the first user and the second user both perceive the virtual trophy to be positioned at the location within the virtual environment.

Some examples of the method, systems, and non-transitory computer-readable medium described herein may further include operations, features, means, or instructions for receiving a second input from the first user, the second input comprising a second location within the virtual environment. In response to receiving the second input, the virtual trophy may be positioned within the virtual environment at the second location within the virtual environment, wherein the first user and the second user both perceive the virtual trophy to be positioned at the second location within the virtual environment.

In some examples of the method, systems, and non-transitory computer-readable medium described herein, the virtual environment may be a virtual reality environment.

In some examples of the method, systems, and non-transitory computer-readable medium described herein, the virtual environment may be a mixed reality environment.

In some examples of the method, systems, and non-transitory computer-readable medium described herein, the location may be a fixed location within the virtual environment.

In some examples of the method, systems, and non-transitory computer-readable medium described herein, the location may be a changing location within the virtual environment.

In some examples of the method, systems, and non-transitory computer-readable medium described herein, the location may be attached to an avatar of the first user, and the virtual trophy may be a wearable item by the avatar of the first user.

Some examples of the method, systems, and non-transitory computer-readable medium described herein may further include operations, features, means, or instructions for providing the virtual environment to a third user through a third device. A particular interaction of the third user with the virtual trophy may be received, and in response to the particular interaction, a particular action from a plurality of actions associated with the trophy may be performed.

In some examples of the method, systems, and non-transitory computer-readable medium described herein, the interaction may comprise an interaction between an avatar of the third user within the virtual environment and the virtual trophy.

In some examples of the method, systems, and non-transitory computer-readable medium described herein, the plurality of actions associated with the trophy may comprise showing a video to the third user illustrating how the first user obtained the achievement to earn the virtual trophy.

In some examples of the method, systems, and non-transitory computer-readable medium described herein, the plurality of actions associated with the trophy may comprise determining that the third user has installed the software application on the third device, and based on that determination, launching the software application on the third device.

In some examples of the method, systems, and non-transitory computer-readable medium described herein, the plurality of actions associated with the trophy may comprise determining that the third user does not have access to the software application and based on that determination, launching a marketplace to provide the software application to the third user to install on the third device.

In some examples of the method, systems, and non-transitory computer-readable medium described herein, the virtual trophy may be generated by the software application in the virtual environment using an application programming interface.

In some examples of the method, systems, and non-transitory computer-readable medium described herein, the virtual trophy may include a visual effect that is activated in response to the first user achieving a predetermined milestone within the software application.

In some examples of the method, systems, and non-transitory computer-readable medium described herein, the virtual trophy may display a leaderboard ranking the first user relative to other users in the software application, in response to the first user's interaction with the trophy.

In some examples of the method, systems, and non-transitory computer-readable medium described herein, the virtual trophy may emit an audible sound effect in response to the first user's proximity within the virtual environment.

In some examples of the method, systems, and non-transitory computer-readable medium described herein, the virtual trophy may be configured to update its appearance in response to subsequent achievements by the first user in the software application.

In some examples of the method, systems, and non-transitory computer-readable medium described herein, the virtual trophy may be associated with a set of virtual items that the first user can deploy within the virtual environment.

The subject disclosure provides for systems and methods for generating and positioning interactive virtual trophies in artificial reality environments. In some examples, the existing approach to virtual trophies in software applications may be limited in its capacity to engage users beyond a superficial level. The static nature of these trophies may not take advantage of the interactive and immersive capabilities offered by modern virtual reality and mixed reality technologies. As a result, there may be a missed opportunity to deepen user engagement, enhance social connectivity, and provide a more rewarding experience within virtual environments. Furthermore, the current implementation of virtual trophies may not allow for dynamic interaction or real-time sharing between users, which could otherwise promote a sense of community and collaborative achievement. This gap in the virtual experience may leave users wanting more meaningful and interactive ways to celebrate their achievements and share them with others in the virtual space.

Implementations disclosed herein address these and other problems. In some examples, a method may allow for the generation, customization, and dynamic positioning of unique virtual trophies within virtual reality and mixed reality environments. This method may enable users to interact with their achievements in a more meaningful way, as the trophies are no longer static icons but become integrated elements of the virtual world that can be placed, shared, and interacted with in real time.

By incorporating user inputs to determine the location and context of the virtual trophies, some implementations may facilitate a personalized and immersive experience. Users may place trophies at specific locations within the virtual environment, attach them to avatars as wearable items, or even set them to change location dynamically. This level of customization may enhance the sense of presence and achievement within the virtual space.

Moreover, some implementations may allow for interactive features where other users can engage with the trophies, triggering a variety of context-specific actions. These actions could include displaying a video of how the achievement was earned, launching the associated software application, or directing users to a marketplace to obtain the application. Such interactions not only may enrich the user experience but also may foster social connections by enabling users to share their accomplishments and engage with others' achievements within the virtual environment. This approach may effectively transform virtual trophies from mere symbols of achievement into interactive, social objects that contribute to a more engaging and connected virtual experience.

According to some implementations, a system may include a variety of physical components that work together to create an artificial reality environment. This environment may be experienced through devices such as headsets or glasses that allow users to see and interact with digital elements as if they were part of the real world. Users may have the ability to place digital objects, referred to as virtual trophies, within this environment. These trophies may represent achievements and can be positioned at different locations within the artificial reality space. The system may include input devices, like controllers or gloves, that enable users to select where to place these trophies in the environment.

The system may also facilitate interactions between users and the virtual trophies. For instance, a user wearing the appropriate device may reach out and touch a trophy, causing it to react in some way. This reaction may vary depending on the context and the way the user interacts with the trophy. The system may allow for these trophies to be shared with other users. This sharing may occur within the same artificial reality environment, enabling multiple users to see and interact with the same digital objects simultaneously.

Furthermore, some implementations may include features that allow virtual trophies to be more than just static objects. They may be designed to be wearable or to move with the user within the artificial reality environment. For example, a trophy could appear as an accessory on a user's digital representation, known as an avatar. The system may support a range of interactions, such as other users viewing a video related to the trophy's achievement or launching a related software application. These features may enhance the level of engagement and social interaction within the artificial reality environment.

Aspects of the subject matter described in this disclosure can be implemented to realize one or more of the following potential advantages. The described techniques may be implemented to support enhanced user engagement through the creation of unique virtual trophies that may be personalized to represent individual achievements within a software application. These trophies may be interactively positioned within a virtual environment, allowing users to customize their virtual space and reflect their accomplishments. The system may enable a dynamic interaction where virtual trophies may trigger a variety of actions, such as displaying achievement-related content or initiating software applications, thereby enriching the user experience. The ability to share these trophies with others may foster social connections and collaborative experiences within the virtual environment. The adaptability of the virtual trophies, including their potential to be wearable or to change location, may provide a more immersive and versatile interaction for users, potentially increasing the sense of presence within the virtual environment.

Embodiments of the disclosed technology may include or be implemented in conjunction with an artificial reality system. Artificial reality, extended reality, or extra reality (collectively “XR”) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some implementations, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. AR also refers to systems where light entering a user's eye is partially generated by a computing system and partially composes light reflected off objects in the real world. For example, an AR headset could be shaped as a pair of glasses with a pass-through display, which allows light from the real world to pass through a waveguide that simultaneously emits light from a projector in the AR headset, allowing the AR headset to present virtual objects intermixed with the real objects the user can see. The AR headset may be a block-light headset with video pass-through. “Artificial reality,” “extra reality,” or “XR,” as used herein, refers to any of VR, AR, MR, or any combination or hybrid thereof.

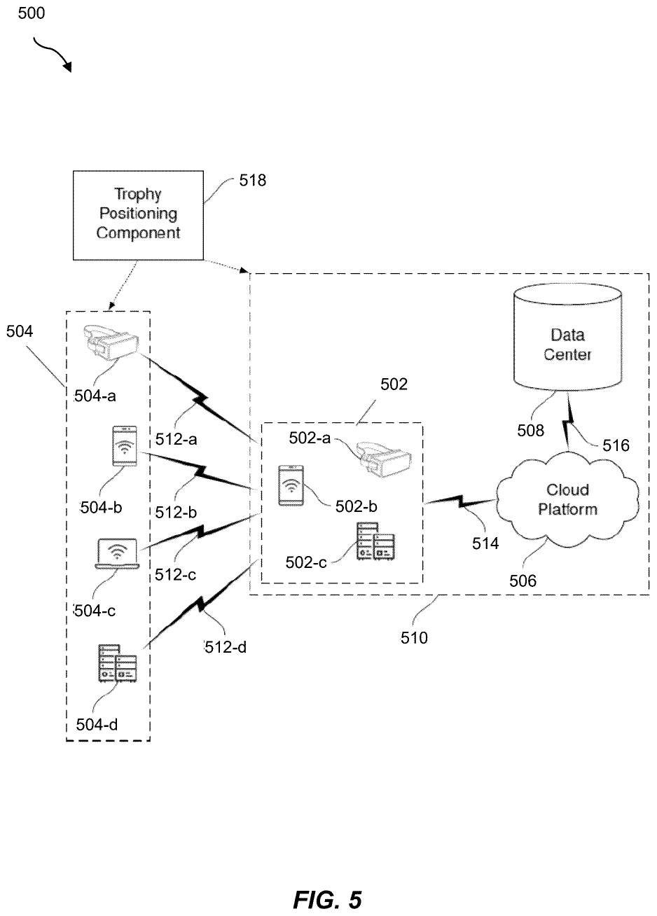

FIG. 5 illustrates an example of a system 500 that supports generating and positioning interactive virtual trophies in artificial reality environments in accordance with various aspects of the present disclosure. The system 500 may include the computing system 100 of FIG. 1 and/or one or more components thereof. The system 500 includes cloud clients 502 (e.g., 502-a, 502-b, 502-c), user devices 504 (e.g., 504-a, 504-b, 504-c, 504-d), a cloud platform 506, and a data center 508. Cloud platform 506 may be an example of a public or private cloud network. A cloud client 502 may access cloud platform 506 over a network connection 514. The network connection 514 may include a wired connection, a wireless connection, or both. The network may implement transfer control protocol and internet protocol (TCP/IP), such as the Internet, or may implement other network protocols. A cloud client 502 may be an example of a computing device, such as a headset (e.g., cloud client 502-a), a smartphone (e.g., cloud client 502-b), a server (e.g., cloud client 502-c), or a wearable computer (e.g., the HMD 200 or the HMD system 216). In other examples, a cloud client 502 may be a desktop computer, a laptop, a tablet, a sensor, a wearable headset, or another computing device or system capable of generating, analyzing, transmitting, or receiving communications. In some examples, a cloud client 502 may be part of a business, an enterprise, a non-profit, a startup, or any other organization type.

A cloud client 502 may facilitate communication between the data center 508 and one or multiple user devices 504 to implement an online environment. The network connection 512 (e.g., 512-a, 512-b, 512-c, 512-d) may include communications, opportunities, purchases, sales, or any other interaction between a cloud client 502 and a user device 504. The network connection 512 may include a wired connection, a wireless connection, or both. A cloud client 502 may access cloud platform 506 to store, manage, and process the data communicated via one or more network connections 512. In some cases, the cloud client 502 may have an associated security or permission level. A cloud client 502 may have access to certain applications, data, and database information within cloud platform 506 based on the associated security or permission level, and may not have access to others.

The user device 504 may include a trophy positioning component 518. The user device 504 may interact with the cloud client 502 over network connection 512. The network may implement transfer control protocol and internet protocol (TCP/IP), such as the Internet, or may implement other network protocols. The network connection 512 may facilitate transport of data via email, web, text messages, mail, or any other appropriate form of electronic interaction (e.g., network connections 512-a, 512-b, 512-c, and 512-d) via a computer network. In some implementations, the user device 504 may be the HMD 200 or the HMD system 216. In some implementations, the user device 504 may be a computing device such as a headset 504-a, a smartphone 504-b, and also may be a laptop 504-c, a server 504-d, and/or other wearable or non-wearable computing devices. In other cases, the user device 504 may be another computing system. In some cases, the user device 504 may be operated by a user or group of users. The user or group of users may be a customer, associated with a business, a manufacturer, or any other appropriate organization.

Cloud platform 506 may offer an on-demand database service to the cloud client 502. In some cases, cloud platform 506 may be an example of a multi-tenant database system. In this case, cloud platform 506 may serve multiple cloud clients 502 with a single instance of software. However, other types of systems may be implemented, including—but not limited to-client-server systems, mobile device systems, and mobile network systems. In some cases, cloud platform 506 may support an online application. This may include support for sales between buyers and sellers operating user devices 504, service, marketing of products posted by buyers, community interactions between buyers and sellers, analytics, such as user-interaction metrics, applications (e.g., computer vision and machine learning), and the Internet of Things (IoT). Cloud platform 506 may receive data associated with generation of an online environment from the cloud client 502 over network connection 514 and may store and analyze the data. In some cases, cloud platform 506 may receive data directly from a user device 504 and the cloud client 502. In some cases, the cloud client 502 may develop applications to run on cloud platform 506. Cloud platform 506 may be implemented using remote servers. In some cases, the remote servers may be located at one or more data centers 508.

Data center 508 may include multiple servers. The multiple servers may be used for data storage, management, and processing. Data center 508 may receive data from cloud platform 506 via connection 516, or directly from the cloud client 502 or via network connection 512 between a user device 504 and the cloud client 502. The connection 516 may include a wired connection, a wireless connection, or both. Data center 508 may utilize multiple redundancies for security purposes. In some cases, the data stored at data center 508 may be backed up by copies of the data at a different data center (not pictured).

Server system 510 may include cloud clients 502, a cloud platform 506, a trophy positioning component 518, and a data center 508 that may coordinate with cloud platform 506 and data center 508 to implement an online environment. In some cases, data processing may occur at any of the components of server system 510, or at a combination of these components. Thus, the trophy positioning component 518 may be included in the user device 504, server system 510, or in part or in whole in both. In some cases, servers may perform the data processing. The servers may be a cloud client 502 or located at data center 508.

Some or all of the functionality attributed to the trophy positioning component 518 may be embodied or performed by one or more user devices 504, one or more components of server system 510 (e.g., cloud clients 502, a cloud platform 506, and/or a data center 508), and/or other components of system 500. The trophy positioning component 518 may receive signals and inputs from user device 504 directly via cloud clients 502, and/or via cloud platform 506 or data center 508.

In some implementations, the trophy positioning component 518 may receive inputs from a first user through a user device 504, which may include specifying a location within an artificial reality environment for placing a virtual trophy. The trophy positioning component 518 may then facilitate the placement of the virtual trophy at the specified location within the artificial reality environment, allowing the first user to interact with the trophy as part of their immersive experience. The trophy positioning component 518 may also enable the virtual trophy to be perceived by a second user at the same location within the artificial reality environment when the environment is provided to the second user through a second user device 504.

Furthermore, the trophy positioning component 518 may interact with the cloud platform 506 and the data center 508 to manage and process data related to the virtual trophies. This interaction may include transmitting information about the virtual trophies' positions and states within the artificial reality environment. The trophy positioning component 518 may also receive updates or changes to the virtual trophies' positions based on further inputs from users via the user device 504. These updates may be processed in coordination with the cloud clients 502, which may facilitate communication between the user device 504 and the cloud platform 506 over the network connection 512, ensuring that the virtual trophies remain consistent and up-to-date across multiple user devices 504 within the system 500.

It should be appreciated by a person skilled in the art that one or more aspects of the disclosure may be implemented in the system 100 and/or the system 500 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

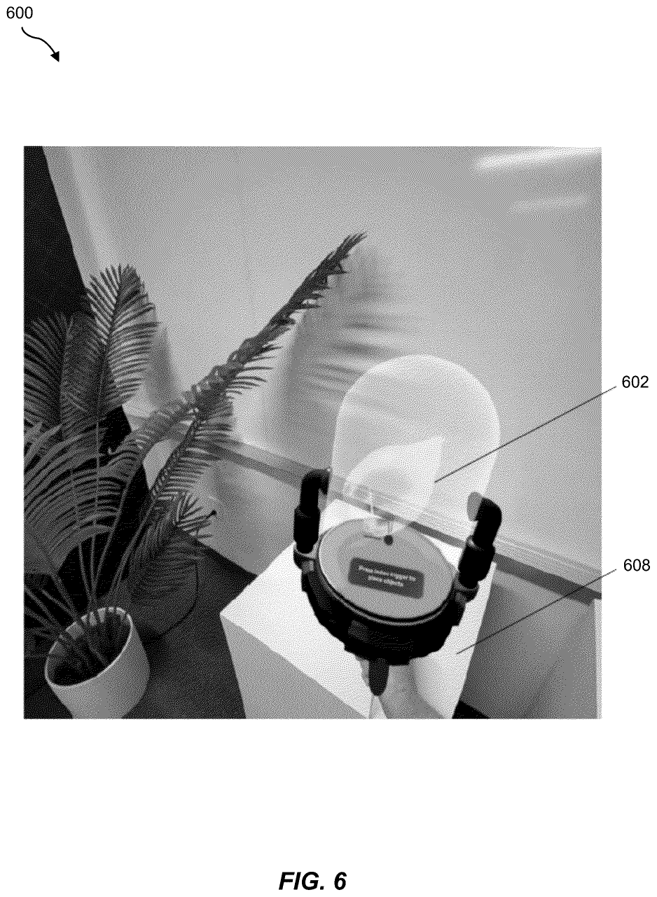

FIG. 6 shows mixed reality placement 600 which supports techniques for generating and positioning interactive virtual trophies in mixed reality environments in accordance with various aspects of the present disclosure. As depicted in FIG. 6, the mixed reality placement 600 may include one or more of a virtual trophy 602, a device, a virtual environment boundary, a pedestal 608, and/or other components.

The virtual trophy 602 may represent a digital reward that is visually unique and corresponds to an achievement within a software application. The virtual trophy 602 may be generated by the software application using an application programming interface. The virtual trophy 602 may be perceived by multiple users within the mixed reality environment to be positioned at a specific location. Examples of the virtual trophy 602 may include wearables for avatars or trophies that can be placed within the environment.

The device may provide the computational power necessary to facilitate the mixed reality environment where the virtual trophy 602 is placed. The device may be a first device through which a first user interacts with the mixed reality environment. The mixed reality placement 600 may receive inputs from the user to determine the location of the virtual trophy 602 within the mixed reality environment. Alternative forms of the device may include various types of mixed reality headsets or handheld devices.

The virtual environment boundary may define the spatial limits within which the virtual trophy 602 can be positioned and interacted with. The virtual environment boundary may be a fixed or changing area within the mixed reality environment. The virtual environment boundary may determine the range of movement for an avatar that is associated with the virtual trophy 602. An example of the virtual environment boundary could be a delineated play area in a user's living space.

The pedestal 608 may serve as a virtual stand on which the virtual trophy 602 can be displayed within the mixed reality environment. The pedestal 608 may be positioned at a fixed location or may be movable within the virtual environment boundary. The pedestal 608 may provide a platform for the virtual trophy 602 that distinguishes it from other objects in the mixed reality environment. An illustrative example of the pedestal 608 could be a virtual column or a showcase stand.

In some implementations, the components of the mixed reality placement 600 may operate together to create an interactive and immersive experience for users. The virtual trophy 602 may be positioned within the virtual environment boundary using inputs received by the device. The pedestal 608 may provide a designated space for the virtual trophy 602, enhancing its visibility and prominence within the mixed reality environment. The virtual trophy 602 may trigger context-sensitive actions when interacted with by users, which may include launching applications or displaying content related to the achievement the trophy represents. These interactions may occur within the confines of the virtual environment boundary, ensuring that the virtual trophy 602 remains an integral part of the mixed reality experience.

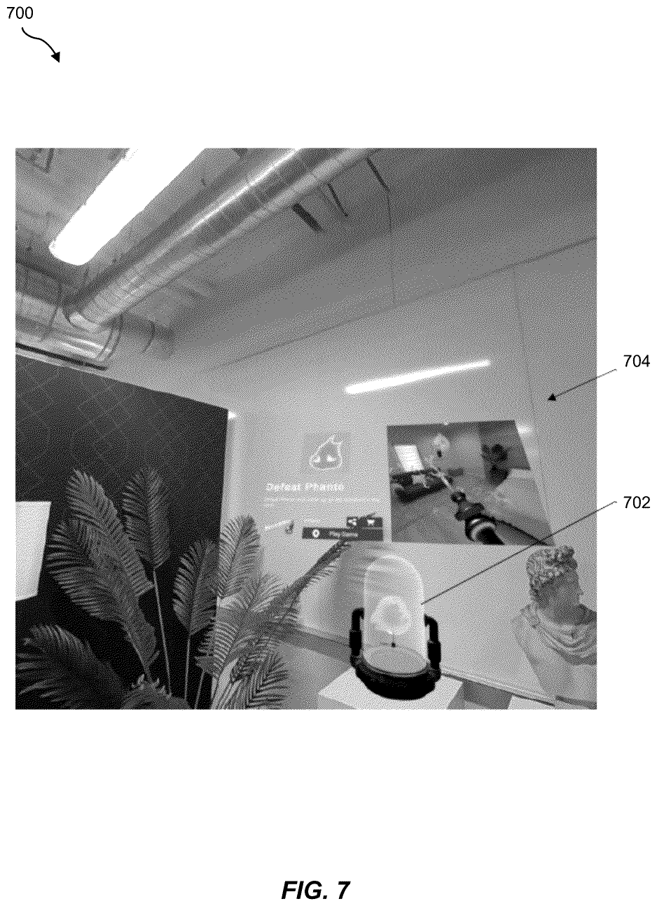

FIG. 7 shows a mixed reality interface 700 that supports techniques for generating and positioning interactive virtual trophies in mixed reality environments in accordance with various aspects of the present disclosure. As depicted in FIG. 7, the mixed reality interface 700 may include one or more of a virtual trophy 702, a virtual environment 704, a mixed reality device, a virtual interactive button, and/or other components.

The virtual trophy 702 may represent a digital award that is generated within the mixed reality interface 700 based on user achievements. The virtual trophy 702 may be unique to the achievement it represents. The virtual trophy 702 may be perceived by users within the virtual environment 704. In some implementations, the virtual trophy 702 may be a wearable item by an avatar of a user. Examples of the virtual trophy 702 may include a digital representation of a cup, medal, or other emblematic object.

The virtual environment 704 may provide a digital space where users can interact with the virtual trophy 702 and other virtual objects. The virtual environment 704 may be a virtual reality or mixed reality space. The virtual environment 704 may allow for the positioning of the virtual trophy 702 at a specific location. In some implementations, the virtual environment 704 may be experienced through a variety of devices such as VR headsets or AR glasses. An example of the virtual environment 704 may be a digital room or landscape where users can navigate and place objects.

The mixed reality device may enable users to experience and interact with the mixed reality interface 700 and its components. The mixed reality device may be a first device through which a first user perceives the virtual environment 704. The mixed reality device may receive inputs from the user to interact with the virtual environment 704. In some implementations, the mixed reality device may be a headset, glasses, or a mobile device equipped with mixed reality capabilities. An alternative to the mixed reality device may be a computer system with a display and input devices configured for mixed reality interactions.

The virtual interactive button may allow users to perform actions within the mixed reality interface 700, such as placing or moving the virtual trophy 702. The virtual interactive button may be an element within the virtual environment 704 that users can interact with. The virtual interactive button may trigger a variety of actions when activated by a user. In some implementations, the virtual interactive button may be a virtual object that resembles a button or switch. Examples of actions that may be triggered by the virtual interactive button include launching an application, initiating a video, or sharing content with other users.

In some implementations, the components of the mixed reality interface 700 may operate together to facilitate the generation and positioning of virtual trophies 702 within the virtual environment 704. The mixed reality device may be used to perceive and interact with the virtual environment 704, which may include the virtual trophy 702 that can be placed at specific locations by users. The virtual interactive button may be employed to trigger context-sensitive actions related to the virtual trophy 702, such as displaying how the achievement was earned or launching related software applications. The virtual trophy 702 may be created using an application programming interface that allows for the integration of the trophy into the virtual environment 704 and the association of actions with the trophy, which other users may trigger through interaction.

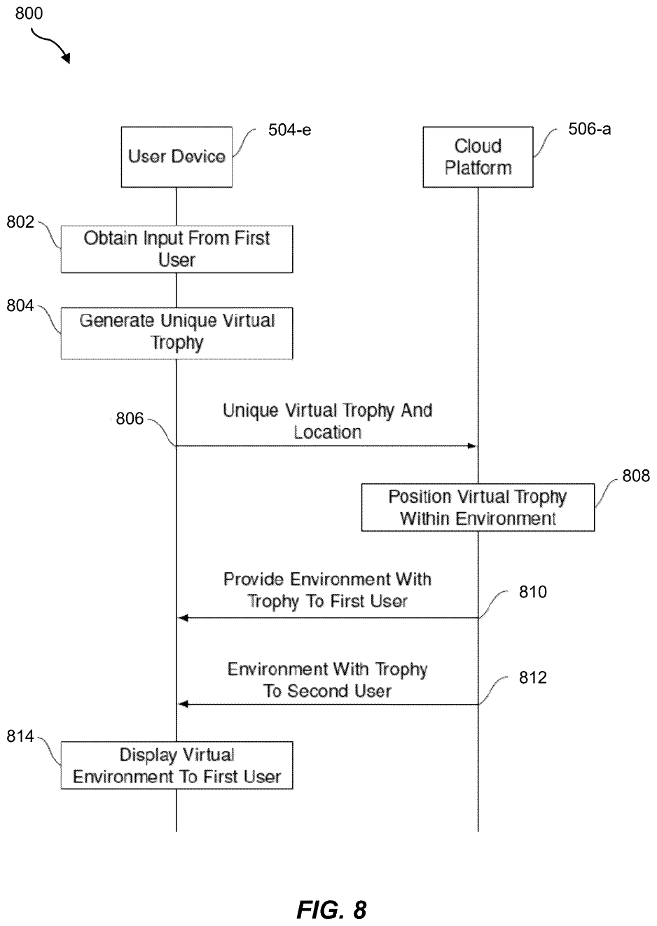

FIG. 8 illustrates an example of a process flow 800 that supports generating and positioning interactive virtual trophies in artificial reality environments in accordance with aspects of the present disclosure. In some examples, the process flow 800 may implement aspects of the system 100 and/or the system 500. For example, the process flow 800 may include a user device 504-e and a cloud platform 506-a, which may be examples of corresponding devices described herein. In some implementations, the method involves user device 504-e generating a unique virtual trophy based on an achievement and positioning it within a virtual environment upon receiving location input from the first user, while cloud platform 506-a facilitates the shared perception of the positioned trophy by both the first and second users through their respective devices.

At 802, the user device 504-e may obtain an input from the first user, the input comprising a location within the virtual environment. For example, the input may be a selection made by the first user on a graphical user interface of the user device 504-e, indicating a specific coordinate or area within the virtual environment where the first user desires to place a virtual object. In some implementations, the user device 504-e may receive a voice command from the first user as the input, where the first user verbally specifies the location within the virtual environment. Alternatively, the user device 504-e may detect a gesture made by the first user in the physical space, which is then translated into a corresponding location within the virtual environment for placing the virtual object.

At 804, the user device 504-e may generate a virtual trophy that is unique to an achievement by the first user in a software application. For example, the virtual trophy may be a three-dimensional object that represents a specific milestone reached within the software application, such as completing a difficult level or achieving a high score. In some implementations, the user device 504-e may allow the first user to customize the appearance of the virtual trophy, offering various designs and colors to choose from. The user device 504-e may also enable the first user to assign a special animation to the virtual trophy, which can be activated when the trophy is viewed by other users within the virtual environment.

At 806, the user device 504-e may transmit the unique virtual trophy and the location within the virtual environment to the cloud platform 506-a. For example, the user device 504-e may transmit data indicating that the virtual trophy is positioned on a virtual pedestal within the virtual environment. In some implementations, the user device 504-e may transmit additional metadata associated with the virtual trophy, such as the date and time the trophy was earned or the specific achievement it represents. Alternatively, the user device 504-e may transmit a request to the cloud platform 506-a to update the virtual trophy's appearance or to animate it within the virtual environment based on user interactions or environmental changes.

At 808, the cloud platform 506-a may position the virtual trophy within the virtual environment at the location received from the user device 504-e. For example, the cloud platform 506-a may receive coordinates from the user device 504-e that specify a particular area within the virtual environment where the virtual trophy is to be displayed. In some implementations, the cloud platform 506-a may allow the virtual trophy to be positioned on a virtual pedestal or shelf that the user device 504-e has created within the virtual environment. Alternatively, the cloud platform 506-a may enable the virtual trophy to be attached to a virtual avatar that represents the first user in the virtual environment, so that the trophy moves with the avatar as it navigates through the virtual space.

At 810, the cloud platform 506-a may provide the virtual environment with the positioned virtual trophy to the user device 504-e for the first user. For example, in some implementations, the cloud platform 506-a may determine the appropriate virtual environment based on the preferences set by the first user on the user device 504-e. In another instance, the cloud platform 506-a may update the virtual environment to reflect changes made by the first user, such as repositioning the virtual trophy within the environment. Additionally, the cloud platform 506-a may synchronize the virtual environment across multiple user devices, such as user device 504-e and another user device, ensuring that each user may view the virtual trophy in its updated location within the virtual environment.

At 812, the cloud platform 506-a may transmit the virtual environment with the positioned virtual trophy to a second user through a second device. For example, the cloud platform 506-a may transmit the virtual environment to the second user's device 504-e, which may be a virtual reality headset or a mixed reality device, allowing the second user to perceive the virtual trophy within their own immersive experience. In some implementations, the cloud platform 506-a may transmit additional data about the virtual trophy, such as its history or the achievements associated with it, to enhance the second user's understanding of the trophy's significance. Alternatively, the cloud platform 506-a may transmit the virtual environment with the virtual trophy to multiple devices simultaneously, allowing a group of users to view and interact with the trophy in a shared virtual space.

At 814, the user device 504-e may display the virtual environment to the first user, wherein the first user perceives the virtual trophy to be positioned at the location within the virtual environment. For example, the user device 504-e may render the virtual trophy with a high degree of visual fidelity, such that the virtual trophy may appear to have a reflective surface that glints as the first user or other users move within the virtual environment. In some implementations, the user device 504-e may allow the first user to interact with the virtual trophy, such as rotating or resizing the trophy within the virtual environment. Alternatively, the user device 504-e may enable the virtual trophy to exhibit dynamic behaviors, like emitting a glow or sound when the first user or other users approach its location within the virtual environment.

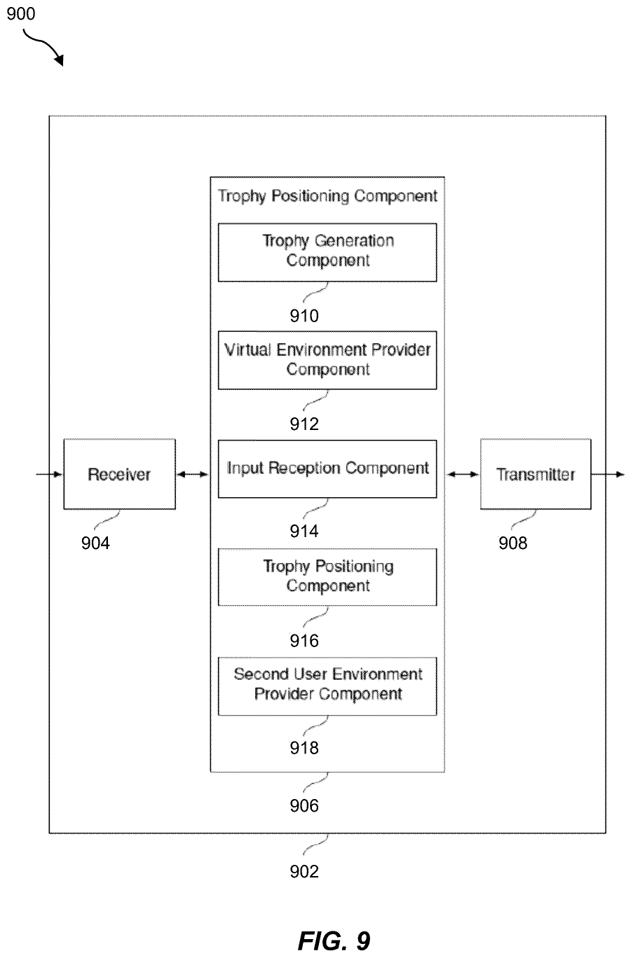

FIG. 9 shows a block diagram 900 of an apparatus 902 that supports generating and positioning interactive virtual trophies in artificial reality environments in accordance with various aspects of the present disclosure. The apparatus 902 may include an input module 904 (equivalently referred herein to as a receiver), trophy positioning component 906, and an output module 908 (equivalently referred to herein as a transmitter). The apparatus 902 may also include a processor. Each of these components may be in communication with one another (e.g., via one or more buses). In some cases, the apparatus 902 may be an example of a user terminal, a database server, or a system containing multiple computing devices.

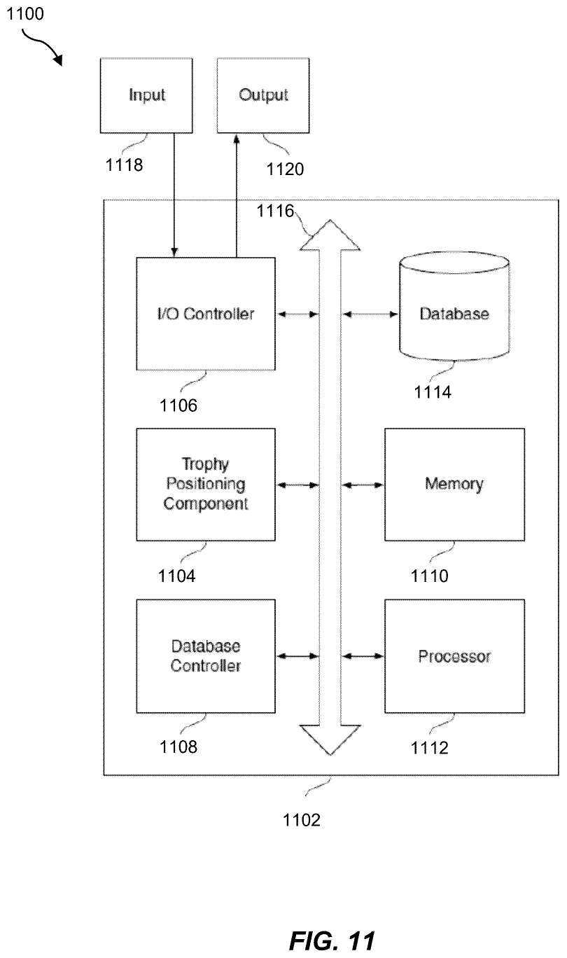

The input module 904 may manage input signals for the apparatus 902. For example, the input module 904 may identify input signals based on an interaction with a modem, a keyboard, a mouse, a touchscreen, or a similar device. These input signals may be associated with user input or processing at other components or devices. In some cases, the input module 904 may utilize an operating system such as iOS®, ANDROID®, MS-DOS®, MS-WINDOWS®, OS/2®, UNIX®, LINUX®, or another known operating system to handle input signals. The input module 904 may send aspects of these input signals to other components of the apparatus 902 for processing. For example, the input module 904 may transmit input signals to the trophy positioning component 906 to support face detection to address privacy in publishing image datasets. In some cases, the input module 904 may be a component of an input/output (I/O) controller 1106 as described with reference to FIG. 11.

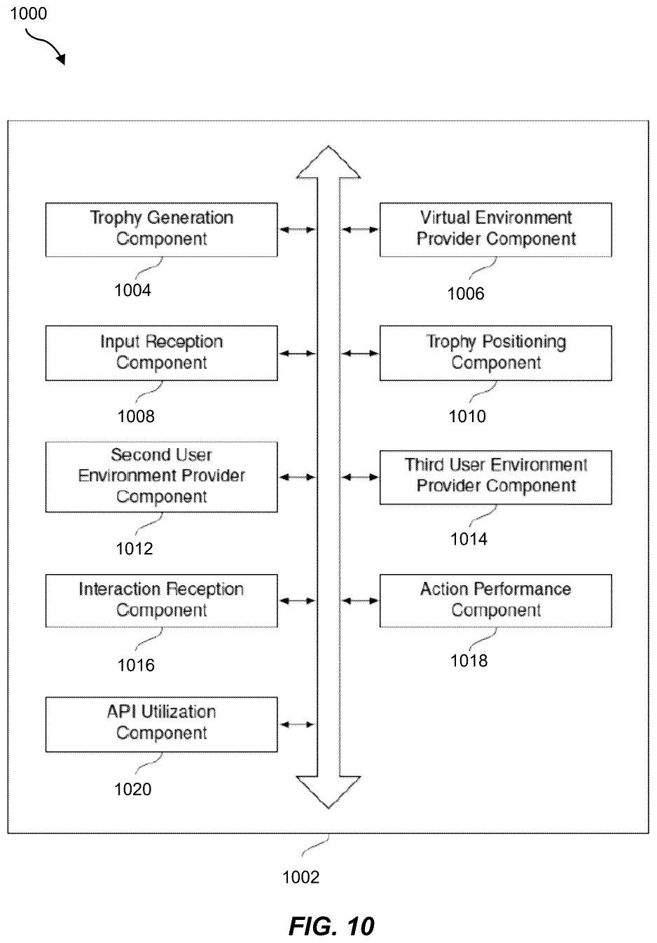

The trophy positioning component 906 may include one or more of a trophy generation component 910, a virtual environment provider component 912, an input reception component 914, a trophy positioning component 916, a second user environment provider component 918, and/or other components. The trophy positioning component 906 may be an example of aspects of the apparatus 1002 or device 1102 described with reference to FIGS. 10 and 9.

The trophy generation component 910 may be configured as or otherwise support a means for generating a virtual trophy based on an achievement by a first user in a software application, where the virtual trophy corresponds to the achievement. The virtual environment provider component 912 may be configured as or otherwise support a means for providing a virtual environment to the first user through a first device. The input reception component 914 (equivalently referred to herein as a receiver) may be configured as or otherwise support a means for receiving an input from the first user, where the input includes a location within the virtual environment. The trophy positioning component 916 may be configured as or otherwise support a means for positioning the virtual trophy within the virtual environment at the location specified by the first user's input. The second user environment provider component 918 may be configured as or otherwise support a means for providing the virtual environment to a second user through a second device, wherein both the first user and the second user perceive the virtual trophy to be positioned at the same location within the virtual environment.

The output module 908 (equivalently referred to herein as a transmitter) may manage output signals for the apparatus 902. For example, the output module 908 may receive signals from other components of the apparatus 902, such as the trophy positioning component 906, and may transmit these signals to other components or devices. In some specific examples, the output module 908 may transmit output signals for display in a user interface, for storage in a database or data store, for further processing at a server or server cluster, or for any other processes at any number of devices or systems. In some cases, the output module 908 may be a component of an I/O controller 1106 as described with reference to FIG. 11.

FIG. 10 shows a block diagram 1000 of an apparatus 1002 that supports generating and positioning interactive virtual trophies in artificial reality environments in accordance with various aspects of the present disclosure. The apparatus 1002 may be an example of aspects of an apparatus 902, a device 1102, or both, as described herein. The apparatus 1002, or various components thereof, may be an example of means for performing various aspects of generating and positioning interactive virtual trophies in artificial reality environments as described herein. For example, the apparatus 1002 may include one or more of a trophy generation component 1004, a virtual environment provider component 1006, an input reception component 1008, a trophy positioning component 1010, a second user environment provider component 1012, a third user environment provider component 1014, an interaction reception component 1016, an action performance component 1018, an API utilization component 1020, and/or other components. Each of these components may communicate, directly or indirectly, with one another (e.g., via one or more buses).

The trophy generation component 1004 may be configured as or otherwise support a means for generating, based on an achievement by a first user in a software application, a virtual trophy that is unique to the achievement. In some implementations, the trophy generation component 1004 may utilize an application programming interface to create the virtual trophy within the virtual environment. The virtual trophy may be designed to reflect the nature of the achievement, such as having a distinct shape or color that signifies the specific accomplishment of the first user.

In some implementations, the trophy generation component 1004 may allow for the customization of the virtual trophy by the first user. The first user may select from a variety of visual enhancements or features to personalize the trophy, which may include engravings, animations, or special effects that are displayed when the trophy is viewed within the virtual environment. The virtual trophy may be stored within a digital inventory or collection associated with the first user's profile in the software application, allowing the first user to access and display the trophy at their discretion within the virtual environment.

The virtual environment provider component 1006 may be configured as or otherwise support a means for providing a virtual environment to the first user through a first device. In some implementations, the virtual environment provider component 1006 may support various types of virtual environments, such as virtual reality or mixed reality environments. The virtual environment provider component 1006 may enable the first user to interact with the virtual environment in a manner that is consistent with the user's actions within the physical world.

The input reception component 1008 may be configured as or otherwise support a means for receiving an input from the first user, the input comprising a location within the virtual environment. In some implementations, the input reception component 1008 may receive a selection from the first user indicating a specific coordinate within the virtual environment where the virtual trophy may be placed. The input reception component 1008 may process gestures or voice commands as the input to determine the desired location for the virtual trophy.

The trophy positioning component 1010 may be configured as or otherwise support a means for positioning the virtual trophy within the virtual environment at the location within the virtual environment in response to receiving the input from the first user. In some implementations, the trophy positioning component 1010 may allow the first user to move the virtual trophy to a different location within the virtual environment if the first user decides to change its position. The trophy positioning component 1010 may also enable the virtual trophy to be positioned in a manner that reflects the status or achievement it represents, such as placing it on a virtual pedestal or shelf within the virtual environment. The trophy positioning component 1010 may support various input methods from the first user, including voice commands, gestures, or interactions with a virtual interface to determine the desired location for the virtual trophy.

The second user environment provider component 1012 may be configured as or otherwise support a means for providing the virtual environment to a second user through a second device, wherein the first user and the second user both may perceive the virtual trophy to be positioned at the location within the virtual environment. In some implementations, the second user may access the virtual environment using a variety of devices such as VR headsets, AR glasses, or mobile devices with AR capabilities. The second user environment provider component 1012 may allow for synchronization of the virtual environment between multiple users so that changes made by one user may be visible to others in real time. The virtual environment provided to the second user may include interactive elements that the second user may engage with, including the virtual trophy earned by the first user.

In some examples, the input reception component 1008 may be configured as or otherwise support a means for receiving a second input from the first user, the second input comprising a second location within the virtual environment. In some implementations, the input reception component 1008 may receive the second input through a gesture or voice command from the first user. The input reception component 1008 may also be capable of receiving the second input via a controller or a touch interface. The second location within the virtual environment may be determined by the first user pointing to a new position or selecting a new area within the virtual environment.

In some examples, the trophy positioning component 1010 may be configured as or otherwise support a means for positioning the virtual trophy within the virtual environment at the second location within the virtual environment, wherein the first user and the second user both may perceive the virtual trophy to be positioned at the second location within the virtual environment. In some implementations, the trophy positioning component 1010 may allow the first user to move the virtual trophy from one location to another within the virtual environment. The trophy positioning component 1010 may enable the virtual trophy to appear at different locations within the virtual environment when the first user interacts with the virtual environment through the input reception component 1008. The trophy positioning component 1010 may maintain the continuity of the virtual trophy's presence so that it remains visible at the second location for both the first and second users.

In some examples, the virtual environment provider component 1006 may be configured as or otherwise support a means for providing a virtual reality environment to the first user. In some implementations, the virtual reality environment may be rendered on a head-mounted display used by the first user. The virtual reality environment may include interactive elements that the first user can engage with. The virtual environment provider component 1006 may generate sensory feedback that corresponds to the interactions of the first user within the virtual reality environment.

In some examples, the virtual environment provider component 1006 may be configured as or otherwise support a means for providing a mixed reality environment to the first user. The mixed reality environment may include elements of both the physical and digital worlds, allowing the first user to interact with virtual objects overlaid on their real-world surroundings. The virtual environment provider component 1006 may generate this mixed reality environment using a combination of hardware and software that tracks the user's movements and adjusts the virtual elements accordingly.

In some examples, the input reception component 1008 may be configured as or otherwise support a means for receiving an input from the first user, the input comprising a fixed location within the virtual environment. In some implementations, the fixed location may be a predetermined point in the virtual environment where the first user desires to place the virtual trophy. The input reception component 1008 may receive coordinates that correspond to the fixed location within the virtual environment. In some implementations, the fixed location may be an area within the virtual environment that is designated for displaying achievements, such as a virtual trophy case or shelf.

In some examples, the input reception component 1008 may be configured as or otherwise support a means for receiving an input from the first user, the input comprising a changing location within the virtual environment. The changing location may be determined by the movement of the first user's avatar within the virtual environment. The input may include coordinates that correspond to the new position of the avatar as the first user navigates through the virtual space. The input reception component 1008 may process the changing location data to update the position of the virtual trophy in real time as the first user moves.

In some examples, the input reception component 1008 may be configured as or otherwise support a means for receiving an input from the first user, the input comprising a location attached to an avatar of the first user. In some implementations, the location may be specified by the first user through a gesture or a selection within the virtual environment. The location may correspond to a virtual space where the avatar of the first user is present or to a specific part of the avatar's attire. In some implementations, the trophy positioning component 1010 may be configured as or otherwise support a means for positioning the virtual trophy as a wearable item by the avatar of the first user. The virtual trophy may be displayed as a badge or an accessory that the avatar can wear within the virtual environment. The positioning may allow the virtual trophy to move with the avatar as the first user navigates through the virtual space.

The third user environment provider component 1014 may be configured as or otherwise support a means for providing the virtual environment to a third user through a third device. In some implementations, the third user may receive the virtual environment that includes the virtual trophy previously positioned by the first user. The third device may be a virtual reality headset, a mixed reality headset, or any other suitable device capable of displaying the virtual environment to the third user. The third user may interact with the virtual environment using various input methods, such as hand gestures, voice commands, or controllers.

The interaction reception component 1016 may be configured as or otherwise support a means for receiving a particular interaction of the third user with the virtual trophy. In some implementations, the interaction reception component 1016 may receive inputs when the third user performs gestures or actions directed towards the virtual trophy within the virtual environment. The interaction reception component 1016 may process these inputs to determine the nature of the interaction, such as a selection or manipulation of the virtual trophy by the third user.

The action performance component 1018 may be configured as or otherwise support a means for performing a particular action from a plurality of actions associated with the trophy in response to the particular interaction. In some implementations, the action performance component 1018 may determine the specific action to perform based on the nature of the interaction received by the interaction reception component 1016. For example, if the interaction involves the third user's avatar touching the virtual trophy, the action performance component 1018 may initiate an animation sequence where the trophy celebrates the achievement. Alternatively, if the interaction is a gesture by the third user indicating a desire to learn more about the trophy, the action performance component 1018 may present a history or backstory of the achievement associated with the trophy.

In some examples, the interaction reception component 1016 may be configured as or otherwise support a means for receiving an interaction between an avatar of the third user within the virtual environment and the virtual trophy. In some implementations, the interaction may involve the third user's avatar touching or gesturing towards the virtual trophy within the virtual environment. The interaction reception component 1016 may detect when the third user's avatar comes into proximity with the virtual trophy and may register this as an interaction. The interaction reception component 1016 may also be capable of distinguishing different types of interactions, such as a tap, grab, or swipe performed by the third user's avatar in relation to the virtual trophy.

In some examples, the action performance component 1018 may be configured as or otherwise support a means for showing a video to the third user illustrating how the first user obtained the achievement to earn the virtual trophy. The action performance component 1018 may allow the third user to view the video within the virtual environment, providing a contextual background on the achievement. The video may be displayed on a virtual screen or as a holographic projection that the third user can watch. The action performance component 1018 may also support various video formats and resolutions to ensure compatibility with the third user's device.

In some examples, the action performance component 1018 may be configured as or otherwise support a means for determining that the third user may have installed the software application on the third device, and based on that determination, may be launching the software application on the third device. In some implementations, the action performance component 1018 may be configured to interact with the operating system of the third device to verify the presence of the software application. The action performance component 1018 may also be configured to send a command to the third device to initiate the software application if it is found to be installed. The action performance component 1018 may further be configured to check for the latest version of the software application before launching it on the third device.

In some examples, the action performance component 1018 may be configured as or otherwise support a means for determining that the third user may not have access to the software application and based on that determination, may launch a marketplace to provide the software application to the third user to install on the third device. In some implementations, the marketplace may be an online store accessible through the third device where various software applications are available for download. The action performance component 1018 may communicate with the marketplace to facilitate the availability of the specific software application associated with the virtual trophy. The action performance component 1018 may also be configured to provide the third user with options to purchase or obtain a free trial of the software application if the third user expresses interest in the virtual trophy.

In some examples, the API utilization component 1020 may be configured as or otherwise support a means for generating the virtual trophy by the software application in the virtual environment using an application programming interface. The API utilization component 1020 may allow for the customization of the virtual trophy's appearance based on the specific achievement earned by the first user. The software application may use the API to create a virtual trophy that includes interactive features, such as the ability to animate when viewed by users within the virtual environment. The API may also support the integration of the virtual trophy with other elements in the virtual environment, allowing it to interact with virtual objects or avatars.

FIG. 11 shows a diagram of a system 1100 including a device 1102 that supports generating and positioning interactive virtual trophies in artificial reality environments in accordance with aspects of the present disclosure. The device 1102 may be an example of or include the components of a database server or an apparatus 1002 as described herein. The device 1102 may include components for bi-directional data communications including components for transmitting and receiving communications, including a trophy positioning component 1104, an I/O controller 1106, a database controller 1108, memory 1110, a processor 1112, and a database 1114. These components may be in electronic communication via one or more buses (e.g., bus 1116).

The trophy positioning component 1104 may be an example of a trophy positioning component 1010 or 916 as described herein. For example, the trophy positioning component 1104 may perform any of the methods or processes described above with reference to FIGS. 9 and 8. In some cases, the trophy positioning component 1104 may be implemented in hardware, software executed by a processor, firmware, or any combination thereof.

The I/O controller 1106 may manage input signals 1118 and output signals 1120 for the device 1102. The I/O controller 1106 may also manage peripherals not integrated into the device 1102. In some cases, the I/O controller 1106 may represent a physical connection or port to an external peripheral. In some cases, the I/O controller 1106 may utilize an operating system such as iOS®, ANDROID®, MS-DOS®, MS-WINDOWS®, OS/2®, UNIX®, LINUX®, or another known operating system. In other cases, the I/O controller 1106 may represent or interact with a modem, a keyboard, a mouse, a touchscreen, or a similar device. In some cases, the I/O controller 1106 may be implemented as part of a processor. In some cases, a user may interact with the device 1102 via the I/O controller 1106 or via hardware components controlled by the I/O controller 1106.

The database controller 1108 may manage data storage and processing in a database 1114. In some cases, a user may interact with the database controller 1108. In other cases, the database controller 1108 may operate automatically without user interaction. The database 1114 may be an example of a single database, a distributed database, multiple distributed databases, a data store, a data lake, or an emergency backup database.

Memory 1110 may include random-access memory (RAM) and read-only memory (ROM). The memory 1110 may store computer-readable, computer-executable software including instructions that, when executed, cause the processor to perform various functions described herein. In some cases, the memory 1110 may contain, among other things, a basic input/output system (BIOS) which may control basic hardware or software operation such as the interaction with peripheral components or devices.

The processor 1112 may include an intelligent hardware device (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 1112 may be configured to operate a memory array using a memory controller. In other cases, a memory controller may be integrated into the processor 1112. The processor 1112 may be configured to execute computer-readable instructions stored in a memory 1110 to perform various functions (e.g., functions or tasks supporting generating and positioning interactive virtual trophies in artificial reality environments).

The disclosed system(s) address a problem in traditional techniques for artificial reality applications tied to computer technology, namely, the technical problem of limited engagement with virtual trophies in software applications due to their static nature and lack of interactive, immersive, and social sharing capabilities. The disclosed system solves this technical problem by providing a solution also rooted in computer technology, namely, by providing for generating and positioning interactive virtual trophies in artificial reality environments. The disclosed subject technology further provides improvements to the functioning of the computer itself because it improves processing and efficiency in artificial reality applications.

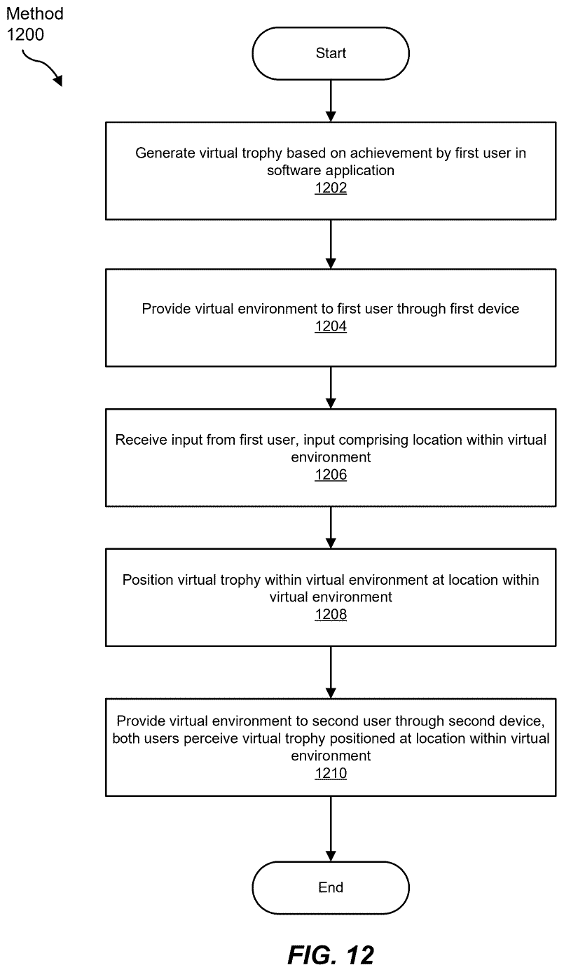

FIG. 12 shows a flowchart illustrating a method 1200 that supports generating and positioning interactive virtual trophies in artificial reality environments in accordance with various aspects of the present disclosure. The operations of the method 1200 may be implemented by one or more components of a networked computing system as described herein. For example, the operations of the method 1200 may be performed by a trophy positioning component as described with reference to FIGS. 9 through 9. In some examples, one or more components of a networked computing system may execute a set of instructions to control the functional elements of the component(s) to perform the described functions. Additionally, or alternatively, the one or more components of a networked computing system may perform aspects of the described functions using special-purpose hardware.

At 1202, the method 1200 may include generating, based on an achievement by a first user in a software application, a virtual trophy that is unique to the achievement. The operations of 1202 may be performed in accordance with examples as disclosed herein. In some examples, aspects of the operations of 1202 may be performed by a trophy generation component 1004 as described with reference to FIG. 10.

At 1204, the method 1200 may include providing a virtual environment to the first user through a first device. The operations of 1204 may be performed in accordance with examples as disclosed herein. In some examples, aspects of the operations of 1204 may be performed by a virtual environment provider component 1006 as described with reference to FIG. 10.

At 1206, the method 1200 may include receiving an input from the first user, the input comprising a location within the virtual environment. The operations of 1206 may be performed in accordance with examples as disclosed herein. In some examples, aspects of the operations of 1206 may be performed by an input reception component 1008 as described with reference to FIG. 10.

At 1208, the method 1200 may include in response to receiving the input, positioning the virtual trophy within the virtual environment at the location within the virtual environment. The operations of 1208 may be performed in accordance with examples as disclosed herein. In some examples, aspects of the operations of 1208 may be performed by a trophy positioning component 1010 as described with reference to FIG. 10.

At 1210, the method 1200 may include providing the virtual environment to a second user through a second device, wherein the first user and the second user both perceive the virtual trophy to be positioned at the location within the virtual environment. The operations of 1210 may be performed in accordance with examples as disclosed herein. In some examples, aspects of the operations of 1210 may be performed by a second user environment provider component 1012 as described with reference to FIG. 10.

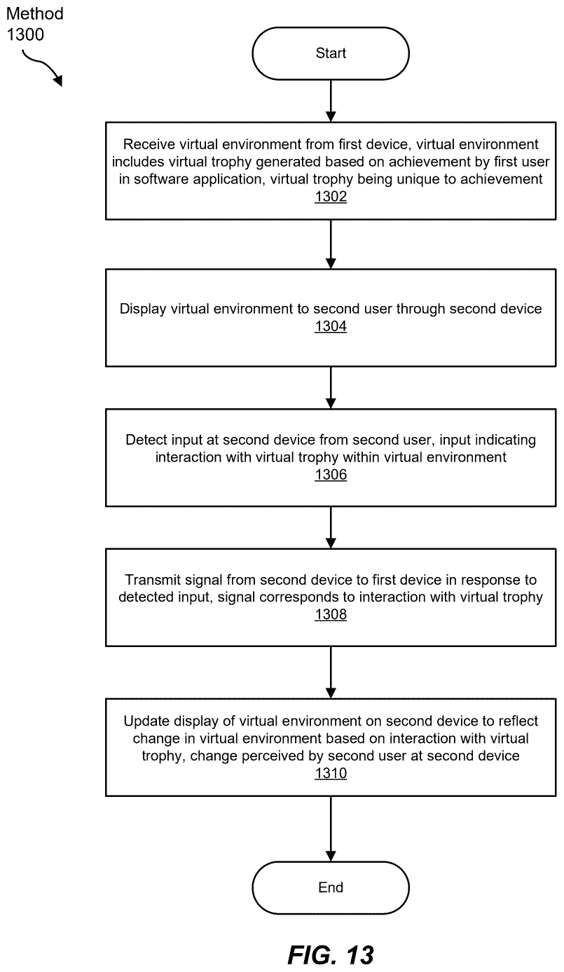

FIG. 13 shows a flowchart illustrating a method 1300 that supports generating and positioning interactive virtual trophies in artificial reality environments in accordance with various aspects of the present disclosure. The operations of the method 1300 may be implemented by one or more components of a networked computing system as described herein. For example, the operations of the method 1300 may be performed by a trophy positioning component as described with reference to FIGS. 9 through 9. In some examples, one or more components of a networked computing system may execute a set of instructions to control the functional elements of the component(s) to perform the described functions. Additionally, or alternatively, the one or more components of a networked computing system may perform aspects of the described functions using special-purpose hardware.

At 1302, the method 1300 may include receiving, at a second device, a virtual environment from a first device, wherein the virtual environment includes a virtual trophy generated based on an achievement by a first user in a software application, the virtual trophy being unique to the achievement. The operations of 1302 may be performed in accordance with examples as disclosed herein. In some examples, aspects of the operations of 1302 may be performed by a virtual environment provider component 1006 as described with reference to FIG. 10.

At 1304, the method 1300 may include displaying the virtual environment to a second user through the second device. The operations of 1304 may be performed in accordance with examples as disclosed herein. In some examples, aspects of the operations of 1304 may be performed by a second user environment provider component 1012 as described with reference to FIG. 10.

At 1306, the method 1300 may include detecting an input at the second device from the second user, the input indicating an interaction with the virtual trophy within the virtual environment. The operations of 1306 may be performed in accordance with examples as disclosed herein. In some examples, aspects of the operations of 1306 may be performed by an interaction reception component 1016 as described with reference to FIG. 10.

At 1308, the method 1300 may include transmitting a signal from the second device to the first device in response to the detected input, wherein the signal corresponds to the interaction with the virtual trophy. The operations of 1308 may be performed in accordance with examples as disclosed herein. In some examples, aspects of the operations of 1308 may be performed by an action performance component 1018 as described with reference to FIG. 10.

At 1310, the method 1300 may include updating the display of the virtual environment on the second device to reflect a change in the virtual environment based on the interaction with the virtual trophy, wherein the change is perceived by the second user at the second device. The operations of 1310 may be performed in accordance with examples as disclosed herein. In some examples, aspects of the operations of 1310 may be performed by a trophy positioning component 1010 as described with reference to FIG. 10.

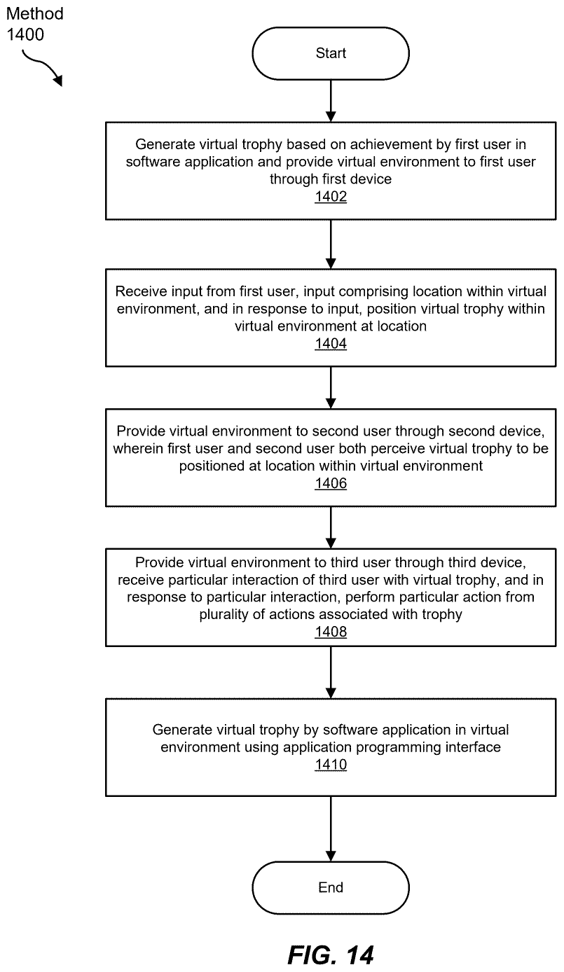

FIG. 14 shows a flowchart illustrating a method 1400 that supports generating and positioning interactive virtual trophies in artificial reality environments in accordance with various aspects of the present disclosure. The operations of the method 1400 may be implemented by one or more components of a networked computing system as described herein. For example, the operations of the method 1400 may be performed by a trophy positioning component as described with reference to FIGS. 9 through 9. In some examples, one or more components of a networked computing system may execute a set of instructions to control the functional elements of the component(s) to perform the described functions. Additionally, or alternatively, the one or more components of a networked computing system may perform aspects of the described functions using special-purpose hardware.

At 1402, the method 1400 may include generating a virtual trophy based on an achievement by a first user in a software application and providing a virtual environment to the first user through a first device. The operations of 1402 may be performed in accordance with examples as disclosed herein. In some examples, aspects of the operations of 1402 may be performed by a trophy generation component 1004 and a virtual environment provider component 1006 as described with reference to FIG. 10.

At 1404, the method 1400 may include receiving an input from the first user, the input comprising a location within the virtual environment, and in response to the input, positioning the virtual trophy within the virtual environment at the location. The operations of 1404 may be performed in accordance with examples as disclosed herein. In some examples, aspects of the operations of 1404 may be performed by an input reception component 1008 and a trophy positioning component 1010 as described with reference to FIG. 10.

At 1406, the method 1400 may include providing the virtual environment to a second user through a second device, wherein the first user and the second user both perceive the virtual trophy to be positioned at the location within the virtual environment. The operations of 1406 may be performed in accordance with examples as disclosed herein. In some examples, aspects of the operations of 1406 may be performed by a second user environment provider component 1012 as described with reference to FIG. 10.

At 1408, the method 1400 may include providing the virtual environment to a third user through a third device, receiving a particular interaction of the third user with the virtual trophy, and in response to the particular interaction, performing a particular action from a plurality of actions associated with the trophy. The operations of 1408 may be performed in accordance with examples as disclosed herein. In some examples, aspects of the operations of 1408 may be performed by a third user environment provider component 1014, an interaction reception component 1016, and an action performance component 1018 as described with reference to FIG. 10.

At 1410, the method 1400 may include generating the virtual trophy by the software application in the virtual environment using an application programming interface. The operations of 1410 may be performed in accordance with examples as disclosed herein. In some examples, aspects of the operations of 1410 may be performed by an API utilization component 1020 as described with reference to FIG. 10.

In some aspects, the techniques described herein relate to a method for generating and positioning interactive virtual trophies in artificial reality environments, including: generating, based on an achievement by a first user in a software application, a virtual trophy that is unique to the achievement; providing a virtual environment to the first user through a first device; receiving an input from the first user, the input including a location within the virtual environment; in response to receiving the input, positioning the virtual trophy within the virtual environment at the location within the virtual environment; and providing the virtual environment to a second user through a second device, wherein the first user and the second user both perceive the virtual trophy to be positioned at the location within the virtual environment.

In some aspects, the techniques described herein relate to a method, wherein the input is a first input and the location is a first location, the method further including: receiving a second input from the first user, the second input including a second location within the virtual environment; and in response to receiving the second input, positioning the virtual trophy within the virtual environment at the second location within the virtual environment, wherein the first user and the second user both perceive the virtual trophy to be positioned at the second location within the virtual environment.

In some aspects, the techniques described herein relate to a method, wherein the virtual environment is a virtual reality environment.

In some aspects, the techniques described herein relate to a method, wherein the virtual environment is a mixed reality environment.

In some aspects, the techniques described herein relate to a method, wherein the location is a fixed location within the virtual environment.

In some aspects, the techniques described herein relate to a method, wherein the location is a changing location within the virtual environment.

In some aspects, the techniques described herein relate to a method, wherein the location is attached to an avatar of the first user, and the virtual trophy is a wearable item by the avatar of the first user.

In some aspects, the techniques described herein relate to a method, further including: providing the virtual environment to a third user through a third device; receiving a particular interaction of the third user with the virtual trophy; and in response to the particular interaction, performing a particular action from a plurality of actions associated with the trophy.

In some aspects, the techniques described herein relate to a method, wherein the interaction includes an interaction between an avatar of the third user within the virtual environment and the virtual trophy.

In some aspects, the techniques described herein relate to a method, wherein the plurality of actions associated with the trophy include showing a video to the third user illustrating how the first user obtained the achievement to earn the virtual trophy.

In some aspects, the techniques described herein relate to a method, wherein the plurality of actions associated with the trophy include determining that the third user has installed the software application on the third device, and based on that determination, launching the software application on the third device.

In some aspects, the techniques described herein relate to a method, wherein the plurality of actions associated with the trophy include determining that the third user does not have access to the software application and based on that determination, launching a marketplace to provide the software application to the third user to install on the third device.

In some aspects, the techniques described herein relate to a method, wherein the virtual trophy is generated by the software application in the virtual environment using an application programming interface.

In some aspects, the techniques described herein relate to a system configured for generating and positioning interactive virtual trophies in artificial reality environments, including: a processor; a memory coupled with the processor; and instructions stored in the memory and executable by the processor to cause the system to: generate, based on an achievement by a first user in a software application, a virtual trophy that is unique to the achievement; provide a virtual environment to the first user through a first device; receive an input from the first user, the input including a location within the virtual environment; position the virtual trophy within the virtual environment at the location in response to receiving the input; and provide the virtual environment to a second user through a second device, wherein the first user and the second user both perceive the virtual trophy to be positioned at the location within the virtual environment.

In some aspects, the techniques described herein relate to a system, wherein the instructions are further executable by the processor to cause the system to receive a second input from the first user, the second input including a second location within the virtual environment, and in response to receiving the second input, position the virtual trophy within the virtual environment at the second location, wherein the first user and the second user both perceive the virtual trophy to be positioned at the second location within the virtual environment.

In some aspects, the techniques described herein relate to a system, wherein the virtual environment is a virtual reality environment.

In some aspects, the techniques described herein relate to a system, wherein the virtual environment is a mixed reality environment.

In some aspects, the techniques described herein relate to a system, wherein the location is a fixed location within the virtual environment.

In some aspects, the techniques described herein relate to a system, wherein the location is a changing location within the virtual environment.

In some aspects, the techniques described herein relate to a non-transitory computer-readable medium storing code for generating and positioning interactive virtual trophies in artificial reality environments, the code including instructions executable by a processor to: generate, based on an achievement by a first user in a software application, a virtual trophy that is unique to the achievement; provide a virtual environment to the first user through a first device; receive an input from the first user, the input including a location within the virtual environment; in response to receiving the input, position the virtual trophy within the virtual environment at the location within the virtual environment; and provide the virtual environment to a second user through a second device, wherein the first user and the second user both perceive the virtual trophy to be positioned at the location within the virtual environment.

### Interactive Spatial Reasoning-Based Mixed Reality Scene Generation

A social media platform refers to a website or software application that allows users to share content with each other. Users of a social media platform typically generate content to share, such as still images, audio, or video (often including audio), on a mobile device, because mobile devices typically include a suitable camera, a microphone, a connection to a communications network such as the internet, and can execute a software application that uploads content to the social media platform.

Describing elements of a scene within an MR environment is difficult, particularly when the state of the MR environment is often partially or completely unknown when a developer or creator creates an MR experience in the environment. For example, a developer might ask where virtual objects in the scene should be placed-on the wall? On a table? What if the user is lying down? What if the user is far away from a virtual object being placed? What if the scene is a virtual room, and the room is too small or big to accommodate a particular virtual object? If the virtual object is intended to be placed on a wall, but there is no free space on any wall, what should happen instead? Currently, developers engage in tedious testing loops, which can lead to shipping titles that earn low reviews due to inadequate spatial reasoning logic that fails to account for diverse user environments and the many edge cases that can occur. When an edge case is found during testing, developers are unsure how frequently the edge case occurs, making it challenging to allocate resources towards ameliorating more frequently occurring edge cases. It is also difficult to assess how much testing coverage has been completed. In one presently available approach, scoped heuristics, a developer indicates that an MR experience would work on specific environmental requirements and maintains the spatial-reasoning logic in a controlled fashion with a handful of fallbacks. This approach becomes inefficient as the number of possible decisions and their effects becomes more complex. In another presently available approach, a software placement tool implements common combination-states for placement scenarios. In another presently available approach, a developer delegates spatial reasoning to the end-user, hence a virtual object will be placed wherever the end-user feels fit. This approach can guarantee plausible placement from the user, especially for surface-based and panel applications, but delays a user's ability to simply experience the scene. In addition, applications that require specific curation of the scene (e.g., to implement e-commerce or branding requirements) would likely not be able to achieve the intended curation from the end-user. Thus, there is a need to improve mixed reality scene generation using an interactive spatial reasoning-based process.

Embodiments of the present disclosure address the above identified problems by implementing interactive spatial reasoning-based mixed reality scene generation. In particular, an embodiment generates, using a trained scene reasoning model, an initial scene prompt corresponding to an input intention; generates, using a trained intention prediction model, a refined scene prompt, the refined scene prompt comprising an adjustment to the initial scene prompt; and places, using the refined scene prompt, a virtual object in a virtual scene.

An embodiment receives an input intention. An input intention is a request from a user to incorporate a virtual object into a scene. One non-limiting example of an input intention is, “Place Object A on the table in front of the user.” One embodiment receives a specification of a virtual environment (e.g., the scenes and objects of a game) or guidelines involved in displaying a virtual object (e.g., branding guidelines if the object is associated with a trademark) and generates an input intention for a particular virtual object.

Using a trained scene reasoning model, an embodiment generates an initial scene prompt corresponding to the input intention. In one embodiment, the trained scene reasoning model is a trained large language model (LLM) fine-tuned for the intention completion task. An LLM is a type of machine learning model designed for natural language processing tasks such as language generation and performing scene reasoning (i.e., asking questions or expressing a contentious opinion to test the strength of an opponent's proposition or argument). A foundation or foundational LLM is a general-purpose LLM that can be fine-tuned to perform a specific task or to include knowledge of a particular subject. An example input to the trained large language model (LLM) fine-tuned for the intention completion task might be an instruction to perform scene reasoning with the logical placement of a virtual object within a scene, along with a few examples of scene curation. In response, the model outputs a response that prompts a user to iteratively refine the original input intention to work in a broader set of environments. For example, given the example input intention, “Place Object A on the table in front of the user,” a model might respond, “44% of users don't have a table in their scene, what would you like to do in that case?” In response, the user might adjust the input intention (e.g., “Place Object A on a horizontal surface” or “if no table is available, place Object A on a shelf or on the floor”) and the embodiment repeats the process. If the user is satisfied, an embodiment generates an initial scene prompt corresponding to the last input intention or the series of progressively refined input intentions. An initial scene prompt is an instruction to a virtual environment to place a virtual object in a virtual scene. One embodiment scores an input intention, providing a metric on how generalizable the current intention is, and if the score is above a threshold the embodiment generates an initial scene prompt corresponding to the last input intention or the series of progressively refined input intentions.

As it would be unreasonable to as the user to work through more than a few possible scenarios or iterations, an embodiment uses a trained intention prediction model to generate a refined scene prompt including an adjustment to the initial scene prompt. In one embodiment, the trained intention prediction model is an LLM fine-tuned to predict the user's answers to additional scenarios that were not explored during generation of the initial scene prompt. An embodiment incorporates the predicted answers into the initial scene prompt to generate the refined scene prompt. One embodiment scores the refined scene prompt, providing a metric on how generalizable the scene prompt is, and if the score is below a threshold the embodiment repeats generation of the refined scene prompt in a manner described herein.

Using the refined scene prompt, current state of the virtual environment, and scene model, during runtime an embodiment places a virtual object in a virtual scene of the virtual environment. In one embodiment, a device generating a virtual scene (e.g., an MR headset or a mobile device) maintains a structured list of objects in the scene, and an embodiment uses an LLM fine-tuned to perform object placement to, given the structured list of objects, provide coordinates for the object being placed within a scene, thus placing the virtual object. For example, if an object is to be placed on top of a table, an embodiment locates the table in the structured list, uses the model to generate a location for the top of the table, and places the virtual object in the calculated location.

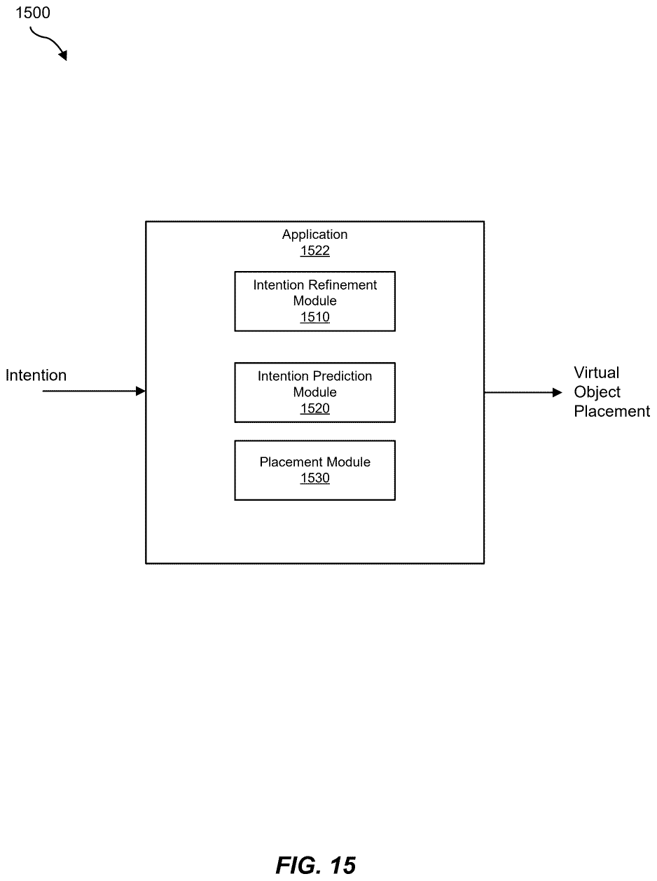

FIG. 15 depicts a block diagram of an example configuration for interactive spatial reasoning-based mixed reality scene generation, in accordance with an illustrative embodiment.

Application 1522 receives an input intention. An input intention is a request from a user to incorporate a virtual object into a scene. One non-limiting example of an input intention is, “Place Object A on the table in front of the user.” One implementation of application 1522 receives a specification of a virtual environment (e.g., the scenes and objects of a game) or guidelines involved in displaying a virtual object (e.g., branding guidelines if the object is associated with a trademark) and generates an input intention for a particular virtual object.

Using a trained scene reasoning model, intention refinement module 1510 generates an initial scene prompt corresponding to the input intention. In one implementation of module 1510, the trained scene reasoning model is a trained large language model (LLM) fine-tuned for the intention completion task. An LLM is a type of machine learning model designed for natural language processing tasks such as language generation and performing scene reasoning (i.e., asking questions or expressing a contentious opinion to test the strength of an opponent's proposition or argument). A foundation or foundational LLM is a general-purpose LLM that can be fine-tuned to perform a specific task or to include knowledge of a particular subject. An example input to the trained large language model (LLM) fine-tuned for the intention completion task might be an instruction to perform scene reasoning with the logical placement of a virtual object within a scene, along with a few examples of scene curation. In response, the model outputs a response that prompts a user to iteratively refine the original input intention to work in a broader set of environments. For example, given the example input intention, “Place Object A on the table in front of the user,” a model might respond, “44% of users don't have a table in their scene, what would you like to do in that case?” In response, the user might adjust the input intention (e.g., “Place Object A on a horizontal surface” or “if no table is available, place Object A on a shelf or on the floor”) and module 1510 repeats the process. If the user is satisfied, module 1510 generates an initial scene prompt corresponding to the last input intention or the series of progressively refined input intentions. An initial scene prompt is an instruction to a virtual environment to place a virtual object in a virtual scene. One implementation of module 1510 scores an input intention, providing a metric on how generalizable the current intention is, and if the score is above a threshold module 1510 generates an initial scene prompt corresponding to the last input intention or the series of progressively refined input intentions.

As it would be unreasonable to as the user to work through more than a few possible scenarios or iterations, intention prediction module 1520 uses a trained intention prediction model to generate a refined scene prompt including an adjustment to the initial scene prompt. In one implementation of module 1520, the trained intention prediction model is an LLM fine-tuned to predict the user's answers to additional scenarios that were not explored during generation of the initial scene prompt. Module 1520 incorporates the predicted answers into the initial scene prompt to generate the refined scene prompt. One implementation of module 1520 scores the refined scene prompt, providing a metric on how generalizable the scene prompt is, and if the score is below a threshold module 1520 repeats generation of the refined scene prompt in a manner described herein.

Using the refined scene prompt, current state of the virtual environment, and scene model, during runtime placement module 1530 places a virtual object in a virtual scene of the virtual environment. In one implementation, a device generating a virtual scene (e.g., an MR headset or a mobile device) maintains a structured list of objects in the scene, and module 1530 uses an LLM fine-tuned to perform object placement to, given the structured list of objects, provide coordinates for the object being placed within a scene, thus placing the virtual object. For example, if an object is to be placed on top of a table, module 1530 locates the table in the structured list, uses the model to generate a location for the top of the table, and places the virtual object in the calculated location.

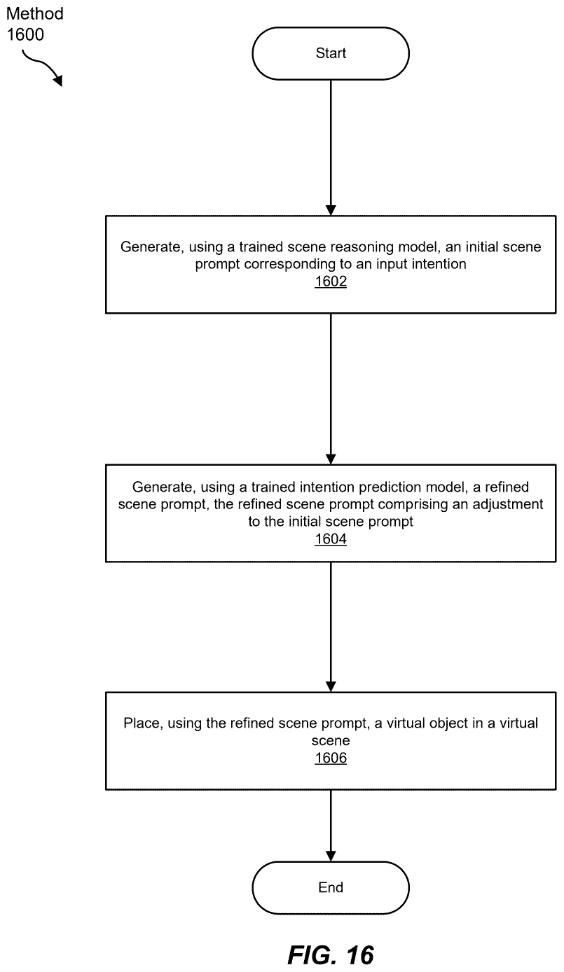

FIG. 16 depicts a flowchart of an example process for interactive spatial reasoning-based mixed reality scene generation, in accordance with an illustrative embodiment. Process 1600 can be implemented in application 1522 in FIG. 15.

At block 1602, the process generates, using a trained scene reasoning model, an initial scene prompt corresponding to an input intention. At block 1604, the process generates, using a trained intention prediction model, a refined scene prompt, the refined scene prompt comprising an adjustment to the initial scene prompt. At block 1606, the process places, using the refined scene prompt, a virtual object in a virtual scene. Then the process ends.

### Systems and Methods for Sensing Skin Collagen Patterns for Biometry and Authentication in Head-Mounted Systems

Biometric authentication systems have become an important aspect of ensuring security in personal devices, enterprise environments, and wearable electronics. Conventional methods of biometric identification, such as facial recognition, fingerprint scanning, and iris recognition, often rely on external features or surface-level imaging. These approaches, while effective in many cases, may be vulnerable to harmful attacks. Additionally, conventional systems may exhibit variability due to factors including environmental lighting conditions, sensor resolution limitations, and expression or posture changes by the user. The proposed system may include polarization-sensitive imaging, which may capture information about the polarization state of reflected light, presenting a method to meet these challenges. In particular, collagen fibers within human skin exhibit birefringent properties, influencing the polarization state of backscattered light in a manner that is unique to each individual. Leveraging polarization-sensitive cameras to detect and analyze collagen fiber orientation offers an opportunity to create highly secure, subsurface biometric signatures that are difficult to replicate.

Consumer-grade polarization sensitive camera technology allows incorporating polarization into devices. Polarization contrast unlocks more accurate eye and face tracking and may be useful in room mapping (SLAM) applications

In the pursuit of enhancing biometric authentication systems, there is a critical need for technologies that offer robust, precise, and spoof-resistant identification methods. Traditional facial recognition systems can be vulnerable to spoofing and may lack the precision required for high-security applications. Using polarization-sensitive cameras to sense collagen orientation in periocular regions and the face may improve the accuracy and security of biometric authentication by leveraging unique physiological characteristics that are difficult to replicate or alter.

Polarization-sensitive cameras have the capability to detect the orientation of collagen fibers in the skin, particularly in the periocular regions and across the face. By capturing polarization contrast, these cameras can provide detailed insights into the structural properties of the skin that are unique to each individual. This technology enhances biometric authentication by offering a layer of security that is inherently resistant to spoofing, as the collagen orientation patterns are difficult to mimic. Additionally, the precision of polarization-sensitive imaging ensures that biometric systems can achieve higher accuracy, making them suitable for applications requiring stringent security measures.

Beyond biometric authentication, these capabilities can be leveraged for long-term skin health monitoring. By analyzing changes in collagen orientation and other skin properties, polarization-sensitive cameras can help track the effectiveness of skincare products, including moisturizers and sunscreens. Furthermore, in the context of contextual AI applications, these cameras can assist in monitoring lifestyle factors such as nutrition and hydration, correlating them with skin health. This holistic approach enables users to make informed decisions about their skincare routines and overall well-being, supported by data-driven insights.

The present disclosure is generally directed to a polarization camera that may capture image data from a user's skin and analyze polarization contrast to determine structural characteristics, such as collagen fiber orientation, that are unique to an individual. The systems disclosed herein may include a camera system that enables biometric authentication and monitor changes in skin health over time.

In one example, a polarization camera may include an image sensor configured to detect polarized electromagnetic radiation reflected from at least one portion of a user's skin. The polarization camera may be integrated into wearable devices including but not limited to a head-mounted display, AR headsets, VR headsets, and smart glasses. The image sensor may capture image data encoding polarization contrast, which results from subsurface interactions of polarized light with the structural components of the skin (e.g., collagen fibers). The captured image data may then be processed by a processing unit operatively coupled to the image sensor. The processing unit may analyze the polarization contrast to identify a pattern associated with internal structural features of the skin. In some examples, the processing includes deriving parameters such as the degree of polarization, angle of polarization, and intensity. Collagen fibers, which act as birefringent structures, may modify the polarization state of incident light in characteristic ways that may be detected and used to form a unique signature associated with the individual.

Upon identification of the collagen-based pattern, an output module may initiate an action based on the determined signature. In one example, the action may include verifying an identity of the user by comparing collagen orientation signatures to stored templates and/or biometric profiles. In other examples, the action may include generating reports related to the user's skin health, such as hydration status, aging effects, or the efficacy of skincare treatments. The disclosed polarization camera system may operate in real-time, continuously authenticating the user as they interact with a device, and/or intermittently performing checks to ensure that the authenticated user remains present. The system may further correlate changes in collagen orientation patterns over time with contextual attributes of the user's lifestyle, such as nutrition, hydration, sun exposure, and other environmental factors, thereby supporting personalized health monitoring and recommendations through contextual AI frameworks.

In further examples, the system may capture image data on selective regions of the skin where collagen structures are well-defined and accessible, such as the periocular region of the user's face, the cheeks, or other facial areas. By imaging these areas, the device can achieve highly accurate authentication without relying solely on traditional surface features. In addition, the system may include polarization-sensitive cameras that are oriented to face away from the user, such as world-facing cameras. These polarization-sensitive, world-facing cameras may be configured to capture image data from an external field of view, such as other individuals in the environment, enabling the system to detect structural characteristics of their skin, such as collagen orientation patterns, in a manner similar to that used for the wearer. As a result, the system may be used to authenticate or identify individuals other than the user, or to assess physiological attributes such as skin health, hydration, or aging for those individuals. This capability extends the application of the device beyond personal biometric security to broader use cases such as multi-user authentication, remote health screening, or population-based biometric sensing.

The polarization camera may comprise one or more optical elements, including polarizers, retarders, or filter arrays aligned with the image sensor to facilitate selective detection of polarized light components. The processing unit may employ machine learning algorithms or pattern recognition techniques trained to classify collagen orientation patterns across populations, improving specificity and reducing false positives.

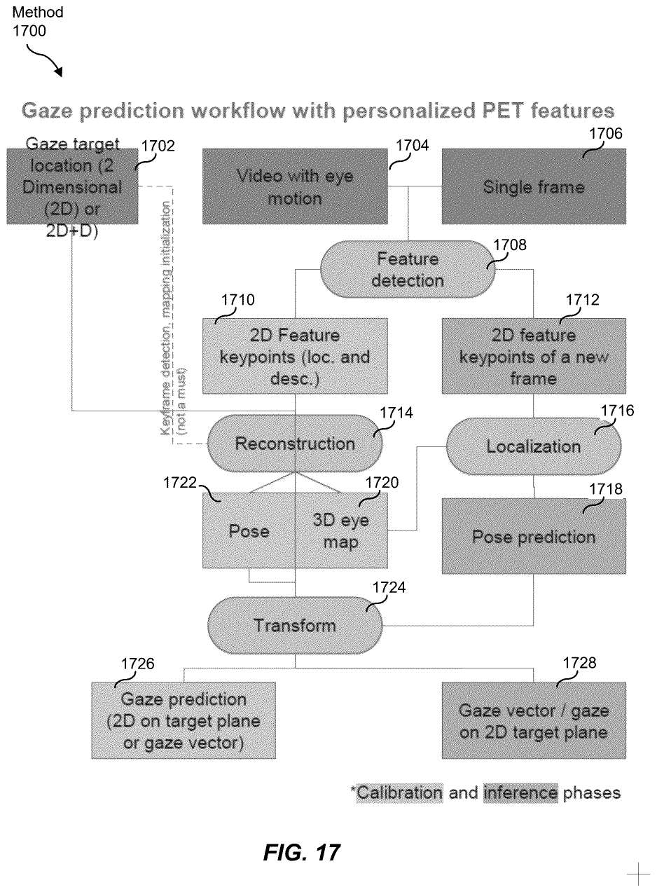

FIG. 17 illustrates an example prediction flow that includes gaze and pose (facial expression) prediction to ensure robust authentication, for a biometric authentication working with eye tracking using polarization-sensitive cameras, such as a gaze prediction workflow with personalized PET features.

At 1702 gaze target location (e.g., two-dimensional and/or 2D with depth) may be determined. At 1704, video with eye motion may be captured, and at 1706 a single frame may be captured. At 1708, feature detection may be performed on the captured video and/or frame. At 1710, 2D feature keypoints (e.g., location and/or description) may be determined (e.g., from the captured video), and at 1712, 2D feature keypoints of a new frame may be determined (e.g., from the captured frame).

At 1714, reconstruction may be performed. Reconstruction may be performed using the 2D feature keypoints (from 1710), the gaze target location (from 1702), and optionally in some examples, keyframe detection and/or mapping initialization. At 1720 pose may be determined, and at 1722, a 3D eye map may be determined (e.g., from the reconstruction from 1714).

At 1716 localization may be performed (e.g., using the 2D feature keypoints from 1712 and/or the 3D eye map from 1720). At 1718, pose prediction may be performed (e.g., from the localization from 1716).

At 1724 a transform may be performed (e.g., using the pose from 1722, the 3D eye map from 1720, and/or the pose prediction from 1718). At 1726, a gaze prediction (e.g., 2D on a target plane or gaze vector) may be performed (e.g., using the transform from 1724). At 1728, gaze vector and/or gaze on a 2D target plane may be determined (e.g., using the transform from 1724).

In some examples, steps 1702, 1704, 1710, 1722, 1720, and/or 1726 may correspond to calibration phases. In some examples, steps 1706, 1712, 1718, and/or 1728 may correspond to inference phases. Accordingly, the calibration phase may be performed separately (e.g., before and/or in parallel) with the inference phase, in some examples.

Embodiments of the present disclosure may include or be implemented in conjunction with various types of Artificial-Reality (AR) systems. AR may be any superimposed functionality and/or sensory-detectable content presented by an artificial-reality system within a user's physical surroundings. In other words, AR is a form of reality that has been adjusted in some manner before presentation to a user. AR can include and/or represent virtual reality (VR), augmented reality, mixed AR (MAR), or some combination and/or variation of these types of realities. Similarly, AR environments may include VR environments (including non-immersive, semi-immersive, and fully immersive VR environments), augmented-reality environments (including marker-based augmented-reality environments, markerless augmented-reality environments, location-based augmented-reality environments, and projection-based augmented-reality environments), hybrid-reality environments, and/or any other type or form of mixed- or alternative-reality environments.

AR content may include completely computer-generated content or computer-generated content combined with captured (e.g., real-world) content. Such AR content may include video, audio, haptic feedback, or some combination thereof, any of which may be presented in a single channel or in multiple channels (such as stereo video that produces a three-dimensional (3D) effect to the viewer). Additionally, in some embodiments, AR may also be associated with applications, products, accessories, services, or some combination thereof, that are used to, for example, create content in an artificial reality and/or are otherwise used in (e.g., to perform activities in) an artificial reality.

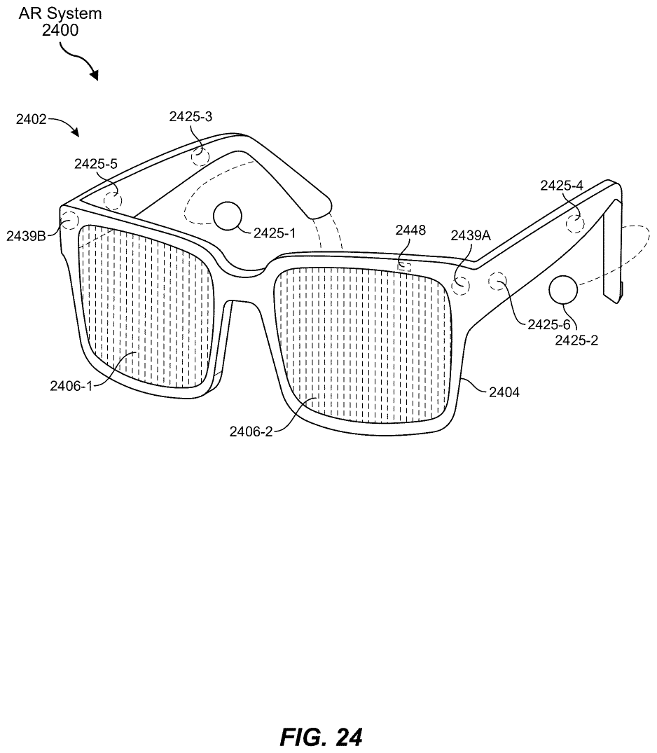

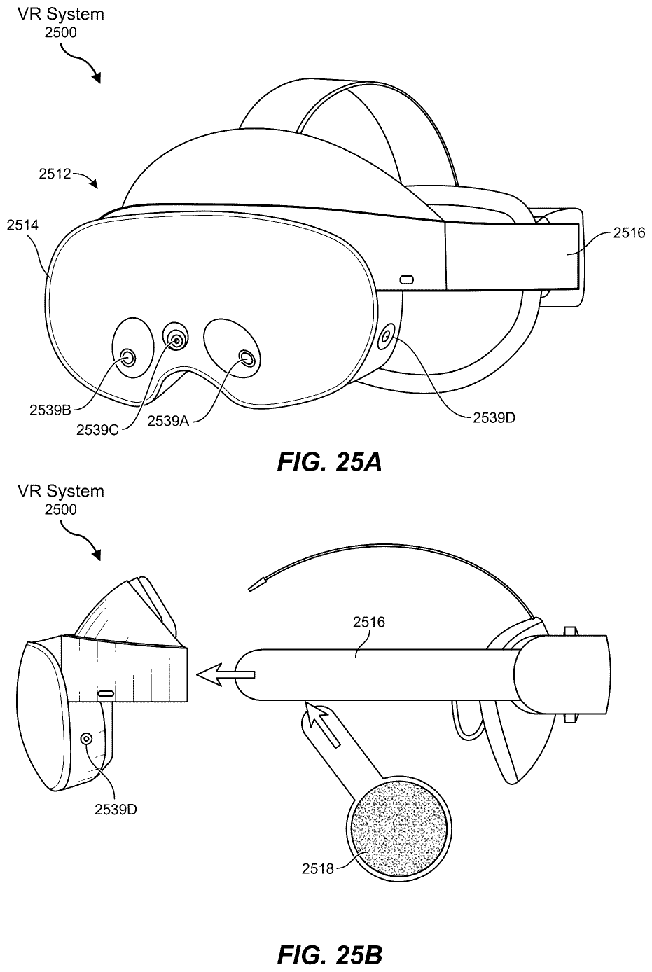

AR systems may be implemented in a variety of different form factors and configurations. Some AR systems may be designed to work without near-eye displays (NEDs). Other AR systems may include a NED that also provides visibility into the real world (such as, e.g., augmented-reality system 2400 in FIG. 24) or that visually immerses a user in an artificial reality (such as, e.g., virtual-reality system 2500 in FIGS. 25A and 25B). While some AR devices may be self-contained systems, other AR devices may communicate and/or coordinate with external devices to provide an AR experience to a user. Examples of such external devices include handheld controllers, mobile devices, desktop computers, devices worn by a user, devices worn by one or more other users, and/or any other suitable external system.

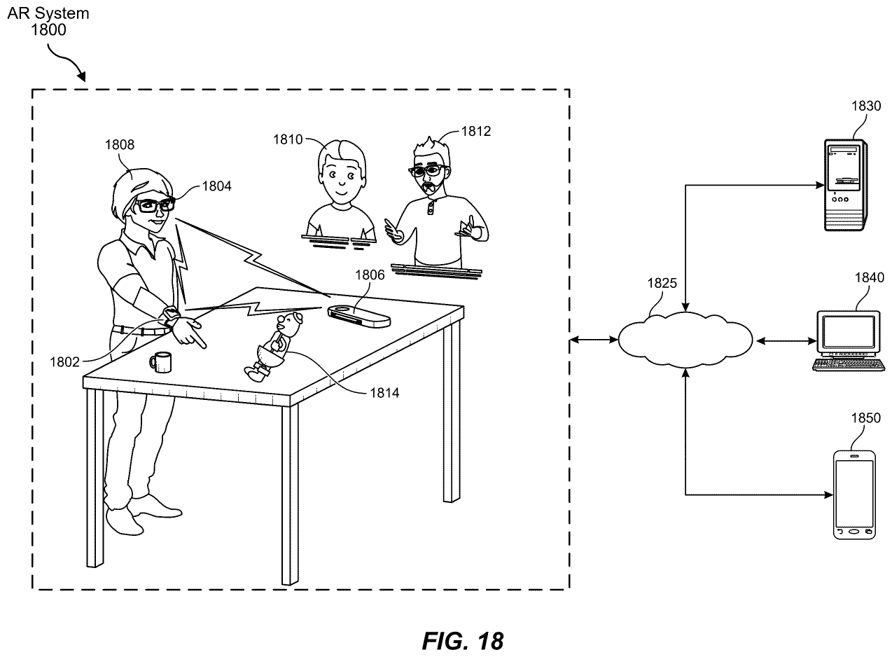

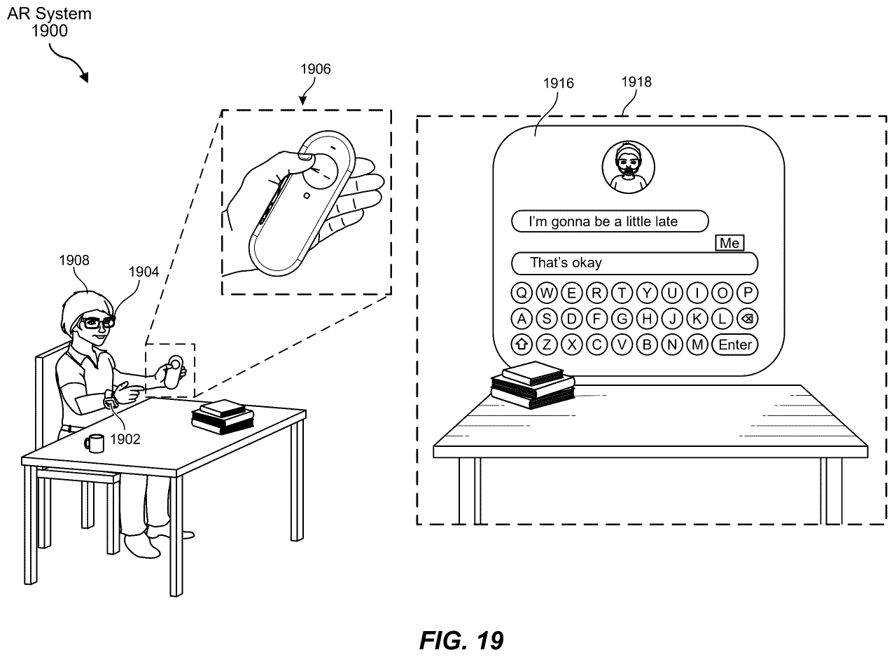

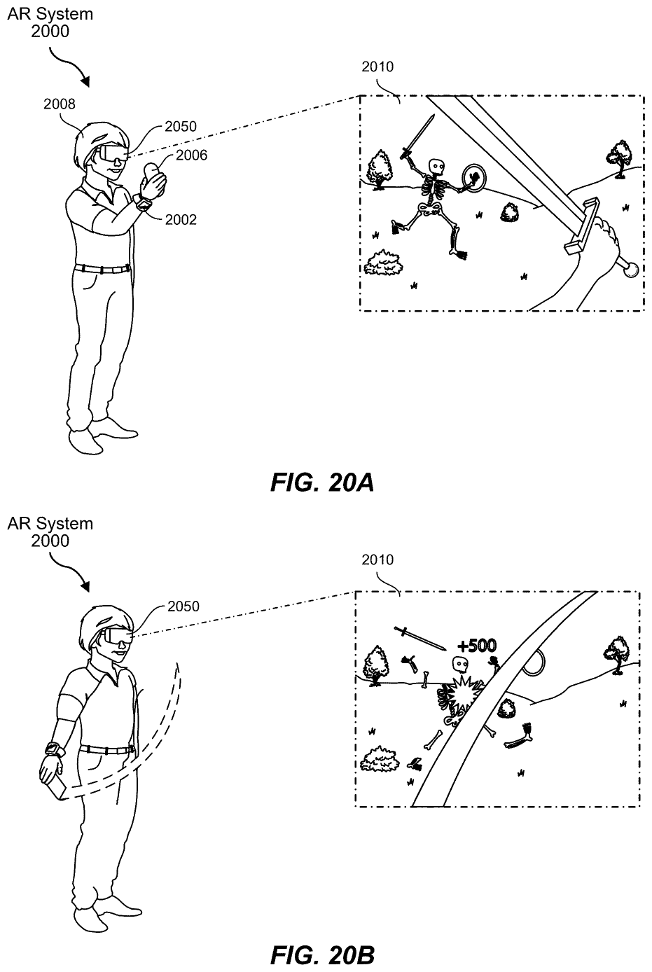

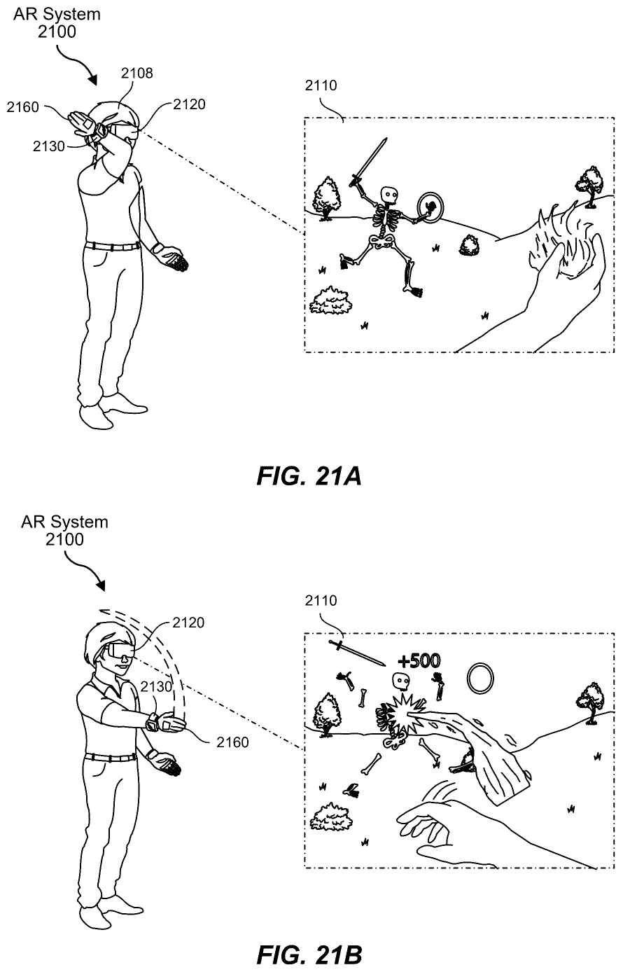

FIGS. 18-21B illustrate example artificial-reality (AR) systems in accordance with some embodiments. FIG. 18 shows a first AR system 1800 and first example user interactions using a wrist-wearable device 1802, a head-wearable device (e.g., AR glasses 2400), and/or a handheld intermediary processing device (HIPD) 1806. FIG. 19 shows a second AR system 1900 and second example user interactions using a wrist-wearable device 1902, AR glasses 1904, and/or an HIPD 1906. FIGS. 20A and 20B show a third AR system 2000 and third example user 2008 interactions using a wrist-wearable device 2002, a head-wearable device (e.g., VR headset 2050), and/or an HIPD 2006. FIGS. 21A and 21B show a fourth AR system 2100 and fourth example user 2108 interactions using a wrist-wearable device 2130, VR headset 2120, and/or a haptic device 2160 (e.g., wearable gloves).

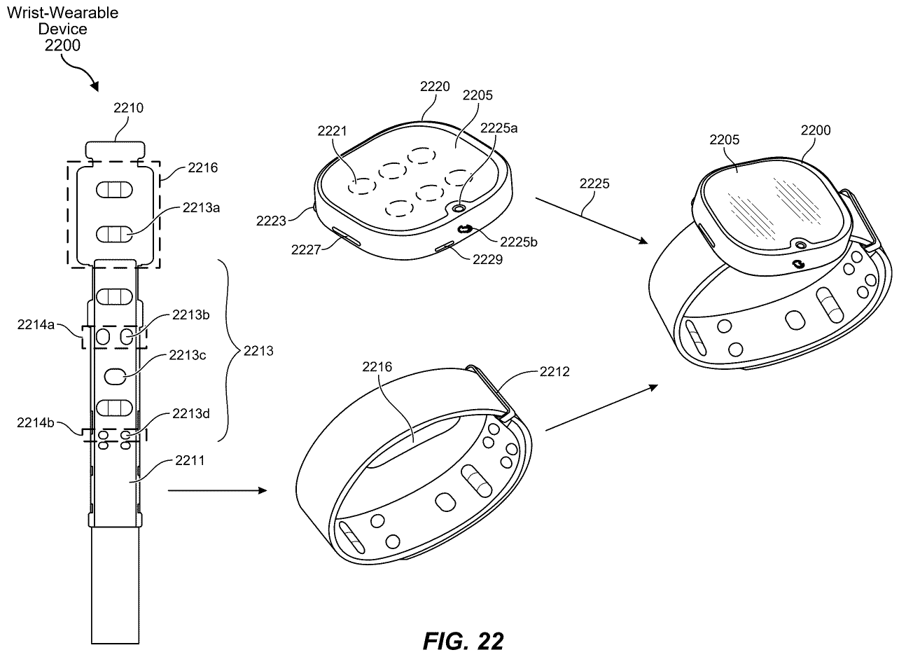

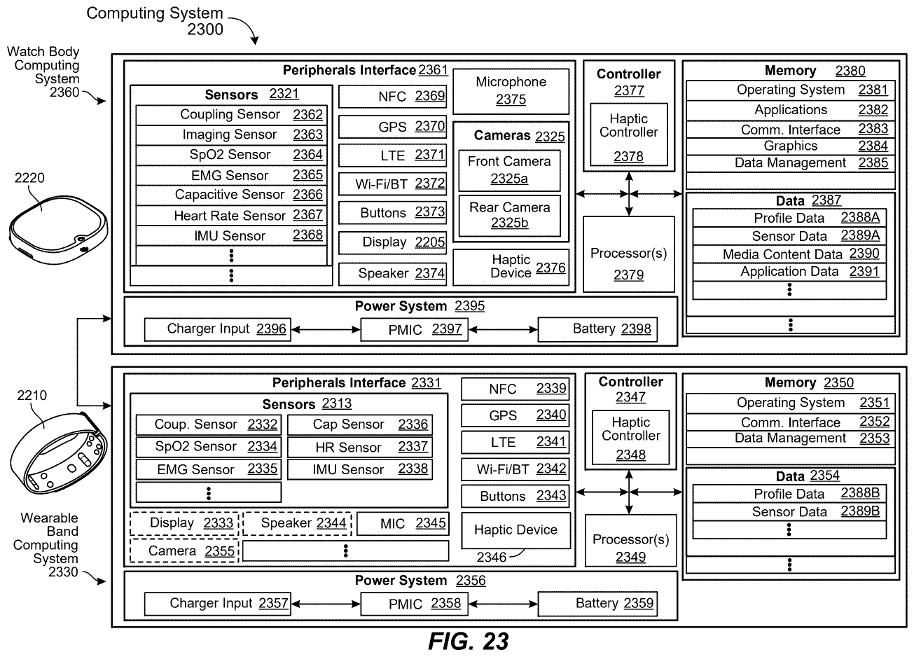

A wrist-wearable device 2200, which can be used for wrist-wearable device 1802, 1902, 2002, 2130, and one or more of its components, are described below in reference to FIGS. 22 and 23; head-wearable devices 2400 and 2500, which can respectively be used for AR glasses 1804, 1904 or VR headset 2050, 2120, and their one or more components are described below in reference to FIGS. 24-26.

Referring to FIG. 18, wrist-wearable device 1802, AR glasses 1804, and/or HIPD 1806 can communicatively couple via a network 1825 (e.g., cellular, near field, Wi-Fi, personal area network, wireless LAN, etc.). Additionally, wrist-wearable device 1802, AR glasses 1804, and/or HIPD 1806 can also communicatively couple with one or more servers 1830, computers 1840 (e.g., laptops, computers, etc.), mobile devices 1850 (e.g., smartphones, tablets, etc.), and/or other electronic devices via network 1825 (e.g., cellular, near field, Wi-Fi, personal area network, wireless LAN, etc.).

In FIG. 18, a user 1808 is shown wearing wrist-wearable device 1802 and AR glasses 1804 and having HIPD 1806 on their desk. The wrist-wearable device 1802, AR glasses 1804, and HIPD 1806 facilitate user interaction with an AR environment. In particular, as shown by first AR system 1800, wrist-wearable device 1802, AR glasses 1804, and/or HIPD 1806 cause presentation of one or more avatars 1810, digital representations of contacts 1812, and virtual objects 1814. As discussed below, user 1808 can interact with one or more avatars 1810, digital representations of contacts 1812, and virtual objects 1814 via wrist-wearable device 1802, AR glasses 1804, and/or HIPD 1806.

User 1808 can use any of wrist-wearable device 1802, AR glasses 1804, and/or HIPD 1806 to provide user inputs. For example, user 1808 can perform one or more hand gestures that are detected by wrist-wearable device 1802 (e.g., using one or more EMG sensors and/or IMUs, described below in reference to FIGS. 22 and 23) and/or AR glasses 1804 (e.g., using one or more image sensor or camera, described below in reference to FIGS. 24-10) to provide a user input. Alternatively, or additionally, user 1808 can provide a user input via one or more touch surfaces of wrist-wearable device 1802, AR glasses 1804, HIPD 1806, and/or voice commands captured by a microphone of wrist-wearable device 1802, AR glasses 1804, and/or HIPD 1806. In some embodiments, wrist-wearable device 1802, AR glasses 1804, and/or HIPD 1806 include a digital assistant to help user 1808 in providing a user input (e.g., completing a sequence of operations, suggesting different operations or commands, providing reminders, confirming a command, etc.). In some embodiments, user 1808 can provide a user input via one or more facial gestures and/or facial expressions. For example, cameras of wrist-wearable device 1802, AR glasses 1804, and/or HIPD 1806 can track eyes of user 1808 for navigating a user interface.

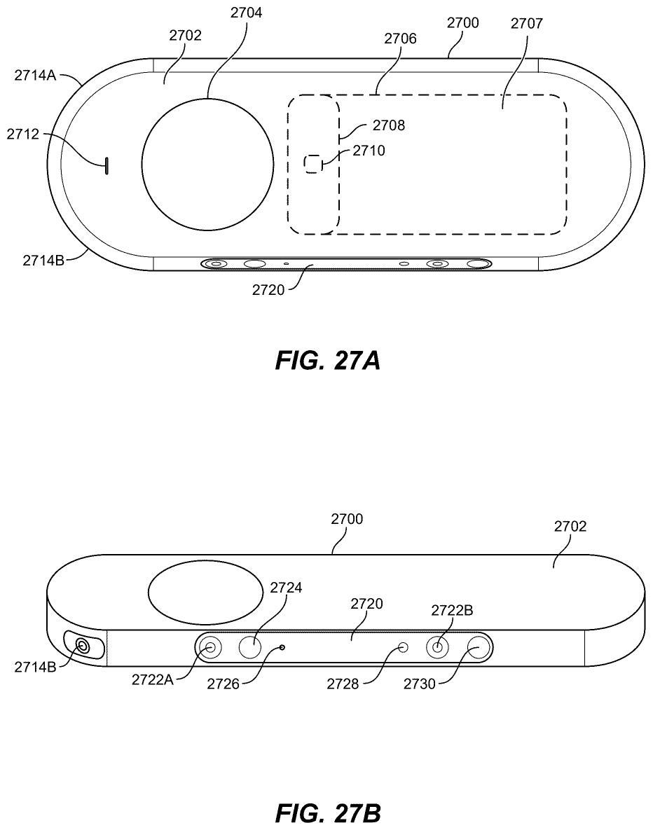

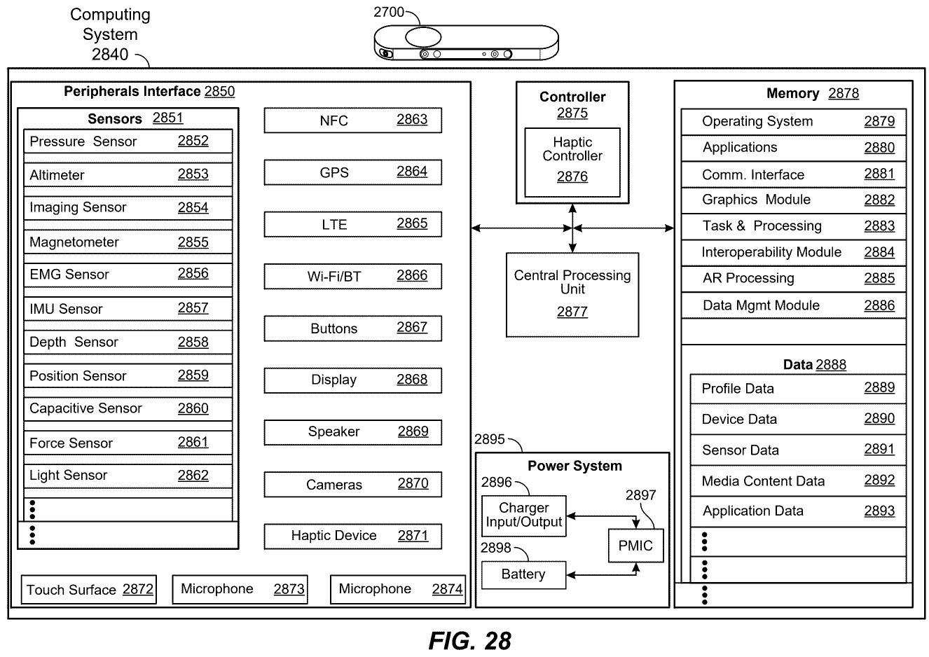

Wrist-wearable device 1802, AR glasses 1804, and/or HIPD 1806 can operate alone or in conjunction to allow user 1808 to interact with the AR environment. In some embodiments, HIPD 1806 is configured to operate as a central hub or control center for the wrist-wearable device 1802, AR glasses 1804, and/or another communicatively coupled device. For example, user 1808 can provide an input to interact with the AR environment at any of wrist-wearable device 1802, AR glasses 1804, and/or HIPD 1806, and HIPD 1806 can identify one or more back-end and front-end tasks to cause the performance of the requested interaction and distribute instructions to cause the performance of the one or more back-end and front-end tasks at wrist-wearable device 1802, AR glasses 1804, and/or HIPD 1806. In some embodiments, a back-end task is a background processing task that is not perceptible by the user (e.g., rendering content, decompression, compression, etc.), and a front-end task is a user-facing task that is perceptible to the user (e.g., presenting information to the user, providing feedback to the user, etc.). As described below in reference to FIGS. 27-28, HIPD 1806 can perform the back-end tasks and provide wrist-wearable device 1802 and/or AR glasses 1804 operational data corresponding to the performed back-end tasks such that wrist-wearable device 1802 and/or AR glasses 1804 can perform the front-end tasks. In this way, HIPD 1806, which has more computational resources and greater thermal headroom than wrist-wearable device 1802 and/or AR glasses 1804, performs computationally intensive tasks and reduces the computer resource utilization and/or power usage of wrist-wearable device 1802 and/or AR glasses 1804.

In the example shown by first AR system 1800, HIPD 1806 identifies one or more back-end tasks and front-end tasks associated with a user request to initiate an AR video call with one or more other users (represented by avatar 1810 and the digital representation of contact 1812) and distributes instructions to cause the performance of the one or more back-end tasks and front-end tasks. In particular, HIPD 1806 performs back-end tasks for processing and/or rendering image data (and other data) associated with the AR video call and provides operational data associated with the performed back-end tasks to AR glasses 1804 such that the AR glasses 1804 perform front-end tasks for presenting the AR video call (e.g., presenting avatar 1810 and digital representation of contact 1812).

In some embodiments, HIPD 1806 can operate as a focal or anchor point for causing the presentation of information. This allows user 1808 to be generally aware of where information is presented. For example, as shown in first AR system 1800, avatar 1810 and the digital representation of contact 1812 are presented above HIPD 1806. In particular, HIPD 1806 and AR glasses 1804 operate in conjunction to determine a location for presenting avatar 1810 and the digital representation of contact 1812. In some embodiments, information can be presented a predetermined distance from HIPD 1806 (e.g., within 5 meters). For example, as shown in first AR system 1800, virtual object 1814 is presented on the desk some distance from HIPD 1806. Similar to the above example, HIPD 1806 and AR glasses 1804 can operate in conjunction to determine a location for presenting virtual object 1814. Alternatively, in some embodiments, presentation of information is not bound by HIPD 1806. More specifically, avatar 1810, digital representation of contact 1812, and virtual object 1814 do not have to be presented within a predetermined distance of HIPD 1806.

User inputs provided at wrist-wearable device 1802, AR glasses 1804, and/or HIPD 1806 are coordinated such that the user can use any device to initiate, continue, and/or complete an operation. For example, user 1808 can provide a user input to AR glasses 1804 to cause AR glasses 1804 to present virtual object 1814 and, while virtual object 1814 is presented by AR glasses 1804, user 1808 can provide one or more hand gestures via wrist-wearable device 1802 to interact and/or manipulate virtual object 1814.

FIG. 19 shows a user 1908 wearing a wrist-wearable device 1902 and AR glasses 1904, and holding an HIPD 1906. In second AR system 1900, the wrist-wearable device 1902, AR glasses 1904, and/or HIPD 1906 are used to receive and/or provide one or more messages to a contact of user 1908. In particular, wrist-wearable device 1902, AR glasses 1904, and/or HIPD 1906 detect and coordinate one or more user inputs to initiate a messaging application and prepare a response to a received message via the messaging application.

In some embodiments, user 1908 initiates, via a user input, an application on wrist-wearable device 1902, AR glasses 1904, and/or HIPD 1906 that causes the application to initiate on at least one device. For example, in second AR system 1900, user 1908 performs a hand gesture associated with a command for initiating a messaging application (represented by messaging user interface 1916), wrist-wearable device 1902 detects the hand gesture and, based on a determination that user 1908 is wearing AR glasses 1904, causes AR glasses 1904 to present a messaging user interface 1916 of the messaging application. AR glasses 1904 can present messaging user interface 1916 to user 1908 via its display (e.g., as shown by a field of view 1918 of user 1908). In some embodiments, the application is initiated and executed on the device (e.g., wrist-wearable device 1902, AR glasses 1904, and/or HIPD 1906) that detects the user input to initiate the application, and the device provides another device operational data to cause the presentation of the messaging application. For example, wrist-wearable device 1902 can detect the user input to initiate a messaging application, initiate and run the messaging application, and provide operational data to AR glasses 1904 and/or HIPD 1906 to cause presentation of the messaging application. Alternatively, the application can be initiated and executed at a device other than the device that detected the user input. For example, wrist-wearable device 1902 can detect the hand gesture associated with initiating the messaging application and cause HIPD 1906 to run the messaging application and coordinate the presentation of the messaging application.

Further, user 1908 can provide a user input provided at wrist-wearable device 1902, AR glasses 1904, and/or HIPD 1906 to continue and/or complete an operation initiated at another device. For example, after initiating the messaging application via wrist-wearable device 1902 and while AR glasses 1904 present messaging user interface 1916, user 1908 can provide an input at HIPD 1906 to prepare a response (e.g., shown by the swipe gesture performed on HIPD 1906). Gestures performed by user 1908 on HIPD 1906 can be provided and/or displayed on another device. For example, a swipe gestured performed on HIPD 1906 is displayed on a virtual keyboard of messaging user interface 1916 displayed by AR glasses 1904.

In some embodiments, wrist-wearable device 1902, AR glasses 1904, HIPD 1906, and/or any other communicatively coupled device can present one or more notifications to user 1908. The notification can be an indication of a new message, an incoming call, an application update, a status update, etc. User 1908 can select the notification via wrist-wearable device 1902, AR glasses 1904, and/or HIPD 1906 and can cause presentation of an application or operation associated with the notification on at least one device. For example, user 1908 can receive a notification that a message was received at wrist-wearable device 1902, AR glasses 1904, HIPD 1906, and/or any other communicatively coupled device and can then provide a user input at wrist-wearable device 1902, AR glasses 1904, and/or HIPD 1906 to review the notification, and the device detecting the user input can cause an application associated with the notification to be initiated and/or presented at wrist-wearable device 1902, AR glasses 1904, and/or HIPD 1906.

While the above example describes coordinated inputs used to interact with a messaging application, user inputs can be coordinated to interact with any number of applications including, but not limited to, gaming applications, social media applications, camera applications, web-based applications, financial applications, etc. For example, AR glasses 1904 can present to user 1908 game application data, and HIPD 1906 can be used as a controller to provide inputs to the game. Similarly, user 1908 can use wrist-wearable device 1902 to initiate a camera of AR glasses 1904, and user 1908 can use wrist-wearable device 1902, AR glasses 1904, and/or HIPD 1906 to manipulate the image capture (e.g., zoom in or out, apply filters, etc.) and capture image data.

Users may interact with the devices disclosed herein in a variety of ways. For example, as shown in FIGS. 20A and 20B, a user 2008 may interact with an AR system 2000 by donning a VR headset 2050 while holding HIPD 2006 and wearing wrist-wearable device 2002. In this example, AR system 2000 may enable a user to interact with a game 2010 by swiping their arm. One or more of VR headset 2050, HIPD 2006, and wrist-wearable device 2002 may detect this gesture and, in response, may display a sword strike in game 2010. Similarly, in FIGS. 21A and 21B, a user 2108 may interact with an AR system 2100 by donning a VR headset 2120 while wearing haptic device 2160 and wrist-wearable device 2130. In this example, AR system 2100 may enable a user to interact with a game 2110 by swiping their arm. One or more of VR headset 2120, haptic device 2160, and wrist-wearable device 2130 may detect this gesture and, in response, may display a spell being cast in game 2010.

Having discussed example AR systems, devices for interacting with such AR systems and other computing systems more generally will now be discussed in greater detail. Some explanations of devices and components that can be included in some or all of the example devices discussed below are explained herein for ease of reference. Certain types of the components described below may be more suitable for a particular set of devices, and less suitable for a different set of devices. But subsequent reference to the components explained here should be considered to be encompassed by the descriptions provided.

In some embodiments discussed below, example devices and systems, including electronic devices and systems, will be addressed. Such example devices and systems are not intended to be limiting, and one of skill in the art will understand that alternative devices and systems to the example devices and systems described herein may be used to perform the operations and construct the systems and devices that are described herein.

An electronic device may be a device that uses electrical energy to perform a specific function. An electronic device can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device may be a device that sits between two other electronic devices and/or a subset of components of one or more electronic devices and facilitates communication, data processing, and/or data transfer between the respective electronic devices and/or electronic components.

An integrated circuit may be an electronic device made up of multiple interconnected electronic components such as transistors, resistors, and capacitors. These components may be etched onto a small piece of semiconductor material, such as silicon. Integrated circuits may include analog integrated circuits, digital integrated circuits, mixed signal integrated circuits, and/or any other suitable type or form of integrated circuit. Examples of integrated circuits include application-specific integrated circuits (ASICs), processing units, central processing units (CPUs), co-processors, and accelerators.

Analog integrated circuits, such as sensors, power management circuits, and operational amplifiers, may process continuous signals and perform analog functions such as amplification, active filtering, demodulation, and mixing. Examples of analog integrated circuits include linear integrated circuits and radio frequency circuits.

Digital integrated circuits, which may be referred to as logic integrated circuits, may include microprocessors, microcontrollers, memory chips, interfaces, power management circuits, programmable devices, and/or any other suitable type or form of integrated circuit. In some embodiments, examples of integrated circuits include central processing units (CPUs),

Processing units, such as CPUs, may be electronic components that are responsible for executing instructions and controlling the operation of an electronic device (e.g., a computer). There are various types of processors that may be used interchangeably, or may be specifically required, by embodiments described herein. For example, a processor may be: (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) an accelerator, such as a graphics processing unit (GPU), designed to accelerate the creation and rendering of images, videos, and animations (e.g., virtual-reality animations, such as three-dimensional modeling); (iv) a field-programmable gate array (FPGA) that can be programmed and reconfigured after manufacturing and/or can be customized to perform specific tasks, such as signal processing, cryptography, and machine learning; and/or (v) a digital signal processor (DSP) designed to perform mathematical operations on signals such as audio, video, and radio waves. One or more processors of one or more electronic devices may be used in various embodiments described herein.

Memory generally refers to electronic components in a computer or electronic device that store data and instructions for the processor to access and manipulate. Examples of memory can include: (i) random access memory (RAM) configured to store data and instructions temporarily; (ii) read-only memory (ROM) configured to store data and instructions permanently (e.g., one or more portions of system firmware, and/or boot loaders) and/or semi-permanently; (iii) flash memory, which can be configured to store data in electronic devices (e.g., USB drives, memory cards, and/or solid-state drives (SSDs)); and/or (iv) cache memory configured to temporarily store frequently accessed data and instructions. Memory, as described herein, can store structured data (e.g., SQL databases, MongoDB databases, GraphQL data, JSON data, etc.). Other examples of data stored in memory can include (i) profile data, including user account data, user settings, and/or other user data stored by the user, (ii) sensor data detected and/or otherwise obtained by one or more sensors, (iii) media content data including stored image data, audio data, documents, and the like, (iv) application data, which can include data collected and/or otherwise obtained and stored during use of an application, and/or any other types of data described herein.

Controllers may be electronic components that manage and coordinate the operation of other components within an electronic device (e.g., controlling inputs, processing data, and/or generating outputs). Examples of controllers can include: (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs.

A power system of an electronic device may be configured to convert incoming electrical power into a form that can be used to operate the device. A power system can include various components, such as (i) a power source, which can be an alternating current (AC) adapter or a direct current (DC) adapter power supply, (ii) a charger input, which can be configured to use a wired and/or wireless connection (which may be part of a peripheral interface, such as a USB, micro-USB interface, near-field magnetic coupling, magnetic inductive and magnetic resonance charging, and/or radio frequency (RF) charging), (iii) a power-management integrated circuit, configured to distribute power to various components of the device and to ensure that the device operates within safe limits (e.g., regulating voltage, controlling current flow, and/or managing heat dissipation), and/or (iv) a battery configured to store power to provide usable power to components of one or more electronic devices.

Peripheral interfaces may be electronic components (e.g., of electronic devices) that allow electronic devices to communicate with other devices or peripherals and can provide the ability to input and output data and signals. Examples of peripheral interfaces can include (i) universal serial bus (USB) and/or micro-USB interfaces configured for connecting devices to an electronic device, (ii) Bluetooth interfaces configured to allow devices to communicate with each other, including Bluetooth low energy (BLE), (iii) near field communication (NFC) interfaces configured to be short-range wireless interfaces for operations such as access control, (iv) POGO pins, which may be small, spring-loaded pins configured to provide a charging interface, (v) wireless charging interfaces, (vi) GPS interfaces, (vii) Wi-Fi interfaces for providing a connection between a device and a wireless network, and/or (viii) sensor interfaces.

Sensors may be electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device), (ii) biopotential-signal sensors, (iii) inertial measurement units (e.g., IMUs) for detecting, for example, angular rate, force, magnetic field, and/or changes in acceleration, (iv) heart rate sensors for measuring a user's heart rate, (v) SpO2 sensors for measuring blood oxygen saturation and/or other biometric data of a user, (vi) capacitive sensors for detecting changes in potential at a portion of a user's body (e.g., a sensor-skin interface), and/or (vii) light sensors (e.g., time-of-flight sensors, infrared light sensors, visible light sensors, etc.).

Biopotential-signal-sensing components may be devices used to measure electrical activity within the body (e.g., biopotential-signal sensors). Some types of biopotential-signal sensors include (i) electroencephalography (EEG) sensors configured to measure electrical activity in the brain to diagnose neurological disorders, (ii) electrocardiogramar EKG) sensors configured to measure electrical activity of the heart to diagnose heart problems, (iii) electromyography (EMG) sensors configured to measure the electrical activity of muscles and to diagnose neuromuscular disorders, and (iv) electrooculography (EOG) sensors configure to measure the electrical activity of eye muscles to detect eye movement and diagnose eye disorders.

An application stored in memory of an electronic device (e.g., software) may include instructions stored in the memory. Examples of such applications include (i) games, (ii) word processors, (iii) messaging applications, (iv) media-streaming applications, (v) financial applications, (vi) calendars. (vii) clocks, and (viii) communication interface modules for enabling wired and/or wireless connections between different respective electronic devices (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocols).

A communication interface may be a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, Bluetooth). In some embodiments, a communication interface can refer to a software layer that enables different software programs to communicate with each other (e.g., application programming interfaces (APIs), protocols like HTTP and TCP/IP, etc.).

A graphics module may be a component or software module that is designed to handle graphical operations and/or processes and can include a hardware module and/or a software module.

Non-transitory computer-readable storage media may be physical devices or storage media that can be used to store electronic data in a non-transitory form (e.g., such that the data is stored permanently until it is intentionally deleted or modified).

FIGS. 22 and 23 illustrate an example wrist-wearable device 2200 and an example computer system 2300, in accordance with some embodiments. Wrist-wearable device 2200 is an instance of wearable device 1802 described in FIG. 18 herein, such that the wearable device 1802 should be understood to have the features of the wrist-wearable device 2200 and vice versa. FIG. 23 illustrates components of the wrist-wearable device 2200, which can be used individually or in combination, including combinations that include other electronic devices and/or electronic components.

FIG. 22 shows a wearable band 2210 and a watch body 2220 (or capsule) being coupled, as discussed below, to form wrist-wearable device 2200. Wrist-wearable device 2200 can perform various functions and/or operations associated with navigating through user interfaces and selectively opening applications as well as the functions and/or operations described above with reference to FIGS. 18-21B.

As will be described in more detail below, operations executed by wrist-wearable device 2200 can include (i) presenting content to a user (e.g., displaying visual content via a display 2205), (ii) detecting (e.g., sensing) user input (e.g., sensing a touch on peripheral button 2223 and/or at a touch screen of the display 2205, a hand gesture detected by sensors (e.g., biopotential sensors)), (iii) sensing biometric data (e.g., neuromuscular signals, heart rate, temperature, sleep, etc.) via one or more sensors 2213, messaging (e.g., text, speech, video, etc.); image capture via one or more imaging devices or cameras 2225, wireless communications (e.g., cellular, near field, Wi-Fi, personal area network, etc.), location determination, financial transactions, providing haptic feedback, providing alarms, providing notifications, providing biometric authentication, providing health monitoring, providing sleep monitoring, etc.

The above-example functions can be executed independently in watch body 2220, independently in wearable band 2210, and/or via an electronic communication between watch body 2220 and wearable band 2210. In some embodiments, functions can be executed on wrist-wearable device 2200 while an AR environment is being presented (e.g., via one of AR systems 1800 to 2100). The wearable devices described herein can also be used with other types of AR environments.

Wearable band 2210 can be configured to be worn by a user such that an inner surface of a wearable structure 2211 of wearable band 2210 is in contact with the user's skin. In this example, when worn by a user, sensors 2213 may contact the user's skin. In some examples, one or more of sensors 2213 can sense biometric data such as a user's heart rate, a saturated oxygen level, temperature, sweat level, neuromuscular signals, or a combination thereof. One or more of sensors 2213 can also sense data about a user's environment including a user's motion, altitude, location, orientation, gait, acceleration, position, or a combination thereof. In some embodiment, one or more of sensors 2213 can be configured to track a position and/or motion of wearable band 2210. One or more of sensors 2213 can include any of the sensors defined above and/or discussed below with respect to FIG. 22.

One or more of sensors 2213 can be distributed on an inside and/or an outside surface of wearable band 2210. In some embodiments, one or more of sensors 2213 are uniformly spaced along wearable band 2210. Alternatively, in some embodiments, one or more of sensors 2213 are positioned at distinct points along wearable band 2210. As shown in FIG. 22, one or more of sensors 2213 can be the same or distinct. For example, in some embodiments, one or more of sensors 2213 can be shaped as a pill (e.g., sensor 2213a), an oval, a circle a square, an oblong (e.g., sensor 2213c) and/or any other shape that maintains contact with the user's skin (e.g., such that neuromuscular signal and/or other biometric data can be accurately measured at the user's skin). In some embodiments, one or more sensors of 2213 are aligned to form pairs of sensors (e.g., for sensing neuromuscular signals based on differential sensing within each respective sensor). For example, sensor 2213b may be aligned with an adjacent sensor to form sensor pair 2214a and sensor 2213d may be aligned with an adjacent sensor to form sensor pair 2214b. In some embodiments, wearable band 2210 does not have a sensor pair. Alternatively, in some embodiments, wearable band 2210 has a predetermined number of sensor pairs (one pair of sensors, three pairs of sensors, four pairs of sensors, six pairs of sensors, sixteen pairs of sensors, etc.).

Wearable band 2210 can include any suitable number of sensors 2213. In some embodiments, the number and arrangement of sensors 2213 depends on the particular application for which wearable band 2210 is used. For instance, wearable band 2210 can be configured as an armband, wristband, or chest-band that include a plurality of sensors 2213 with different number of sensors 2213, a variety of types of individual sensors with the plurality of sensors 2213, and different arrangements for each use case, such as medical use cases as compared to gaming or general day-to-day use cases.

In accordance with some embodiments, wearable band 2210 further includes an electrical ground electrode and a shielding electrode. The electrical ground and shielding electrodes, like the sensors 2213, can be distributed on the inside surface of the wearable band 2210 such that they contact a portion of the user's skin. For example, the electrical ground and shielding electrodes can be at an inside surface of a coupling mechanism 2216 or an inside surface of a wearable structure 2211. The electrical ground and shielding electrodes can be formed and/or use the same components as sensors 2213. In some embodiments, wearable band 2210 includes more than one electrical ground electrode and more than one shielding electrode.

Sensors 2213 can be formed as part of wearable structure 2211 of wearable band 2210. In some embodiments, sensors 2213 are flush or substantially flush with wearable structure 2211 such that they do not extend beyond the surface of wearable structure 2211. While flush with wearable structure 2211, sensors 2213 are still configured to contact the user's skin (e.g., via a skin-contacting surface). Alternatively, in some embodiments, sensors 2213 extend beyond wearable structure 2211 a predetermined distance (e.g., 0.1-2 mm) to make contact and depress into the user's skin. In some embodiment, sensors 2213 are coupled to an actuator (not shown) configured to adjust an extension height (e.g., a distance from the surface of wearable structure 2211) of sensors 2213 such that sensors 2213 make contact and depress into the user's skin. In some embodiments, the actuators adjust the extension height between 0.01 mm-1.2 mm. This may allow a the user to customize the positioning of sensors 2213 to improve the overall comfort of the wearable band 2210 when worn while still allowing sensors 2213 to contact the user's skin. In some embodiments, sensors 2213 are indistinguishable from wearable structure 2211 when worn by the user.

Wearable structure 2211 can be formed of an elastic material, elastomers, etc., configured to be stretched and fitted to be worn by the user. In some embodiments, wearable structure 2211 is a textile or woven fabric. As described above, sensors 2213 can be formed as part of a wearable structure 2211. For example, sensors 2213 can be molded into the wearable structure 2211, be integrated into a woven fabric (e.g., sensors 2213 can be sewn into the fabric and mimic the pliability of fabric and can and/or be constructed from a series woven strands of fabric).

Wearable structure 2211 can include flexible electronic connectors that interconnect sensors 2213, the electronic circuitry, and/or other electronic components (described below in reference to FIG. 23) that are enclosed in wearable band 2210. In some embodiments, the flexible electronic connectors are configured to interconnect sensors 2213, the electronic circuitry, and/or other electronic components of wearable band 2210 with respective sensors and/or other electronic components of another electronic device (e.g., watch body 2220). The flexible electronic connectors are configured to move with wearable structure 2211 such that the user adjustment to wearable structure 2211 (e.g., resizing, pulling, folding, etc.) does not stress or strain the electrical coupling of components of wearable band 2210.

As described above, wearable band 2210 is configured to be worn by a user. In particular, wearable band 2210 can be shaped or otherwise manipulated to be worn by a user. For example, wearable band 2210 can be shaped to have a substantially circular shape such that it can be configured to be worn on the user's lower arm or wrist. Alternatively, wearable band 2210 can be shaped to be worn on another body part of the user, such as the user's upper arm (e.g., around a bicep), forearm, chest, legs, etc. Wearable band 2210 can include a retaining mechanism 2212 (e.g., a buckle, a hook and loop fastener, etc.) for securing wearable band 2210 to the user's wrist or other body part. While wearable band 2210 is worn by the user, sensors 2213 sense data (referred to as sensor data) from the user's skin. In some examples, sensors 2213 of wearable band 2210 obtain (e.g., sense and record) neuromuscular signals.

The sensed data (e.g., sensed neuromuscular signals) can be used to detect and/or determine the user's intention to perform certain motor actions. In some examples, sensors 2213 may sense and record neuromuscular signals from the user as the user performs muscular activations (e.g., movements, gestures, etc.). The detected and/or determined motor actions (e.g., phalange (or digit) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on display 2205 of wrist-wearable device 2200 and/or can be transmitted to a device responsible for rendering an artificial-reality environment (e.g., a head-mounted display) to perform an action in an associated artificial-reality environment, such as to control the motion of a virtual device displayed to the user. The muscular activations performed by the user can include static gestures, such as placing the user's hand palm down on a table, dynamic gestures, such as grasping a physical or virtual object, and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by sensors 2213 can be used to provide a user with an enhanced interaction with a physical object (e.g., devices communicatively coupled with wearable band 2210) and/or a virtual object in an artificial-reality application generated by an artificial-reality system (e.g., user interface objects presented on the display 2205, or another computing device (e.g., a smartphone)).

In some embodiments, wearable band 2210 includes one or more haptic devices 2346 (e.g., a vibratory haptic actuator) that are configured to provide haptic feedback (e.g., a cutaneous and/or kinesthetic sensation, etc.) to the user's skin. Sensors 2213 and/or haptic devices 2346 (shown in FIG. 23) can be configured to operate in conjunction with multiple applications including, without limitation, health monitoring, social media, games, and artificial reality (e.g., the applications associated with artificial reality).

Wearable band 2210 can also include coupling mechanism 2216 for detachably coupling a capsule (e.g., a computing unit) or watch body 2220 (via a coupling surface of the watch body 2220) to wearable band 2210. For example, a cradle or a shape of coupling mechanism 2216 can correspond to shape of watch body 2220 of wrist-wearable device 2200. In particular, coupling mechanism 2216 can be configured to receive a coupling surface proximate to the bottom side of watch body 2220 (e.g., a side opposite to a front side of watch body 2220 where display 2205 is located), such that a user can push watch body 2220 downward into coupling mechanism 2216 to attach watch body 2220 to coupling mechanism 2216. In some embodiments, coupling mechanism 2216 can be configured to receive a top side of the watch body 2220 (e.g., a side proximate to the front side of watch body 2220 where display 2205 is located) that is pushed upward into the cradle, as opposed to being pushed downward into coupling mechanism 2216. In some embodiments, coupling mechanism 2216 is an integrated component of wearable band 2210 such that wearable band 2210 and coupling mechanism 2216 are a single unitary structure. In some embodiments, coupling mechanism 2216 is a type of frame or shell that allows watch body 2220 coupling surface to be retained within or on wearable band 2210 coupling mechanism 2216 (e.g., a cradle, a tracker band, a support base, a clasp, etc.).

Coupling mechanism 2216 can allow for watch body 2220 to be detachably coupled to the wearable band 2210 through a friction fit, magnetic coupling, a rotation-based connector, a shear-pin coupler, a retention spring, one or more magnets, a clip, a pin shaft, a hook and loop fastener, or a combination thereof. A user can perform any type of motion to couple the watch body 2220 to wearable band 2210 and to decouple the watch body 2220 from the wearable band 2210. For example, a user can twist, slide, turn, push, pull, or rotate watch body 2220 relative to wearable band 2210, or a combination thereof, to attach watch body 2220 to wearable band 2210 and to detach watch body 2220 from wearable band 2210. Alternatively, as discussed below, in some embodiments, the watch body 2220 can be decoupled from the wearable band 2210 by actuation of a release mechanism 2229.

Wearable band 2210 can be coupled with watch body 2220 to increase the functionality of wearable band 2210 (e.g., converting wearable band 2210 into wrist-wearable device 2200, adding an additional computing unit and/or battery to increase computational resources and/or a battery life of wearable band 2210, adding additional sensors to improve sensed data, etc.). As described above, wearable band 2210 and coupling mechanism 2216 are configured to operate independently (e.g., execute functions independently) from watch body 2220. For example, coupling mechanism 2216 can include one or more sensors 2213 that contact a user's skin when wearable band 2210 is worn by the user, with or without watch body 2220 and can provide sensor data for determining control commands.

A user can detach watch body 2220 from wearable band 2210 to reduce the encumbrance of wrist-wearable device 2200 to the user. For embodiments in which watch body 2220 is removable, watch body 2220 can be referred to as a removable structure, such that in these embodiments wrist-wearable device 2200 includes a wearable portion (e.g., wearable band 2210) and a removable structure (e.g., watch body 2220).

Turning to watch body 2220, in some examples watch body 2220 can have a substantially rectangular or circular shape. Watch body 2220 is configured to be worn by the user on their wrist or on another body part. More specifically, watch body 2220 is sized to be easily carried by the user, attached on a portion of the user's clothing, and/or coupled to wearable band 2210 (forming the wrist-wearable device 2200). As described above, watch body 2220 can have a shape corresponding to coupling mechanism 2216 of wearable band 2210. In some embodiments, watch body 2220 includes a single release mechanism 2229 or multiple release mechanisms (e.g., two release mechanisms 2229 positioned on opposing sides of watch body 2220, such as spring-loaded buttons) for decoupling watch body 2220 from wearable band 2210. Release mechanism 2229 can include, without limitation, a button, a knob, a plunger, a handle, a lever, a fastener, a clasp, a dial, a latch, or a combination thereof.

A user can actuate release mechanism 2229 by pushing, turning, lifting, depressing, shifting, or performing other actions on release mechanism 2229. Actuation of release mechanism 2229 can release (e.g., decouple) watch body 2220 from coupling mechanism 2216 of wearable band 2210, allowing the user to use watch body 2220 independently from wearable band 2210 and vice versa. For example, decoupling watch body 2220 from wearable band 2210 can allow a user to capture images using rear-facing camera 2225b. Although release mechanism 2229 is shown positioned at a corner of watch body 2220, release mechanism 2229 can be positioned anywhere on watch body 2220 that is convenient for the user to actuate. In addition, in some embodiments, wearable band 2210 can also include a respective release mechanism for decoupling watch body 2220 from coupling mechanism 2216. In some embodiments, release mechanism 2229 is optional and watch body 2220 can be decoupled from coupling mechanism 2216 as described above (e.g., via twisting, rotating, etc.).

Watch body 2220 can include one or more peripheral buttons 2223 and 2227 for performing various operations at watch body 2220. For example, peripheral buttons 2223 and 2227 can be used to turn on or wake (e.g., transition from a sleep state to an active state) display 2205, unlock watch body 2220, increase or decrease a volume, increase or decrease a brightness, interact with one or more applications, interact with one or more user interfaces, etc. Additionally or alternatively, in some embodiments, display 2205 operates as a touch screen and allows the user to provide one or more inputs for interacting with watch body 2220.

In some embodiments, watch body 2220 includes one or more sensors 2221. Sensors 2221 of watch body 2220 can be the same or distinct from sensors 2213 of wearable band 2210. Sensors 2221 of watch body 2220 can be distributed on an inside and/or an outside surface of watch body 2220. In some embodiments, sensors 2221 are configured to contact a user's skin when watch body 2220 is worn by the user. For example, sensors 2221 can be placed on the bottom side of watch body 2220 and coupling mechanism 2216 can be a cradle with an opening that allows the bottom side of watch body 2220 to directly contact the user's skin. Alternatively, in some embodiments, watch body 2220 does not include sensors that are configured to contact the user's skin (e.g., including sensors internal and/or external to the watch body 2220 that are configured to sense data of watch body 2220 and the surrounding environment). In some embodiments, sensors 2221 are configured to track a position and/or motion of watch body 2220.

Watch body 2220 and wearable band 2210 can share data using a wired communication method (e.g., a Universal Asynchronous Receiver/Transmitter (UART), a USB transceiver, etc.) and/or a wireless communication method (e.g., near field communication, Bluetooth, etc.). For example, watch body 2220 and wearable band 2210 can share data sensed by sensors 2213 and 2221, as well as application and device specific information (e.g., active and/or available applications, output devices (e.g., displays, speakers, etc.), input devices (e.g., touch screens, microphones, imaging sensors, etc.).

In some embodiments, watch body 2220 can include, without limitation, a front-facing camera 2225a and/or a rear-facing camera 2225b, sensors 2221 (e.g., a biometric sensor, an IMU, a heart rate sensor, a saturated oxygen sensor, a neuromuscular signal sensor, an altimeter sensor, a temperature sensor, a bioimpedance sensor, a pedometer sensor, an optical sensor (e.g., imaging sensor 2363), a touch sensor, a sweat sensor, etc.). In some embodiments, watch body 2220 can include one or more haptic devices 2376 (e.g., a vibratory haptic actuator) that is configured to provide haptic feedback (e.g., a cutaneous and/or kinesthetic sensation, etc.) to the user. Sensors 2321 and/or haptic device 2376 can also be configured to operate in conjunction with multiple applications including, without limitation, health monitoring applications, social media applications, game applications, and artificial reality applications (e.g., the applications associated with artificial reality).

As described above, watch body 2220 and wearable band 2210, when coupled, can form wrist-wearable device 2200. When coupled, watch body 2220 and wearable band 2210 may operate as a single device to execute functions (operations, detections, communications, etc.) described herein. In some embodiments, each device may be provided with particular instructions for performing the one or more operations of wrist-wearable device 2200. For example, in accordance with a determination that watch body 2220 does not include neuromuscular signal sensors, wearable band 2210 can include alternative instructions for performing associated instructions (e.g., providing sensed neuromuscular signal data to watch body 2220 via a different electronic device). Operations of wrist-wearable device 2200 can be performed by watch body 2220 alone or in conjunction with wearable band 2210 (e.g., via respective processors and/or hardware components) and vice versa. In some embodiments, operations of wrist-wearable device 2200, watch body 2220, and/or wearable band 2210 can be performed in conjunction with one or more processors and/or hardware components.

As described below with reference to the block diagram of FIG. 23, wearable band 2210 and/or watch body 2220 can each include independent resources required to independently execute functions. For example, wearable band 2210 and/or watch body 2220 can each include a power source (e.g., a battery), a memory, data storage, a processor (e.g., a central processing unit (CPU)), communications, a light source, and/or input/output devices.

FIG. 23 shows block diagrams of a computing system 2330 corresponding to wearable band 2210 and a computing system 2360 corresponding to watch body 2220 according to some embodiments. Computing system 2300 of wrist-wearable device 2200 may include a combination of components of wearable band computing system 2330 and watch body computing system 2360, in accordance with some embodiments.

Watch body 2220 and/or wearable band 2210 can include one or more components shown in watch body computing system 2360. In some embodiments, a single integrated circuit may include all or a substantial portion of the components of watch body computing system 2360 included in a single integrated circuit. Alternatively, in some embodiments, components of the watch body computing system 2360 may be included in a plurality of integrated circuits that are communicatively coupled. In some embodiments, watch body computing system 2360 may be configured to couple (e.g., via a wired or wireless connection) with wearable band computing system 2330, which may allow the computing systems to share components, distribute tasks, and/or perform other operations described herein (individually or as a single device).

Watch body computing system 2360 can include one or more processors 2379, a controller 2377, a peripherals interface 2361, a power system 2395, and memory (e.g., a memory 2380).

Power system 2395 can include a charger input 2396, a power-management integrated circuit (PMIC) 2397, and a battery 2398. In some embodiments, a watch body 2220 and a wearable band 2210 can have respective batteries (e.g., battery 2398 and 2359) and can share power with each other. Watch body 2220 and wearable band 2210 can receive a charge using a variety of techniques. In some embodiments, watch body 2220 and wearable band 2210 can use a wired charging assembly (e.g., power cords) to receive the charge. Alternatively, or in addition, watch body 2220 and/or wearable band 2210 can be configured for wireless charging. For example, a portable charging device can be designed to mate with a portion of watch body 2220 and/or wearable band 2210 and wirelessly deliver usable power to battery 2398 of watch body 2220 and/or battery 2359 of wearable band 2210. Watch body 2220 and wearable band 2210 can have independent power systems (e.g., power system 2395 and 2356, respectively) to enable each to operate independently. Watch body 2220 and wearable band 2210 can also share power (e.g., one can charge the other) via respective PMICs (e.g., PMICs 2397 and 2358) and charger inputs (e.g., 2357 and 2396) that can share power over power and ground conductors and/or over wireless charging antennas.

In some embodiments, peripherals interface 2361 can include one or more sensors 2321. Sensors 2321 can include one or more coupling sensors 2362 for detecting when watch body 2220 is coupled with another electronic device (e.g., a wearable band 2210). Sensors 2321 can include one or more imaging sensors 2363 (e.g., one or more of cameras 2325, and/or separate imaging sensors 2363 (e.g., thermal-imaging sensors)). In some embodiments, sensors 2321 can include one or more SpO2 sensors 2364. In some embodiments, sensors 2321 can include one or more biopotential-signal sensors (e.g., EMG sensors 2365, which may be disposed on an interior, user-facing portion of watch body 2220 and/or wearable band 2210). In some embodiments, sensors 2321 may include one or more capacitive sensors 2366. In some embodiments, sensors 2321 may include one or more heart rate sensors 2367. In some embodiments, sensors 2321 may include one or more IMU sensors 2368. In some embodiments, one or more IMU sensors 2368 can be configured to detect movement of a user's hand or other location where watch body 2220 is placed or held.

In some embodiments, one or more of sensors 2321 may provide an example human-machine interface. For example, a set of neuromuscular sensors, such as EMG sensors 2365, may be arranged circumferentially around wearable band 2210 with an interior surface of EMG sensors 2365 being configured to contact a user's skin. Any suitable number of neuromuscular sensors may be used (e.g., between 2 and 20 sensors). The number and arrangement of neuromuscular sensors may depend on the particular application for which the wearable device is used. For example, wearable band 2210 can be used to generate control information for controlling an augmented reality system, a robot, controlling a vehicle, scrolling through text, controlling a virtual avatar, or any other suitable control task.

In some embodiments, neuromuscular sensors may be coupled together using flexible electronics incorporated into the wireless device, and the output of one or more of the sensing components can be optionally processed using hardware signal processing circuitry (e.g., to perform amplification, filtering, and/or rectification). In other embodiments, at least some signal processing of the output of the sensing components can be performed in software such as processors 2379. Thus, signal processing of signals sampled by the sensors can be performed in hardware, software, or by any suitable combination of hardware and software, as aspects of the technology described herein are not limited in this respect.

Neuromuscular signals may be processed in a variety of ways. For example, the output of EMG sensors 2365 may be provided to an analog front end, which may be configured to perform analog processing (e.g., amplification, noise reduction, filtering, etc.) on the recorded signals. The processed analog signals may then be provided to an analog-to-digital converter, which may convert the analog signals to digital signals that can be processed by one or more computer processors. Furthermore, although this example is as discussed in the context of interfaces with EMG sensors, the embodiments described herein can also be implemented in wearable interfaces with other types of sensors including, but not limited to, mechanomyography (MMG) sensors, sonomyography (SMG) sensors, and electrical impedance tomography (EIT) sensors.

In some embodiments, peripherals interface 2361 includes a near-field communication (NFC) component 2369, a global-position system (GPS) component 2370, a long-term evolution (LTE) component 2371, and/or a Wi-Fi and/or Bluetooth communication component 2372. In some embodiments, peripherals interface 2361 includes one or more buttons 2373 (e.g., peripheral buttons 2223 and 2227 in FIG. 22), which, when selected by a user, cause operation to be performed at watch body 2220. In some embodiments, the peripherals interface 2361 includes one or more indicators, such as a light emitting diode (LED), to provide a user with visual indicators (e.g., message received, low battery, active microphone and/or camera, etc.).

Watch body 2220 can include at least one display 2205 for displaying visual representations of information or data to a user, including user-interface elements and/or three-dimensional virtual objects. The display can also include a touch screen for inputting user inputs, such as touch gestures, swipe gestures, and the like. Watch body 2220 can include at least one speaker 2374 and at least one microphone 2375 for providing audio signals to the user and receiving audio input from the user. The user can provide user inputs through microphone 2375 and can also receive audio output from speaker 2374 as part of a haptic event provided by haptic controller 2378. Watch body 2220 can include at least one camera 2325, including a front camera 2325a and a rear camera 2325b. Cameras 2325 can include ultra-wide-angle cameras, wide angle cameras, fish-eye cameras, spherical cameras, telephoto cameras, depth-sensing cameras, or other types of cameras.

Watch body computing system 2360 can include one or more haptic controllers 2378 and associated componentry (e.g., haptic devices 2376) for providing haptic events at watch body 2220 (e.g., a vibrating sensation or audio output in response to an event at the watch body 2220). Haptic controllers 2378 can communicate with one or more haptic devices 2376, such as electroacoustic devices, including a speaker of the one or more speakers 2374 and/or other audio components and/or electromechanical devices that convert energy into linear motion such as a motor, solenoid, electroactive polymer, piezoelectric actuator, electrostatic actuator, or other tactile output generating components (e.g., a component that converts electrical signals into tactile outputs on the device). Haptic controller 2378 can provide haptic events to that are capable of being sensed by a user of watch body 2220. In some embodiments, one or more haptic controllers 2378 can receive input signals from an application of applications 2382.

In some embodiments, wearable band computing system 2330 and/or watch body computing system 2360 can include memory 2380, which can be controlled by one or more memory controllers of controllers 2377. In some embodiments, software components stored in memory 2380 include one or more applications 2382 configured to perform operations at the watch body 2220. In some embodiments, one or more applications 2382 may include games, word processors, messaging applications, calling applications, web browsers, social media applications, media streaming applications, financial applications, calendars, clocks, etc. In some embodiments, software components stored in memory 2380 include one or more communication interface modules 2383 as defined above. In some embodiments, software components stored in memory 2380 include one or more graphics modules 2384 for rendering, encoding, and/or decoding audio and/or visual data and one or more data management modules 2385 for collecting, organizing, and/or providing access to data 2387 stored in memory 2380. In some embodiments, one or more of applications 2382 and/or one or more modules can work in conjunction with one another to perform various tasks at the watch body 2220.

In some embodiments, software components stored in memory 2380 can include one or more operating systems 2381 (e.g., a Linux-based operating system, an Android operating system, etc.). Memory 2380 can also include data 2387. Data 2387 can include profile data 2388A, sensor data 2389A, media content data 2390, and application data 2391.

It should be appreciated that watch body computing system 2360 is an example of a computing system within watch body 2220, and that watch body 2220 can have more or fewer components than shown in watch body computing system 2360, can combine two or more components, and/or can have a different configuration and/or arrangement of the components. The various components shown in watch body computing system 2360 are implemented in hardware, software, firmware, or a combination thereof, including one or more signal processing and/or application-specific integrated circuits.

Turning to the wearable band computing system 2330, one or more components that can be included in wearable band 2210 are shown. Wearable band computing system 2330 can include more or fewer components than shown in watch body computing system 2360, can combine two or more components, and/or can have a different configuration and/or arrangement of some or all of the components. In some embodiments, all, or a substantial portion of the components of wearable band computing system 2330 are included in a single integrated circuit. Alternatively, in some embodiments, components of wearable band computing system 2330 are included in a plurality of integrated circuits that are communicatively coupled. As described above, in some embodiments, wearable band computing system 2330 is configured to couple (e.g., via a wired or wireless connection) with watch body computing system 2360, which allows the computing systems to share components, distribute tasks, and/or perform other operations described herein (individually or as a single device).

Wearable band computing system 2330, similar to watch body computing system 2360, can include one or more processors 2349, one or more controllers 2347 (including one or more haptics controllers 2348), a peripherals interface 2331 that can includes one or more sensors 2313 and other peripheral devices, a power source (e.g., a power system 2356), and memory (e.g., a memory 2350) that includes an operating system (e.g., an operating system 2351), data (e.g., data 2354 including profile data 2388B, sensor data 2389B, etc.), and one or more modules (e.g., a communications interface module 2352, a data management module 2353, etc.).

One or more of sensors 2313 can be analogous to sensors 2321 of watch body computing system 2360. For example, sensors 2313 can include one or more coupling sensors 2332, one or more SpO2 sensors 2334, one or more EMG sensors 2335, one or more capacitive sensors 2336, one or more heart rate sensors 2337, and one or more IMU sensors 2338.

Peripherals interface 2331 can also include other components analogous to those included in peripherals interface 2361 of watch body computing system 2360, including an NFC component 2339, a GPS component 2340, an LTE component 2341, a Wi-Fi and/or Bluetooth communication component 2342, and/or one or more haptic devices 2346 as described above in reference to peripherals interface 2361. In some embodiments, peripherals interface 2331 includes one or more buttons 2343, a display 2333, a speaker 2344, a microphone 2345, and a camera 2355. In some embodiments, peripherals interface 2331 includes one or more indicators, such as an LED.

It should be appreciated that wearable band computing system 2330 is an example of a computing system within wearable band 2210, and that wearable band 2210 can have more or fewer components than shown in wearable band computing system 2330, combine two or more components, and/or have a different configuration and/or arrangement of the components. The various components shown in wearable band computing system 2330 can be implemented in one or more of a combination of hardware, software, or firmware, including one or more signal processing and/or application-specific integrated circuits.

Wrist-wearable device 2200 with respect to FIG. 22 is an example of wearable band 2210 and watch body 2220 coupled together, so wrist-wearable device 2200 will be understood to include the components shown and described for wearable band computing system 2330 and watch body computing system 2360. In some embodiments, wrist-wearable device 2200 has a split architecture (e.g., a split mechanical architecture, a split electrical architecture, etc.) between watch body 2220 and wearable band 2210. In other words, all of the components shown in wearable band computing system 2330 and watch body computing system 2360 can be housed or otherwise disposed in a combined wrist-wearable device 2200 or within individual components of watch body 2220, wearable band 2210, and/or portions thereof (e.g., a coupling mechanism 2216 of wearable band 2210).

The techniques described above can be used with any device for sensing neuromuscular signals but could also be used with other types of wearable devices for sensing neuromuscular signals (such as body-wearable or head-wearable devices that might have neuromuscular sensors closer to the brain or spinal column).

In some embodiments, wrist-wearable device 2200 can be used in conjunction with a head-wearable device (e.g., AR glasses 2400 and VR system 2510) and/or an HIPD 2700 described below, and wrist-wearable device 2200 can also be configured to be used to allow a user to control any aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable devices, attention will now be turned to example head-wearable devices, such AR glasses 2400 and VR headset 2510.

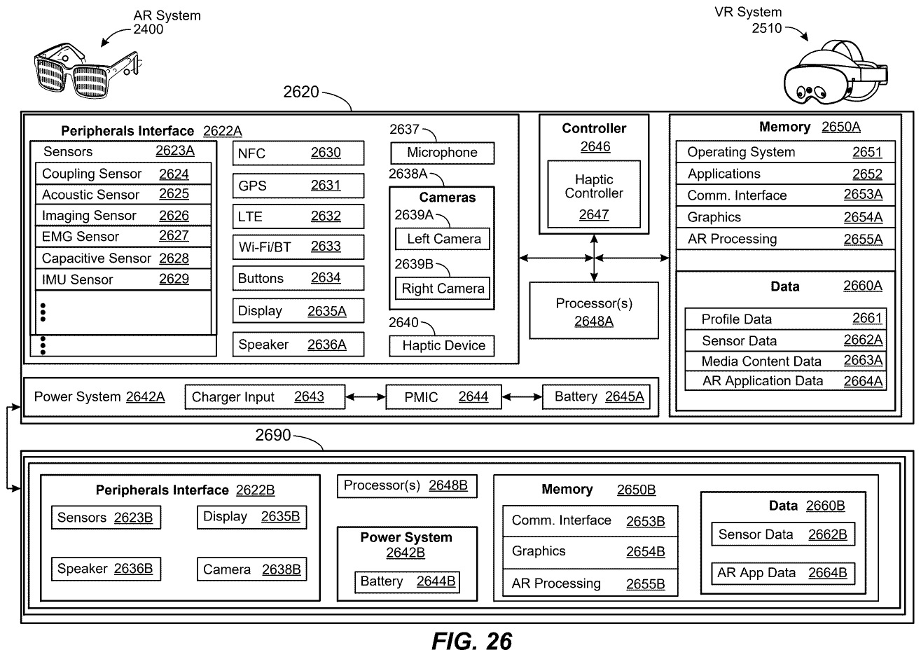

FIGS. 24 to 26 show example artificial-reality systems, which can be used as or in connection with wrist-wearable device 2200. In some embodiments, AR system 2400 includes an eyewear device 2402, as shown in FIG. 24. In some embodiments, VR system 2510 includes a head-mounted display (HMD) 2512, as shown in FIGS. 25A and 25B. In some embodiments, AR system 2400 and VR system 2510 can include one or more analogous components (e.g., components for presenting interactive artificial-reality environments, such as processors, memory, and/or presentation devices, including one or more displays and/or one or more waveguides), some of which are described in more detail with respect to FIG. 26. As described herein, a head-wearable device can include components of eyewear device 2402 and/or head-mounted display 2512. Some embodiments of head-wearable devices do not include any displays, including any of the displays described with respect to AR system 2400 and/or VR system 2510. While the example artificial-reality systems are respectively described herein as AR system 2400 and VR system 2510, either or both of the example AR systems described herein can be configured to present fully-immersive virtual-reality scenes presented in substantially all of a user's field of view or subtler augmented-reality scenes that are presented within a portion, less than all, of the user's field of view.

FIG. 24 show an example visual depiction of AR system 2400, including an eyewear device 2402 (which may also be described herein as augmented-reality glasses, and/or smart glasses). AR system 2400 can include additional electronic components that are not shown in FIG. 24, such as a wearable accessory device and/or an intermediary processing device, in electronic communication or otherwise configured to be used in conjunction with the eyewear device 2402. In some embodiments, the wearable accessory device and/or the intermediary processing device may be configured to couple with eyewear device 2402 via a coupling mechanism in electronic communication with a coupling sensor 2624 (FIG. 26), where coupling sensor 2624 can detect when an electronic device becomes physically or electronically coupled with eyewear device 2402. In some embodiments, eyewear device 2402 can be configured to couple to a housing 2690 (FIG. 26), which may include one or more additional coupling mechanisms configured to couple with additional accessory devices. The components shown in FIG. 24 can be implemented in hardware, software, firmware, or a combination thereof, including one or more signal-processing components and/or application-specific integrated circuits (ASICs).

Eyewear device 2402 includes mechanical glasses components, including a frame 2404 configured to hold one or more lenses (e.g., one or both lenses 2406-1 and 2406-2). One of ordinary skill in the art will appreciate that eyewear device 2402 can include additional mechanical components, such as hinges configured to allow portions of frame 2404 of eyewear device 2402 to be folded and unfolded, a bridge configured to span the gap between lenses 2406-1 and 2406-2 and rest on the user's nose, nose pads configured to rest on the bridge of the nose and provide support for eyewear device 2402, earpieces configured to rest on the user's ears and provide additional support for eyewear device 2402, temple arms configured to extend from the hinges to the earpieces of eyewear device 2402, and the like. One of ordinary skill in the art will further appreciate that some examples of AR system 2400 can include none of the mechanical components described herein. For example, smart contact lenses configured to present artificial reality to users may not include any components of eyewear device 2402.

Eyewear device 2402 includes electronic components, many of which will be described in more detail below with respect to FIG. 10. Some example electronic components are illustrated in FIG. 24, including acoustic sensors 2425-1, 2425-2, 2425-3, 2425-4, 2425-5, and 2425-6, which can be distributed along a substantial portion of the frame 2404 of eyewear device 2402. Eyewear device 2402 also includes a left camera 2439A and a right camera 2439B, which are located on different sides of the frame 2404. Eyewear device 2402 also includes a processor 2448 (or any other suitable type or form of integrated circuit) that is embedded into a portion of the frame 2404.

FIGS. 25A and 25B show a VR system 2510 that includes a head-mounted display (HMD) 2512 (e.g., also referred to herein as an artificial-reality headset, a head-wearable device, a VR headset, etc.), in accordance with some embodiments. As noted, some artificial-reality systems (e.g., AR system 2400) may, instead of blending an artificial reality with actual reality, substantially replace one or more of a user's visual and/or other sensory perceptions of the real world with a virtual experience (e.g., AR systems 2000 and 2100).

HMD 2512 includes a front body 2514 and a frame 2516 (e.g., a strap or band) shaped to fit around a user's head. In some embodiments, front body 2514 and/or frame 2516 include one or more electronic elements for facilitating presentation of and/or interactions with an AR and/or VR system (e.g., displays, IMUs, tracking emitter or detectors). In some embodiments, HMD 2512 includes output audio transducers (e.g., an audio transducer 2518), as shown in FIG. 25B. In some embodiments, one or more components, such as the output audio transducer(s) 2518 and frame 2516, can be configured to attach and detach (e.g., are detachably attachable) to HMD 2512 (e.g., a portion or all of frame 2516, and/or audio transducer 2518), as shown in FIG. 25B. In some embodiments, coupling a detachable component to HMD 2512 causes the detachable component to come into electronic communication with HMD 2512.

FIGS. 25A and 25B also show that VR system 2510 includes one or more cameras, such as left camera 2539A and right camera 2539B, which can be analogous to left and right cameras 2439A and 2439B on frame 2404 of eyewear device 2402. In some embodiments, VR system 2510 includes one or more additional cameras (e.g., cameras 2539C and 2539D), which can be configured to augment image data obtained by left and right cameras 2539A and 2539B by providing more information. For example, camera 2539C can be used to supply color information that is not discerned by cameras 2539A and 2539B. In some embodiments, one or more of cameras 2539A to 2539D can include an optional IR cut filter configured to remove IR light from being received at the respective camera sensors.

FIG. 26 illustrates a computing system 2620 and an optional housing 2690, each of which show components that can be included in AR system 2400 and/or VR system 2510. In some embodiments, more or fewer components can be included in optional housing 2690 depending on practical restraints of the respective AR system being described.

In some embodiments, computing system 2620 can include one or more peripherals interfaces 2622A and/or optional housing 2690 can include one or more peripherals interfaces 2622B. Each of computing system 2620 and optional housing 2690 can also include one or more power systems 2642A and 2642B, one or more controllers 2646 (including one or more haptic controllers 2647), one or more processors 2648A and 2648B (as defined above, including any of the examples provided), and memory 2650A and 2650B, which can all be in electronic communication with each other. For example, the one or more processors 2648A and 2648B can be configured to execute instructions stored in memory 2650A and 2650B, which can cause a controller of one or more of controllers 2646 to cause operations to be performed at one or more peripheral devices connected to peripherals interface 2622A and/or 2622B. In some embodiments, each operation described can be powered by electrical power provided by power system 2642A and/or 2642B.

In some embodiments, peripherals interface 2622A can include one or more devices configured to be part of computing system 2620, some of which have been defined above and/or described with respect to the wrist-wearable devices shown in FIGS. 22 and 23. For example, peripherals interface 2622A can include one or more sensors 2623A. Some example sensors 2623A include one or more coupling sensors 2624, one or more acoustic sensors 2625, one or more imaging sensors 2626, one or more EMG sensors 2627, one or more capacitive sensors 2628, one or more IMU sensors 2629, and/or any other types of sensors explained above or described with respect to any other embodiments discussed herein.

In some embodiments, peripherals interfaces 2622A and 2622B can include one or more additional peripheral devices, including one or more NFC devices 2630, one or more GPS devices 2631, one or more LTE devices 2632, one or more Wi-Fi and/or Bluetooth devices 2633, one or more buttons 2634 (e.g., including buttons that are slidable or otherwise adjustable), one or more displays 2635A and 2635B, one or more speakers 2636A and 2636B, one or more microphones 2637, one or more cameras 2638A and 2638B (e.g., including the left camera 2639A and/or a right camera 2639B), one or more haptic devices 2640, and/or any other types of peripheral devices defined above or described with respect to any other embodiments discussed herein.

AR systems can include a variety of types of visual feedback mechanisms (e.g., presentation devices). For example, display devices in AR system 2400 and/or VR system 2510 can include one or more liquid-crystal displays (LCDs), light emitting diode (LED) displays, organic LED (OLED) displays, and/or any other suitable types of display screens. Artificial-reality systems can include a single display screen (e.g., configured to be seen by both eyes), and/or can provide separate display screens for each eye, which can allow for additional flexibility for varifocal adjustments and/or for correcting a refractive error associated with a user's vision. Some embodiments of AR systems also include optical subsystems having one or more lenses (e.g., conventional concave or convex lenses, Fresnel lenses, or adjustable liquid lenses) through which a user can view a display screen.

For example, respective displays 2635A and 2635B can be coupled to each of the lenses 2406-1 and 2406-2 of AR system 2400. Displays 2635A and 2635B may be coupled to each of lenses 2406-1 and 2406-2, which can act together or independently to present an image or series of images to a user. In some embodiments, AR system 2400 includes a single display 2635A or 2635B (e.g., a near-eye display) or more than two displays 2635A and 2635B. In some embodiments, a first set of one or more displays 2635A and 2635B can be used to present an augmented-reality environment, and a second set of one or more display devices 2635A and 2635B can be used to present a virtual-reality environment. In some embodiments, one or more waveguides are used in conjunction with presenting artificial-reality content to the user of AR system 2400 (e.g., as a means of delivering light from one or more displays 2635A and 2635B to the user's eyes). In some embodiments, one or more waveguides are fully or partially integrated into the eyewear device 2402. Additionally, or alternatively to display screens, some artificial-reality systems include one or more projection systems. For example, display devices in AR system 2400 and/or VR system 2510 can include micro-LED projectors that project light (e.g., using a waveguide) into display devices, such as clear combiner lenses that allow ambient light to pass through. The display devices can refract the projected light toward a user's pupil and can enable a user to simultaneously view both artificial-reality content and the real world. Artificial-reality systems can also be configured with any other suitable type or form of image projection system. In some embodiments, one or more waveguides are provided additionally or alternatively to the one or more display(s) 2635A and 2635B.

Computing system 2620 and/or optional housing 2690 of AR system 2400 or VR system 2510 can include some or all of the components of a power system 2642A and 2642B. Power systems 2642A and 2642B can include one or more charger inputs 2643, one or more PMICs 2644, and/or one or more batteries 2645A and 2644B.

Memory 2650A and 2650B may include instructions and data, some or all of which may be stored as non-transitory computer-readable storage media within the memories 2650A and 2650B. For example, memory 2650A and 2650B can include one or more operating systems 2651, one or more applications 2652, one or more communication interface applications 2653A and 2653B, one or more graphics applications 2654A and 2654B, one or more AR processing applications 2655A and 2655B, and/or any other types of data defined above or described with respect to any other embodiments discussed herein.

Memory 2650A and 2650B also include data 2660A and 2660B, which can be used in conjunction with one or more of the applications discussed above. Data 2660A and 2660B can include profile data 2661, sensor data 2662A and 2662B, media content data 2663A, AR application data 2664A and 2664B, and/or any other types of data defined above or described with respect to any other embodiments discussed herein.

In some embodiments, controller 2646 of eyewear device 2402 may process information generated by sensors 2623A and/or 2623B on eyewear device 2402 and/or another electronic device within AR system 2400. For example, controller 2646 can process information from acoustic sensors 2425-1 and 2425-2. For each detected sound, controller 2646 can perform a direction of arrival (DOA) estimation to estimate a direction from which the detected sound arrived at eyewear device 2402 of R system 2400. As one or more of acoustic sensors 2625 (e.g., the acoustic sensors 2425-1, 2425-2) detects sounds, controller 2646 can populate an audio data set with the information (e.g., represented in FIG. 10 as sensor data 2662A and 2662B).

In some embodiments, a physical electronic connector can convey information between eyewear device 2402 and another electronic device and/or between one or more processors 2448, 2648A, 2648B of AR system 2400 or VR system 2510 and controller 2646. The information can be in the form of optical data, electrical data, wireless data, or any other transmittable data form. Moving the processing of information generated by eyewear device 2402 to an intermediary processing device can reduce weight and heat in the eyewear device, making it more comfortable and safer for a user. In some embodiments, an optional wearable accessory device (e.g., an electronic neckband) is coupled to eyewear device 2402 via one or more connectors. The connectors can be wired or wireless connectors and can include electrical and/or non-electrical (e.g., structural) components. In some embodiments, eyewear device 2402 and the wearable accessory device can operate independently without any wired or wireless connection between them.

In some situations, pairing external devices, such as an intermediary processing device (e.g., HIPD 1806, 1906, 2006) with eyewear device 2402 (e.g., as part of AR system 2400) enables eyewear device 2402 to achieve a similar form factor of a pair of glasses while still providing sufficient battery and computation power for expanded capabilities. Some, or all, of the battery power, computational resources, and/or additional features of AR system 2400 can be provided by a paired device or shared between a paired device and eyewear device 2402, thus reducing the weight, heat profile, and form factor of eyewear device 2402 overall while allowing eyewear device 2402 to retain its desired functionality. For example, the wearable accessory device can allow components that would otherwise be included on eyewear device 2402 to be included in the wearable accessory device and/or intermediary processing device, thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computation capacity than might otherwise have been possible on eyewear device 2402 standing alone. Because weight carried in the wearable accessory device can be less invasive to a user than weight carried in the eyewear device 2402, a user may tolerate wearing a lighter eyewear device and carrying or wearing the paired device for greater lengths of time than the user would tolerate wearing a heavier eyewear device standing alone, thereby enabling an artificial-reality environment to be incorporated more fully into a user's day-to-day activities.

AR systems can include various types of computer vision components and subsystems. For example, AR system 2400 and/or VR system 2510 can include one or more optical sensors such as two-dimensional (2D) or three-dimensional (3D) cameras, time-of-flight depth sensors, structured light transmitters and detectors, single-beam or sweeping laser rangefinders, 3D LiDAR sensors, and/or any other suitable type or form of optical sensor. An AR system can process data from one or more of these sensors to identify a location of a user and/or aspects of the use's real-world physical surroundings, including the locations of real-world objects within the real-world physical surroundings. In some embodiments, the methods described herein are used to map the real world, to provide a user with context about real-world surroundings, and/or to generate digital twins (e.g., interactable virtual objects), among a variety of other functions. For example, FIGS. 25A and 25B show VR system 2510 having cameras 2539A to 2539D, which can be used to provide depth information for creating a voxel field and a two-dimensional mesh to provide object information to the user to avoid collisions.

In some embodiments, AR system 2400 and/or VR system 2510 can include haptic (tactile) feedback systems, which may be incorporated into headwear, gloves, body suits, handheld controllers, environmental devices (e.g., chairs or floormats), and/or any other type of device or system, such as the wearable devices discussed herein. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback may be implemented using motors, piezoelectric actuators, fluidic systems, and/or a variety of other types of feedback mechanisms. The haptic feedback systems may be implemented independently of other artificial-reality devices, within other artificial-reality devices, and/or in conjunction with other artificial-reality devices.

In some embodiments of an artificial reality system, such as AR system 2400 and/or VR system 2510, ambient light (e.g., a live feed of the surrounding environment that a user would normally see) can be passed through a display element of a respective head-wearable device presenting aspects of the AR system. In some embodiments, ambient light can be passed through a portion less that is less than all of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable device, and an amount of ambient light (e.g., 15-50% of the ambient light) can be passed through the user interface element such that the user can distinguish at least a portion of the physical environment over which the user interface element is being displayed.

FIGS. 27A and 27B illustrate an example handheld intermediary processing device (HIPD) 2700 in accordance with some embodiments. HIPD 2700 is an instance of the intermediary device described herein, such that HIPD 2700 should be understood to have the features described with respect to any intermediary device defined above or otherwise described herein and vice versa. FIG. 27A shows a top view and FIG. 27B shows a side view of the HIPD 2700. HIPD 2700 is configured to communicatively couple with one or more wearable devices (or other electronic devices) associated with a user. For example, HIPD 2700 is configured to communicatively couple with a user's wrist-wearable device 1802, 1902 (or components thereof, such as watch body 2220 and wearable band 2210), AR glasses 2400, and/or VR headset 2050 and 2500. HIPD 2700 can be configured to be held by a user (e.g., as a handheld controller), carried on the user's person (e.g., in their pocket, in their bag, etc.), placed in proximity of the user (e.g., placed on their desk while seated at their desk, on a charging dock, etc.), and/or placed at or within a predetermined distance from a wearable device or other electronic device (e.g., where, in some embodiments, the predetermined distance is the maximum distance (e.g., 10 meters) at which HIPD 2700 can successfully be communicatively coupled with an electronic device, such as a wearable device).

HIPD 2700 can perform various functions independently and/or in conjunction with one or more wearable devices (e.g., wrist-wearable device 1802, AR glasses 2400, VR system 2510, etc.). HIPD 2700 can be configured to increase and/or improve the functionality of communicatively coupled devices, such as the wearable devices. HIPD 2700 can be configured to perform one or more functions or operations associated with interacting with user interfaces and applications of communicatively coupled devices, interacting with an AR environment, interacting with VR environment, and/or operating as a human-machine interface controller, as well as functions and/or operations described above with reference to FIGS. 18-20B. Additionally, as will be described in more detail below, functionality and/or operations of HIPD 2700 can include, without limitation, task offloading and/or handoffs; thermals offloading and/or handoffs; six degrees of freedom (6DoF) raycasting and/or gaming (e.g., using imaging devices or cameras 2714A, 2714B, which can be used for simultaneous localization and mapping (SLAM) and/or with other image processing techniques), portable charging, messaging, image capturing via one or more imaging devices or cameras 2722A and 2722B, sensing user input (e.g., sensing a touch on a touch input surface 2702), wireless communications and/or interlining (e.g., cellular, near field, Wi-Fi, personal area network, etc.), location determination, financial transactions, providing haptic feedback, alarms, notifications, biometric authentication, health monitoring, sleep monitoring, etc. The above-described example functions can be executed independently in HIPD 2700 and/or in communication between HIPD 2700 and another wearable device described herein. In some embodiments, functions can be executed on HIPD 2700 in conjunction with an AR environment. As the skilled artisan will appreciate upon reading the descriptions provided herein that HIPD 2700 can be used with any type of suitable AR environment.

While HIPD 2700 is communicatively coupled with a wearable device and/or other electronic device, HIPD 2700 is configured to perform one or more operations initiated at the wearable device and/or the other electronic device. In particular, one or more operations of the wearable device and/or the other electronic device can be offloaded to HIPD 2700 to be performed. HIPD 2700 performs the one or more operations of the wearable device and/or the other electronic device and provides to data corresponded to the completed operations to the wearable device and/or the other electronic device. For example, a user can initiate a video stream using AR glasses 2400 and back-end tasks associated with performing the video stream (e.g., video rendering) can be offloaded to HIPD 2700, which HIPD 2700 performs and provides corresponding data to AR glasses 2400 to perform remaining front-end tasks associated with the video stream (e.g., presenting the rendered video data via a display of AR glasses 2400). In this way, HIPD 2700, which has more computational resources and greater thermal headroom than a wearable device, can perform computationally intensive tasks for the wearable device, thereby improving performance of an operation performed by the wearable device.

HIPD 2700 includes a multi-touch input surface 2702 on a first side (e.g., a front surface) that is configured to detect one or more user inputs. In particular, multi-touch input surface 2702 can detect single tap inputs, multi-tap inputs, swipe gestures and/or inputs, force-based and/or pressure-based touch inputs, held taps, and the like. Multi-touch input surface 2702 is configured to detect capacitive touch inputs and/or force (and/or pressure) touch inputs. Multi-touch input surface 2702 includes a first touch-input surface 2704 defined by a surface depression and a second touch-input surface 2706 defined by a substantially planar portion. First touch-input surface 2704 can be disposed adjacent to second touch-input surface 2706. In some embodiments, first touch-input surface 2704 and second touch-input surface 2706 can be different dimensions and/or shapes. For example, first touch-input surface 2704 can be substantially circular and second touch-input surface 2706 can be substantially rectangular. In some embodiments, the surface depression of multi-touch input surface 2702 is configured to guide user handling of HIPD 2700. In particular, the surface depression can be configured such that the user holds HIPD 2700 upright when held in a single hand (e.g., such that the using imaging devices or cameras 2714A and 2714B are pointed toward a ceiling or the sky). Additionally, the surface depression is configured such that the user's thumb rests within first touch-input surface 2704.

In some embodiments, the different touch-input surfaces include a plurality of touch-input zones. For example, second touch-input surface 2706 includes at least a second touch-input zone 2708 within a first touch-input zone 2707 and a third touch-input zone 2710 within second touch-input zone 2708. In some embodiments, one or more of touch-input zones 2708 and 2710 are optional and/or user defined (e.g., a user can specific a touch-input zone based on their preferences). In some embodiments, each touch-input surface 2704 and 2706 and/or touch-input zone 2708 and 2710 are associated with a predetermined set of commands. For example, a user input detected within first touch-input zone 2708 may cause HIPD 2700 to perform a first command and a user input detected within second touch-input surface 2706 may cause HIPD 2700 to perform a second command, distinct from the first. In some embodiments, different touch-input surfaces and/or touch-input zones are configured to detect one or more types of user inputs. The different touch-input surfaces and/or touch-input zones can be configured to detect the same or distinct types of user inputs. For example, first touch-input zone 2708 can be configured to detect force touch inputs (e.g., a magnitude at which the user presses down) and capacitive touch inputs, and second touch-input zone 2710 can be configured to detect capacitive touch inputs.

As shown in FIG. 28, HIPD 2700 includes one or more sensors 2851 for sensing data used in the performance of one or more operations and/or functions. For example, HIPD 2700 can include an IMU sensor that is used in conjunction with cameras 2714A, 2714B (FIGS. 27A-27B) for 3-dimensional object manipulation (e.g., enlarging, moving, destroying, etc., an object) in an AR or VR environment. Non-limiting examples of sensors 2851 included in HIPD 2700 include a light sensor, a magnetometer, a depth sensor, a pressure sensor, and a force sensor.

HIPD 2700 can include one or more light indicators 2712 to provide one or more notifications to the user. In some embodiments, light indicators 2712 are LEDs or other types of illumination devices. Light indicators 2712 can operate as a privacy light to notify the user and/or others near the user that an imaging device and/or microphone are active. In some embodiments, a light indicator is positioned adjacent to one or more touch-input surfaces. For example, a light indicator can be positioned around first touch-input surface 2704. Light indicators 2712 can be illuminated in different colors and/or patterns to provide the user with one or more notifications and/or information about the device. For example, a light indicator positioned around first touch-input surface 2704 may flash when the user receives a notification (e.g., a message), change red when HIPD 2700 is out of power, operate as a progress bar (e.g., a light ring that is closed when a task is completed (e.g., 0% to 100%)), operate as a volume indicator, etc.

In some embodiments, HIPD 2700 includes one or more additional sensors on another surface. For example, as shown FIG. 27A, HIPD 2700 includes a set of one or more sensors (e.g., sensor set 2720) on an edge of HIPD 2700. Sensor set 2720, when positioned on an edge of the of HIPD 2700, can be pe positioned at a predetermined tilt angle (e.g., 26 degrees), which allows sensor set 2720 to be angled toward the user when placed on a desk or other flat surface. Alternatively, in some embodiments, sensor set 2720 is positioned on a surface opposite the multi-touch input surface 2702 (e.g., a back surface). The one or more sensors of sensor set 2720 are discussed in further detail below.

The side view of the of HIPD 2700 in FIG. 27B shows sensor set 2720 and camera 2714B. Sensor set 2720 can include one or more cameras 2722A and 2722B, a depth projector 2724, an ambient light sensor 2728, and a depth receiver 2730. In some embodiments, sensor set 2720 includes a light indicator 2726. Light indicator 2726 can operate as a privacy indicator to let the user and/or those around them know that a camera and/or microphone is active. Sensor set 2720 is configured to capture a user's facial expression such that the user can puppet a custom avatar (e.g., showing emotions, such as smiles, laughter, etc., on the avatar or a digital representation of the user). Sensor set 2720 can be configured as a side stereo RGB system, a rear indirect Time-of-Flight (iToF) system, or a rear stereo RGB system. As the skilled artisan will appreciate upon reading the descriptions provided herein, HIPD 2700 described herein can use different sensor set 2720 configurations and/or sensor set 2720 placement.

Turning to FIG. 28, in some embodiments, a computing system 2840 of HIPD 2700 can include one or more haptic devices 2871 (e.g., a vibratory haptic actuator) that are configured to provide haptic feedback (e.g., kinesthetic sensation). Sensors 2851 and/or the haptic devices 2871 can be configured to operate in conjunction with multiple applications and/or communicatively coupled devices including, without limitation, a wearable devices, health monitoring applications, social media applications, game applications, and artificial reality applications (e.g., the applications associated with artificial reality).

In some embodiments, HIPD 2700 is configured to operate without a display. However, optionally, computing system 2840 of the HIPD 2700 can include a display 2868. HIPD 2700 can also include one or more optional peripheral buttons 2867. For example, peripheral buttons 2867 can be used to turn on or turn off HIPD 2700. Further, HIPD 2700 housing can be formed of polymers and/or elastomers. In other words, HIPD 2700 may be designed such that it would not easily slide off a surface. In some embodiments, HIPD 2700 includes one or magnets to couple HIPD 2700 to another surface. This allows the user to mount HIPD 2700 to different surfaces and provide the user with greater flexibility in use of HIPD 2700.

As described above, HIPD 2700 can distribute and/or provide instructions for performing the one or more tasks at HIPD 2700 and/or a communicatively coupled device. For example, HIPD 2700 can identify one or more back-end tasks to be performed by HIPD 2700 and one or more front-end tasks to be performed by a communicatively coupled device. While HIPD 2700 is configured to offload and/or handoff tasks of a communicatively coupled device, HIPD 2700 can perform both back-end and front-end tasks (e.g., via one or more processors, such as CPU 2877). HIPD 2700 can, without limitation, can be used to perform augmented calling (e.g., receiving and/or sending 3D or 2.5D live volumetric calls, live digital human representation calls, and/or avatar calls), discreet messaging, 6DoF portrait/landscape gaming, AR/VR object manipulation, AR/VR content display (e.g., presenting content via a virtual display), and/or other AR/VR interactions. HIPD 2700 can perform the above operations alone or in conjunction with a wearable device (or other communicatively coupled electronic device).

FIG. 28 shows a block diagram of a computing system 2840 of HIPD 2700 in accordance with some embodiments. HIPD 2700, described in detail above, can include one or more components shown in HIPD computing system 2840. HIPD 2700 will be understood to include the components shown and described below for HIPD computing system 2840. In some embodiments, all, or a substantial portion of the components of HIPD computing system 2840 are included in a single integrated circuit. Alternatively, in some embodiments, components of HIPD computing system 2840 are included in a plurality of integrated circuits that are communicatively coupled.

HIPD computing system 2840 can include a processor (e.g., a CPU 2877, a GPU, and/or a CPU with integrated graphics), a controller 2875, a peripherals interface 2850 that includes one or more sensors 2851 and other peripheral devices, a power source (e.g., a power system 2895), and memory (e.g., a memory 2878) that includes an operating system (e.g., an operating system 2879), data (e.g., data 2888), one or more applications (e.g., applications 2880), and one or more modules (e.g., a communications interface module 2881, a graphics module 2882, a task and processing management module 2883, an interoperability module 2884, an AR processing module 2885, a data management module 2886, etc.). HIPD computing system 2840 further includes a power system 2895 that includes a charger input and output 2896, a PMIC 2897, and a battery 2898, all of which are defined above.

In some embodiments, peripherals interface 2850 can include one or more sensors 2851. Sensors 2851 can include analogous sensors to those described above in reference to FIG. 22. For example, sensors 2851 can include imaging sensors 2854, (optional) EMG sensors 2856, IMU sensors 2858, and capacitive sensors 2860. In some embodiments, sensors 2851 can include one or more pressure sensors 2852 for sensing pressure data, an altimeter 2853 for sensing an altitude of the HIPD 2700, a magnetometer 2855 for sensing a magnetic field, a depth sensor 2857 (or a time-of flight sensor) for determining a difference between the camera and the subject of an image, a position sensor 2859 (e.g., a flexible position sensor) for sensing a relative displacement or position change of a portion of the HIPD 2700, a force sensor 2861 for sensing a force applied to a portion of the HIPD 2700, and a light sensor 2862 (e.g., an ambient light sensor) for detecting an amount of lighting. Sensors 2851 can include one or more sensors not shown in FIG. 28.

Analogous to the peripherals described above in reference to FIG. 22, peripherals interface 2850 can also include an NFC component 2863, a GPS component 2864, an LTE component 2865, a Wi-Fi and/or Bluetooth communication component 2866, a speaker 2869, a haptic device 2871, and a microphone 2873. As noted above, HIPD 2700 can optionally include a display 2868 and/or one or more peripheral buttons 2867. Peripherals interface 2850 can further include one or more cameras 2870, touch surfaces 2872, and/or one or more light emitters 2874. Multi-touch input surface 2702 described above in reference to FIGS. 27A and 27B is an example of touch surface 2872. Light emitters 2874 can be one or more LEDs, lasers, etc. and can be used to project or present information to a user. For example, light emitters 2874 can include light indicators 2712 and 2726 described above in reference to FIGS. 27A and 27B. Cameras 2870 (e.g., cameras 2714A, 2714B, 2722A, and 2722B described above in reference to FIGS. 27A and 27B) can include one or more wide angle cameras, fish-eye cameras, spherical cameras, compound eye cameras (e.g., stereo and multi cameras), depth cameras, RGB cameras, ToF cameras, RGB-D cameras (depth and ToF cameras), and/or other suitable cameras. Cameras 2870 can be used for SLAM, 6DoF ray casting, gaming, object manipulation and/or other rendering, facial recognition and facial expression recognition, etc.

Similar to watch body computing system 2360 and watch band computing system 2330 described above in reference to FIG. 23, HIPD computing system 2840 can include one or more haptic controllers 2876 and associated componentry (e.g., haptic devices 2871) for providing haptic events at HIPD 2700.

Memory 2878 can include high-speed random-access memory and/or non-volatile memory, such as one or more magnetic disk storage devices, flash memory devices, or other non-volatile solid-state memory devices. Access to memory 2878 by other components of HIPD 2700, such as the one or more processors and peripherals interface 2850, can be controlled by a memory controller of controllers 2875.

In some embodiments, software components stored in memory 2878 include one or more operating systems 2879, one or more applications 2880, one or more communication interface modules 2881, one or more graphics modules 2882, and/or one or more data management modules 2886, which are analogous to the software components described above in reference to FIG. 22.

In some embodiments, software components stored in memory 2878 include a task and processing management module 2883 for identifying one or more front-end and back-end tasks associated with an operation performed by the user, performing one or more front-end and/or back-end tasks, and/or providing instructions to one or more communicatively coupled devices that cause performance of the one or more front-end and/or back-end tasks. In some embodiments, task and processing management module 2883 uses data 2888 (e.g., device data 2890) to distribute the one or more front-end and/or back-end tasks based on communicatively coupled devices' computing resources, available power, thermal headroom, ongoing operations, and/or other factors. For example, task and processing management module 2883 can cause the performance of one or more back-end tasks (of an operation performed at communicatively coupled AR system 2400) at HIPD 2700 in accordance with a determination that the operation is utilizing a predetermined amount (e.g., at least 70%) of computing resources available at AR system 2400.

In some embodiments, software components stored in memory 2878 include an interoperability module 2884 for exchanging and utilizing information received and/or provided to distinct communicatively coupled devices. Interoperability module 2884 allows for different systems, devices, and/or applications to connect and communicate in a coordinated way without user input. In some embodiments, software components stored in memory 2878 include an AR processing module 2885 that is configured to process signals based at least on sensor data for use in an AR and/or VR environment. For example, AR processing module 2885 can be used for 3D object manipulation, gesture recognition, facial and facial expression recognition, etc.

Memory 2878 can also include data 2888. In some embodiments, data 2888 can include profile data 2889, device data 2890 (including device data of one or more devices communicatively coupled with HIPD 2700, such as device type, hardware, software, configurations, etc.), sensor data 2891, media content data 2892, and application data 2893.

It should be appreciated that HIPD computing system 2840 is an example of a computing system within HIPD 2700, and that HIPD 2700 can have more or fewer components than shown in HIPD computing system 2840, combine two or more components, and/or have a different configuration and/or arrangement of the components. The various components shown HIPD computing system 2840 are implemented in hardware, software, firmware, or a combination thereof, including one or more signal processing and/or application-specific integrated circuits.

The techniques described above in FIGS. 27A, 27B, and 28 can be used with any device used as a human-machine interface controller. In some embodiments, an HIPD 2700 can be used in conjunction with one or more wearable device such as a head-wearable device (e.g., AR system 2400 and VR system 2510) and/or a wrist-wearable device 2200 (or components thereof).

In some embodiments, the artificial reality devices and/or accessory devices disclosed herein may include haptic interfaces with transducers that provide haptic feedback and/or that collect haptic information about a user's interaction with an environment. The artificial-reality systems disclosed herein may include various types of haptic interfaces that detect or convey various types of haptic information, including tactile feedback (e.g., feedback that a user detects via nerves in the skin, which may also be referred to as cutaneous feedback) and/or kinesthetic feedback (e.g., feedback that a user detects via receptors located in muscles, joints, and/or tendons). In some examples, cutaneous feedback may include vibration, force, traction, texture, and/or temperature. Similarly, kinesthetic feedback, may include motion and compliance. Cutaneous and/or kinesthetic feedback may be provided using motors, piezoelectric actuators, fluidic systems, and/or a variety of other types of feedback mechanisms. Furthermore, haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The haptics assemblies disclosed herein may enable or enhance a user's artificial-reality experience in one or more of these contexts and environments and/or in other contexts and environments.

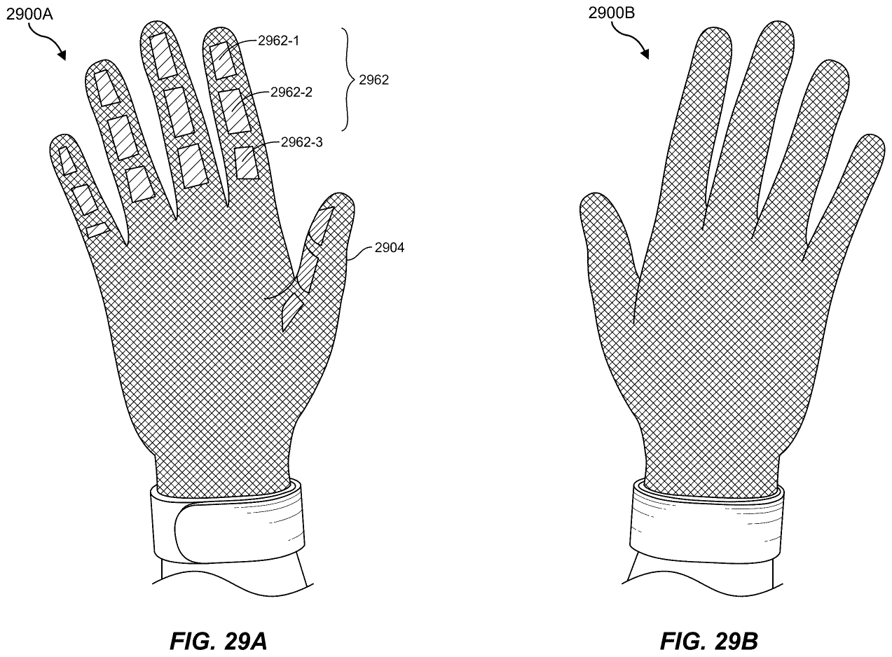

FIGS. 29A and 29B show example haptic feedback systems (e.g., hand-wearable devices) for providing feedback to a user regarding the user's interactions with a computing system (e.g., an artificial-reality environment presented by the AR system 2400 or the VR system 2510). In some embodiments, a computing system (e.g., the AR systems 2000 and/or 2100) may also provide feedback to one or more users based on an action that was performed within the computing system and/or an interaction provided by the AR system (e.g., which may be based on instructions that are executed in conjunction with performing operations of an application of the computing system). Such feedback may include visual and/or audio feedback and may also include haptic feedback provided by a haptic assembly, such as one or more haptic assemblies 2962 of haptic device 2900 (e.g., haptic assemblies 2962-1, 2962-2, 2962-3, etc.). For example, the haptic feedback may prevent (or, at a minimum, hinder/resist movement of) one or more fingers of a user from bending past a certain point to simulate the sensation of touching a solid coffee mug. In actuating such haptic effects, haptic device 2900 can change (either directly or indirectly) a pressurized state of one or more of haptic assemblies 2962.

Vibrotactile system 2900 may optionally include other subsystems and components, such as touch-sensitive pads, pressure sensors, motion sensors, position sensors, lighting elements, and/or user interface elements (e.g., an on/off button, a vibration control element, etc.). During use, haptic assemblies 2962 may be configured to be activated for a variety of different reasons, such as in response to the user's interaction with user interface elements, a signal from the motion or position sensors, a signal from the touch-sensitive pads, a signal from the pressure sensors, a signal from the other device or system, etc.

In FIGS. 29A and 29B, each of haptic assemblies 2962 may include a mechanism that, at a minimum, provides resistance when the respective haptic assembly 2962 is transitioned from a first pressurized state (e.g., atmospheric pressure or deflated) to a second pressurized state (e.g., inflated to a threshold pressure). Structures of haptic assemblies 2962 can be integrated into various devices configured to be in contact or proximity to a user's skin, including, but not limited to devices such as glove worn devices, body worn clothing device, headset devices.

As noted above, haptic assemblies 2962 described herein can be configured to transition between a first pressurized state and a second pressurized state to provide haptic feedback to the user. Due to the ever-changing nature of artificial-reality, haptic assemblies 2962 may be required to transition between the two states hundreds, or perhaps thousands of times, during a single use. Thus, haptic assemblies 2962 described herein are durable and designed to quickly transition from state to state. To provide some context, in the first pressurized state, haptic assemblies 2962 do not impede free movement of a portion of the wearer's body. For example, one or more haptic assemblies 2962 incorporated into a glove are made from flexible materials that do not impede free movement of the wearer's hand and fingers (e.g., an electrostatic-zipping actuator). Haptic assemblies 2962 may be configured to conform to a shape of the portion of the wearer's body when in the first pressurized state. However, once in the second pressurized state, haptic assemblies 2962 can be configured to restrict and/or impede free movement of the portion of the wearer's body (e.g., appendages of the user's hand). For example, the respective haptic assembly 2962 (or multiple respective haptic assemblies) can restrict movement of a wearer's finger (e.g., prevent the finger from curling or extending) when haptic assembly 2962 is in the second pressurized state. Moreover, once in the second pressurized state, haptic assemblies 2962 may take different shapes, with some haptic assemblies 2962 configured to take a planar, rigid shape (e.g., flat and rigid), while some other haptic assemblies 2962 are configured to curve or bend, at least partially.

As a non-limiting example, haptic device 2900 includes a plurality of haptic devices (e.g., a pair of haptic gloves, a haptics component of a wrist-wearable device (e.g., any of the wrist-wearable devices described with respect to FIGS. 18-22), etc.), each of which can include a garment component (e.g., a garment 2904) and one or more haptic assemblies coupled (e.g., physically coupled) to the garment component. For example, each of the haptic assemblies 2962-1, 2962-2, 2962-3, . . . 2962-N are physically coupled to the garment 2904 and are configured to contact respective phalanges of a user's thumb and fingers. As explained above, haptic assemblies 2962 are configured to provide haptic simulations to a wearer of device 2900. Garment 2904 of each device 2900 can be one of various articles of clothing (e.g., gloves, socks, shirts, pants, etc.). Thus, a user may wear multiple haptic devices 2900 that are each configured to provide haptic stimulations to respective parts of the body where haptic devices 2900 are being worn.

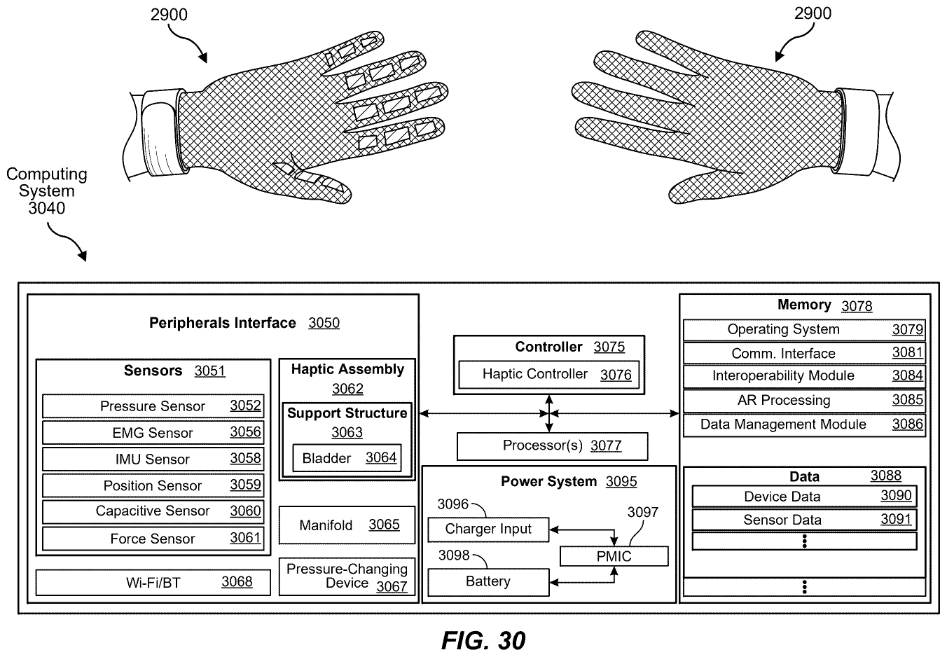

FIG. 30 shows block diagrams of a computing system 3040 of haptic device 2900, in accordance with some embodiments. Computing system 3040 can include one or more peripherals interfaces 3050, one or more power systems 3095, one or more controllers 3075 (including one or more haptic controllers 3076), one or more processors 3077 (as defined above, including any of the examples provided), and memory 3078, which can all be in electronic communication with each other. For example, one or more processors 3077 can be configured to execute instructions stored in the memory 3078, which can cause a controller of the one or more controllers 3075 to cause operations to be performed at one or more peripheral devices of peripherals interface 3050. In some embodiments, each operation described can occur based on electrical power provided by the power system 3095. The power system 3095 can include a charger input 3096, a PMIC 3097, and a battery 3098.

In some embodiments, peripherals interface 3050 can include one or more devices configured to be part of computing system 3040, many of which have been defined above and/or described with respect to wrist-wearable devices shown in FIGS. 22 and 23. For example, peripherals interface 3050 can include one or more sensors 3051. Some example sensors include: one or more pressure sensors 3052, one or more EMG sensors 3056, one or more IMU sensors 3058, one or more position sensors 3059, one or more capacitive sensors 3060, one or more force sensors 3061; and/or any other types of sensors defined above or described with respect to any other embodiments discussed herein.

In some embodiments, the peripherals interface can include one or more additional peripheral devices, including one or more Wi-Fi and/or Bluetooth devices 3068; one or more haptic assemblies 3062; one or more support structures 3063 (which can include one or more bladders 3064; one or more manifolds 3065; one or more pressure-changing devices 3067; and/or any other types of peripheral devices defined above or described with respect to any other embodiments discussed herein.

In some embodiments, each haptic assembly 3062 includes a support structure 3063 and at least one bladder 3064. Bladder 3064 (e.g., a membrane) may be a sealed, inflatable pocket made from a durable and puncture-resistant material, such as thermoplastic polyurethane (TPU), a flexible polymer, or the like. Bladder 3064 contains a medium (e.g., a fluid such as air, inert gas, or even a liquid) that can be added to or removed from bladder 3064 to change a pressure (e.g., fluid pressure) inside the bladder 3064. Support structure 3063 is made from a material that is stronger and stiffer than the material of bladder 3064. A respective support structure 3063 coupled to a respective bladder 3064 is configured to reinforce the respective bladder 3064 as the respective bladder 3064 changes shape and size due to changes in pressure (e.g., fluid pressure) inside the bladder.

The system 3040 also includes a haptic controller 3076 and a pressure-changing device 3067. In some embodiments, haptic controller 3076 is part of the computer system 3040 (e.g., in electronic communication with one or more processors 3077 of the computer system 3040). Haptic controller 3076 is configured to control operation of pressure-changing device 3067, and in turn operation of haptic device 2900. For example, haptic controller 3076 sends one or more signals to pressure-changing device 3067 to activate pressure-changing device 3067 (e.g., turn it on and off). The one or more signals may specify a desired pressure (e.g., pounds-per-square inch) to be output by pressure-changing device 3067. Generation of the one or more signals, and in turn the pressure output by pressure-changing device 3067, may be based on information collected by sensors 3051. For example, the one or more signals may cause pressure-changing device 3067 to increase the pressure (e.g., fluid pressure) inside a first haptic assembly 3062 at a first time, based on the information collected by sensors 3051 (e.g., the user makes contact with an artificial coffee mug or other artificial object). Then, the controller may send one or more additional signals to pressure-changing device 3067 that cause pressure-changing device 3067 to further increase the pressure inside first haptic assembly 3062 at a second time after the first time, based on additional information collected by sensors 3051. Further, the one or more signals may cause pressure-changing device 3067 to inflate one or more bladders 3064 in a first device 2900A, while one or more bladders 3064 in a second device 2900B remain unchanged. Additionally, the one or more signals may cause pressure-changing device 3067 to inflate one or more bladders 3064 in a first device 2900A to a first pressure and inflate one or more other bladders 3064 in first device 2900A to a second pressure different from the first pressure. Depending on number of devices 2900 serviced by pressure-changing device 3067, and the number of bladders therein, many different inflation configurations can be achieved through the one or more signals and the examples above are not meant to be limiting.

The system 3040 may include an optional manifold 3065 between pressure-changing device 3067 and haptic devices 2900. Manifold 3065 may include one or more valves (not shown) that pneumatically couple each of haptic assemblies 3062 with pressure-changing device 3067 via tubing. In some embodiments, manifold 3065 is in communication with controller 3075, and controller 3075 controls the one or more valves of manifold 3065 (e.g., the controller generates one or more control signals). Manifold 3065 is configured to switchably couple pressure-changing device 3067 with one or more haptic assemblies 3062 of the same or different haptic devices 2900 based on one or more control signals from controller 3075. In some embodiments, instead of using manifold 3065 to pneumatically couple pressure-changing device 3067 with haptic assemblies 3062, system 3040 may include multiple pressure-changing devices 3067, where each pressure-changing device 3067 is pneumatically coupled directly with a single haptic assembly 3062 or multiple haptic assemblies 3062. In some embodiments, pressure-changing device 3067 and optional manifold 3065 can be configured as part of one or more of the haptic devices 2900 while, in other embodiments, pressure-changing device 3067 and optional manifold 3065 can be configured as external to haptic device 2900. A single pressure-changing device 3067 may be shared by multiple haptic devices 2900.

In some embodiments, pressure-changing device 3067 is a pneumatic device, hydraulic device, a pneudraulic device, or some other device capable of adding and removing a medium (e.g., fluid, liquid, gas) from the one or more haptic assemblies 3062.

The devices shown in FIGS. 29A-30 may be coupled via a wired connection (e.g., via busing). Alternatively, one or more of the devices shown in FIGS. 29A-30 may be wirelessly connected (e.g., via short-range communication signals).

Memory 3078 includes instructions and data, some or all of which may be stored as non-transitory computer-readable storage media within memory 3078. For example, memory 3078 can include one or more operating systems 3079; one or more communication interface applications 3081; one or more interoperability modules 3084; one or more AR processing applications 3085; one or more data management modules 3086; and/or any other types of applications or modules defined above or described with respect to any other embodiments discussed herein.

Memory 3078 also includes data 3088 which can be used in conjunction with one or more of the applications discussed above. Data 3088 can include: device data 3090; sensor data 3091; and/or any other types of data defined above or described with respect to any other embodiments discussed herein.

In some examples, the augmented reality systems described herein may also include a microphone array with a plurality of acoustic transducers. Acoustic transducers may represent transducers that detect air pressure variations induced by sound waves. Each acoustic transducer may be configured to detect sound and convert the detected sound into an electronic format (e.g., an analog or digital format). A microphone array may include, for example, ten acoustic transducers that may be designed to be placed inside a corresponding ear of the user, acoustic transducers that may be positioned at various locations on an HMD frame a watch band, etc.

In some embodiments, one or more of acoustic transducers may be used as output transducers (e.g., speakers). For example, the artificial reality systems described herein may include acoustic transducers that are earbuds or any other suitable type of headphone or speaker.

The configuration of acoustic transducers of a microphone array may vary and may include any suitable number of transducers. In some embodiments, using higher numbers of acoustic transducers may increase the amount of audio information collected and/or the sensitivity and accuracy of the audio information. In contrast, using a lower number of acoustic transducers may decrease the computing power required by an associated controller to process the collected audio information. In addition, the position of each acoustic transducer of the microphone array may vary. For example, the position of an acoustic transducer may include a defined position on the user, a defined coordinate on a frame of an HMD, an orientation associated with each acoustic transducer, or some combination thereof.

Acoustic transducers and may be positioned on different parts of the user's ear, such as behind the pinna, behind the tragus, and/or within the auricle or fossa. Or, there may be additional acoustic transducers on or surrounding the ear in addition to acoustic transducers inside the ear canal. Having an acoustic transducer positioned next to an ear canal of a user may enable the microphone array to collect information on how sounds arrive at the ear canal. By positioning at least two of acoustic transducers on either side of a user's head (e.g., as binaural microphones), an artificial-reality device may simulate binaural hearing and capture a 3D stereo sound field around about a user's head. In some embodiments, acoustic transducers may be connected to artificial reality systems via a wired connection, and in other embodiments acoustic transducers may be connected to artificial-reality systems via a wireless connection (e.g., a BLUETOOTH connection).

Acoustic transducers may be positioned on HMDs frames in a variety of different ways, including along the length of the temples, across the bridge, above or below display devices, or some combination thereof. Acoustic transducers may also be oriented such that the microphone array is able to detect sounds in a wide range of directions surrounding the user wearing the augmented-reality system. In some embodiments, an optimization process may be performed during manufacturing of augmented-reality system to determine relative positioning of each acoustic transducer in the microphone array.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

Some augmented-reality systems may map a user's and/or device's environment using techniques referred to as “simultaneous location and mapping” (SLAM). SLAM mapping and location identifying techniques may involve a variety of hardware and software tools that can create or update a map of an environment while simultaneously keeping track of a user's location within the mapped environment. SLAM may use many different types of sensors to create a map and determine a user's position within the map.

SLAM techniques may, for example, implement optical sensors to determine a user's location. Radios including Wi-Fi, BLUETOOTH, global positioning system (GPS), cellular or other communication devices may be also used to determine a user's location relative to a radio transceiver or group of transceivers (e.g., a Wi-Fi router or group of GPS satellites). Acoustic sensors such as microphone arrays or 2D or 3D sonar sensors may also be used to determine a user's location within an environment. Augmented-reality and virtual-reality devices may incorporate any or all of these types of sensors to perform SLAM operations such as creating and continually updating maps of the user's current environment. In at least some of the embodiments described herein, SLAM data generated by these sensors may be referred to as “environmental data” and may indicate a user's current environment. This data may be stored in a local or remote data store (e.g., a cloud data store) and may be provided to a user's AR/VR device on demand.

When the user is wearing an augmented-reality headset or virtual-reality headset in a given environment, the user may be interacting with other users or other electronic devices that serve as audio sources. In some cases, it may be desirable to determine where the audio sources are located relative to the user and then present the audio sources to the user as if they were coming from the location of the audio source. The process of determining where the audio sources are located relative to the user may be referred to as “localization,” and the process of rendering playback of the audio source signal to appear as if it is coming from a specific direction may be referred to as “spatialization.”

Localizing an audio source may be performed in a variety of different ways. In some cases, an augmented-reality or virtual-reality headset may initiate a DOA analysis to determine the location of a sound source. The DOA analysis may include analyzing the intensity, spectra, and/or arrival time of each sound at the artificial-reality device to determine the direction from which the sounds originated. The DOA analysis may include any suitable algorithm for analyzing the surrounding acoustic environment in which the artificial reality device is located.

For example, the DOA analysis may be designed to receive input signals from a microphone and apply digital signal processing algorithms to the input signals to estimate the direction of arrival. These algorithms may include, for example, delay and sum algorithms where the input signal is sampled, and the resulting weighted and delayed versions of the sampled signal are averaged together to determine a direction of arrival. A least mean squared (LMS) algorithm may also be implemented to create an adaptive filter. This adaptive filter may then be used to identify differences in signal intensity, for example, or differences in time of arrival. These differences may then be used to estimate the direction of arrival. In another embodiment, the DOA may be determined by converting the input signals into the frequency domain and selecting specific bins within the time-frequency (TF) domain to process. Each selected TF bin may be processed to determine whether that bin includes a portion of the audio spectrum with a direct-path audio signal. Those bins having a portion of the direct-path signal may then be analyzed to identify the angle at which a microphone array received the direct-path audio signal. The determined angle may then be used to identify the direction of arrival for the received input signal. Other algorithms not listed above may also be used alone or in combination with the above algorithms to determine DOA.

In some embodiments, different users may perceive the source of a sound as coming from slightly different locations. This may be the result of each user having a unique head-related transfer function (HRTF), which may be dictated by a user's anatomy including ear canal length and the positioning of the ear drum. The artificial-reality device may provide an alignment and orientation guide, which the user may follow to customize the sound signal presented to the user based on their unique HRTF. In some embodiments, an artificial reality device may implement one or more microphones to listen to sounds within the user's environment. The augmented reality or virtual reality headset may use a variety of different array transfer functions (e.g., any of the DOA algorithms identified above) to estimate the direction of arrival for the sounds. Once the direction of arrival has been determined, the artificial-reality device may play back sounds to the user according to the user's unique HRTF. Accordingly, the DOA estimation generated using the array transfer function (ATF) may be used to determine the direction from which the sounds are to be played from. The playback sounds may be further refined based on how that specific user hears sounds according to the HRTF.

In addition to or as an alternative to performing a DOA estimation, an artificial-reality device may perform localization based on information received from other types of sensors. These sensors may include cameras, IR sensors, heat sensors, motion sensors, GPS receivers, or in some cases, sensors that detect a user's eye movements. For example, as noted above, an artificial-reality device may include an eye tracker or gaze detector that determines where the user is looking. Often, the user's eyes will look at the source of the sound, if only briefly. Such clues provided by the user's eyes may further aid in determining the location of a sound source. Other sensors such as cameras, heat sensors, and IR sensors may also indicate the location of a user, the location of an electronic device, or the location of another sound source. Any or all of the above methods may be used individually or in combination to determine the location of a sound source and may further be used to update the location of a sound source over time.

Some embodiments may implement the determined DOA to generate a more customized output audio signal for the user. For instance, an “acoustic transfer function” may characterize or define how a sound is received from a given location. More specifically, an acoustic transfer function may define the relationship between parameters of a sound at its source location and the parameters by which the sound signal is detected (e.g., detected by a microphone array or detected by a user's ear). An artificial-reality device may include one or more acoustic sensors that detect sounds within range of the device. A controller of the artificial-reality device may estimate a DOA for the detected sounds (using, e.g., any of the methods identified above) and, based on the parameters of the detected sounds, may generate an acoustic transfer function that is specific to the location of the device. This customized acoustic transfer function may thus be used to generate a spatialized output audio signal where the sound is perceived as coming from a specific location.

Indeed, once the location of the sound source or sources is known, the artificial-reality device may re-render (i.e., spatialize) the sound signals to sound as if coming from the direction of that sound source. The artificial-reality device may apply filters or other digital signal processing that alter the intensity, spectra, or arrival time of the sound signal. The digital signal processing may be applied in such a way that the sound signal is perceived as originating from the determined location. The artificial-reality device may amplify or subdue certain frequencies or change the time that the signal arrives at each ear. In some cases, the artificial-reality device may create an acoustic transfer function that is specific to the location of the device and the detected direction of arrival of the sound signal. In some embodiments, the artificial-reality device may re-render the source signal in a stereo device or multi-speaker device (e.g., a surround sound device). In such cases, separate and distinct audio signals may be sent to each speaker. Each of these audio signals may be altered according to the user's HRTF and according to measurements of the user's location and the location of the sound source to sound as if they are coming from the determined location of the sound source. Accordingly, in this manner, the artificial-reality device (or speakers associated with the device) may re-render an audio signal to sound as if originating from a specific location.

In some embodiments, the systems described herein may also include an eye-tracking subsystem designed to identify and track various characteristics of a user's eye(s), such as the user's gaze direction. The phrase “eye tracking” may, in some examples, refer to a process by which the position, orientation, and/or motion of an eye is measured, detected, sensed, determined, and/or monitored. The disclosed systems may measure the position, orientation, and/or motion of an eye in a variety of different ways, including through the use of various optical-based eye-tracking techniques, ultrasound-based eye-tracking techniques, etc. An eye-tracking subsystem may be configured in a number of different ways and may include a variety of different eye-tracking hardware components or other computer-vision components. For example, an eye-tracking subsystem may include a variety of different optical sensors, such as two-dimensional (2D) or 3D cameras, time-of-flight depth sensors, single-beam or sweeping laser rangefinders, 3D LiDAR sensors, and/or any other suitable type or form of optical sensor. In this example, a processing subsystem may process data from one or more of these sensors to measure, detect, determine, and/or otherwise monitor the position, orientation, and/or motion of the user's eye(s).

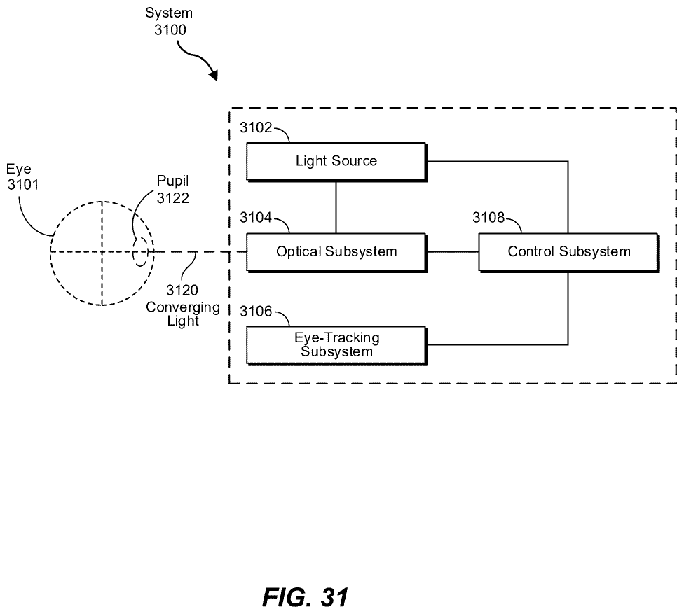

FIG. 31 is an illustration of an example system 3100 that incorporates an eye-tracking subsystem capable of tracking a user's eye(s). As depicted in FIG. 31, system 3100 may include a light source 3102, an optical subsystem 3104, an eye-tracking subsystem 3106, and/or a control subsystem 3108. In some examples, light source 3102 may generate light for an image (e.g., to be presented to an eye 3101 of the viewer). Light source 3102 may represent any of a variety of suitable devices. For example, light source 3102 can include a two-dimensional projector (e.g., a LCoS display), a scanning source (e.g., a scanning laser), or other device (e.g., an LCD, an LED display, an OLED display, an active-matrix OLED display (AMOLED), a transparent OLED display (TOLED), a waveguide, or some other display capable of generating light for presenting an image to the viewer). In some examples, the image may represent a virtual image, which may refer to an optical image formed from the apparent divergence of light rays from a point in space, as opposed to an image formed from the light ray's actual divergence.

In some embodiments, optical subsystem 3104 may receive the light generated by light source 3102 and generate, based on the received light, converging light 3120 that includes the image. In some examples, optical subsystem 3104 may include any number of lenses (e.g., Fresnel lenses, convex lenses, concave lenses), apertures, filters, mirrors, prisms, and/or other optical components, possibly in combination with actuators and/or other devices. In particular, the actuators and/or other devices may translate and/or rotate one or more of the optical components to alter one or more aspects of converging light 3120. Further, various mechanical couplings may serve to maintain the relative spacing and/or the orientation of the optical components in any suitable combination.

In one embodiment, eye-tracking subsystem 3106 may generate tracking information indicating a gaze angle of an eye 3101 of the viewer. In this embodiment, control subsystem 3108 may control aspects of optical subsystem 3104 (e.g., the angle of incidence of converging light 3120) based at least in part on this tracking information. Additionally, in some examples, control subsystem 3108 may store and utilize historical tracking information (e.g., a history of the tracking information over a given duration, such as the previous second or fraction thereof) to anticipate the gaze angle of eye 3101 (e.g., an angle between the visual axis and the anatomical axis of eye 3101). In some embodiments, eye-tracking subsystem 3106 may detect radiation emanating from some portion of eye 3101 (e.g., the cornea, the iris, the pupil, or the like) to determine the current gaze angle of eye 3101. In other examples, eye-tracking subsystem 3106 may employ a wavefront sensor to track the current location of the pupil.

Any number of techniques can be used to track eye 3101. Some techniques may involve illuminating eye 3101 with infrared light and measuring reflections with at least one optical sensor that is tuned to be sensitive to the infrared light. Information about how the infrared light is reflected from eye 3101 may be analyzed to determine the position(s), orientation(s), and/or motion(s) of one or more eye feature(s), such as the cornea, pupil, iris, and/or retinal blood vessels.

In some examples, the radiation captured by a sensor of eye-tracking subsystem 3106 may be digitized (i.e., converted to an electronic signal). Further, the sensor may transmit a digital representation of this electronic signal to one or more processors (for example, processors associated with a device including eye-tracking subsystem 3106). Eye-tracking subsystem 3106 may include any of a variety of sensors in a variety of different configurations. For example, eye-tracking subsystem 3106 may include an infrared detector that reacts to infrared radiation. The infrared detector may be a thermal detector, a photonic detector, and/or any other suitable type of detector. Thermal detectors may include detectors that react to thermal effects of the incident infrared radiation.

In some examples, one or more processors may process the digital representation generated by the sensor(s) of eye-tracking subsystem 3106 to track the movement of eye 3101. In another example, these processors may track the movements of eye 3101 by executing algorithms represented by computer-executable instructions stored on non-transitory memory. In some examples, on-chip logic (e.g., an application-specific integrated circuit or ASIC) may be used to perform at least portions of such algorithms. As noted, eye-tracking subsystem 3106 may be programmed to use an output of the sensor(s) to track movement of eye 3101. In some embodiments, eye-tracking subsystem 3106 may analyze the digital representation generated by the sensors to extract eye rotation information from changes in reflections. In one embodiment, eye-tracking subsystem 3106 may use corneal reflections or glints (also known as Purkinje images) and/or the center of the eye's pupil 3122 as features to track over time.

In some embodiments, eye-tracking subsystem 3106 may use the center of the eye's pupil 3122 and infrared or near-infrared, non-collimated light to create corneal reflections. In these embodiments, eye-tracking subsystem 3106 may use the vector between the center of the eye's pupil 3122 and the corneal reflections to compute the gaze direction of eye 3101. In some embodiments, the disclosed systems may perform a calibration procedure for an individual (using, e.g., supervised or unsupervised techniques) before tracking the user's eyes. For example, the calibration procedure may include directing users to look at one or more points displayed on a display while the eye-tracking system records the values that correspond to each gaze position associated with each point.

In some embodiments, eye-tracking subsystem 3106 may use two types of infrared and/or near-infrared (also known as active light) eye-tracking techniques: bright-pupil and dark-pupil eye tracking, which may be differentiated based on the location of an illumination source with respect to the optical elements used. If the illumination is coaxial with the optical path, then eye 3101 may act as a retroreflector as the light reflects off the retina, thereby creating a bright pupil effect similar to a red-eye effect in photography. If the illumination source is offset from the optical path, then the eye's pupil 3122 may appear dark because the retroreflection from the retina is directed away from the sensor. In some embodiments, bright-pupil tracking may create greater iris/pupil contrast, allowing more robust eye tracking with iris pigmentation, and may feature reduced interference (e.g., interference caused by eyelashes and other obscuring features). Bright-pupil tracking may also allow tracking in lighting conditions ranging from total darkness to a very bright environment.

In some embodiments, control subsystem 3108 may control light source 3102 and/or optical subsystem 3104 to reduce optical aberrations (e.g., chromatic aberrations and/or monochromatic aberrations) of the image that may be caused by or influenced by eye 3101. In some examples, as mentioned above, control subsystem 3108 may use the tracking information from eye-tracking subsystem 3106 to perform such control. For example, in controlling light source 3102, control subsystem 3108 may alter the light generated by light source 3102 (e.g., by way of image rendering) to modify (e.g., pre-distort) the image so that the aberration of the image caused by eye 3101 is reduced.

The disclosed systems may track both the position and relative size of the pupil (since, e.g., the pupil dilates and/or contracts). In some examples, the eye-tracking devices and components (e.g., sensors and/or sources) used for detecting and/or tracking the pupil may be different (or calibrated differently) for different types of eyes. For example, the frequency range of the sensors may be different (or separately calibrated) for eyes of different colors and/or different pupil types, sizes, and/or the like. As such, the various eye-tracking components (e.g., infrared sources and/or sensors) described herein may need to be calibrated for each individual user and/or eye.

The disclosed systems may track both eyes with and without ophthalmic correction, such as that provided by contact lenses worn by the user. In some embodiments, ophthalmic correction elements (e.g., adjustable lenses) may be directly incorporated into the artificial reality systems described herein. In some examples, the color of the user's eye may necessitate modification of a corresponding eye-tracking algorithm. For example, eye-tracking algorithms may need to be modified based at least in part on the differing color contrast between a brown eye and, for example, a blue eye.

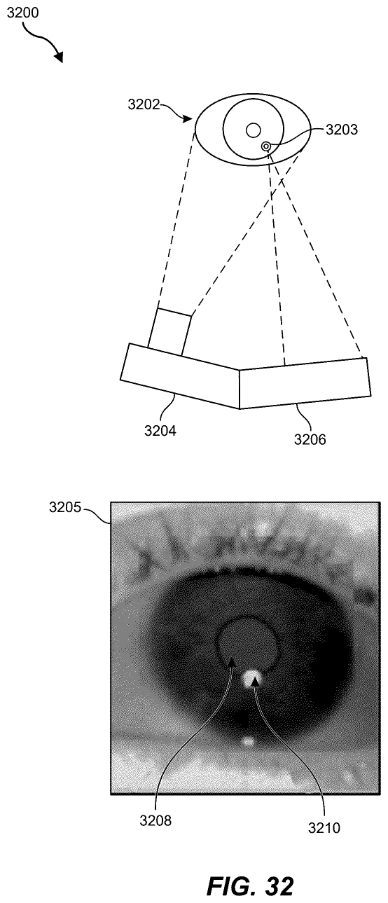

FIG. 32 is a more detailed illustration of various aspects of the eye-tracking subsystem illustrated in FIG. 31. As shown in this figure, an eye-tracking subsystem 3200 may include at least one source 3204 and at least one sensor 3206. Source 3204 generally represents any type or form of element capable of emitting radiation. In one example, source 3204 may generate visible, infrared, and/or near-infrared radiation. In some examples, source 3204 may radiate non-collimated infrared and/or near-infrared portions of the electromagnetic spectrum towards an eye 3202 of a user. Source 3204 may utilize a variety of sampling rates and speeds. For example, the disclosed systems may use sources with higher sampling rates in order to capture fixational eye movements of a user's eye 3202 and/or to correctly measure saccade dynamics of the user's eye 3202. As noted above, any type or form of eye-tracking technique may be used to track the user's eye 3202, including optical-based eye-tracking techniques, ultrasound-based eye-tracking techniques, etc.

Sensor 3206 generally represents any type or form of element capable of detecting radiation, such as radiation reflected off the user's eye 3202. Examples of sensor 3206 include, without limitation, a charge coupled device (CCD), a photodiode array, a complementary metal-oxide-semiconductor (CMOS) based sensor device, and/or the like. In one example, sensor 3206 may represent a sensor having predetermined parameters, including, but not limited to, a dynamic resolution range, linearity, and/or other characteristic selected and/or designed specifically for eye tracking.

As detailed above, eye-tracking subsystem 3200 may generate one or more glints. As detailed above, a glint 3203 may represent reflections of radiation (e.g., infrared radiation from an infrared source, such as source 3204) from the structure of the user's eye. In various embodiments, glint 3203 and/or the user's pupil may be tracked using an eye-tracking algorithm executed by a processor (either within or external to an artificial reality device). For example, an artificial reality device may include a processor and/or a memory device in order to perform eye tracking locally and/or a transceiver to send and receive the data necessary to perform eye tracking on an external device (e.g., a mobile phone, cloud server, or other computing device).

FIG. 32 shows an example image 3205 captured by an eye-tracking subsystem, such as eye-tracking subsystem 3200. In this example, image 3205 may include both the user's pupil 3208 and a glint 3210 near the same. In some examples, pupil 3208 and/or glint 3210 may be identified using an artificial-intelligence-based algorithm, such as a computer-vision-based algorithm. In one embodiment, image 3205 may represent a single frame in a series of frames that may be analyzed continuously in order to track the eye 3202 of the user. Further, pupil 3208 and/or glint 3210 may be tracked over a period of time to determine a user's gaze.

In one example, eye-tracking subsystem 3200 may be configured to identify and measure the inter-pupillary distance (IPD) of a user. In some embodiments, eye-tracking subsystem 3200 may measure and/or calculate the IPD of the user while the user is wearing the artificial reality system. In these embodiments, eye-tracking subsystem 3200 may detect the positions of a user's eyes and may use this information to calculate the user's IPD.

As noted, the eye-tracking systems or subsystems disclosed herein may track a user's eye position and/or eye movement in a variety of ways. In one example, one or more light sources and/or optical sensors may capture an image of the user's eyes. The eye-tracking subsystem may then use the captured information to determine the user's inter-pupillary distance, interocular distance, and/or a 3D position of each eye (e.g., for distortion adjustment purposes), including a magnitude of torsion and rotation (i.e., roll, pitch, and yaw) and/or gaze directions for each eye. In one example, infrared light may be emitted by the eye-tracking subsystem and reflected from each eye. The reflected light may be received or detected by an optical sensor and analyzed to extract eye rotation data from changes in the infrared light reflected by each eye.

The eye-tracking subsystem may use any of a variety of different methods to track the eyes of a user. For example, a light source (e.g., infrared light-emitting diodes) may emit a dot pattern onto each eye of the user. The eye-tracking subsystem may then detect (e.g., via an optical sensor coupled to the artificial reality system) and analyze a reflection of the dot pattern from each eye of the user to identify a location of each pupil of the user. Accordingly, the eye-tracking subsystem may track up to six degrees of freedom of each eye (i.e., 3D position, roll, pitch, and yaw) and at least a subset of the tracked quantities may be combined from two eyes of a user to estimate a gaze point (i.e., a 3D location or position in a virtual scene where the user is looking) and/or an IPD.

In some cases, the distance between a user's pupil and a display may change as the user's eye moves to look in different directions. The varying distance between a pupil and a display as viewing direction changes may be referred to as “pupil swim” and may contribute to distortion perceived by the user as a result of light focusing in different locations as the distance between the pupil and the display changes. Accordingly, measuring distortion at different eye positions and pupil distances relative to displays and generating distortion corrections for different positions and distances may allow mitigation of distortion caused by pupil swim by tracking the 3D position of a user's eyes and applying a distortion correction corresponding to the 3D position of each of the user's eyes at a given point in time. Thus, knowing the 3D position of each of a user's eyes may allow for the mitigation of distortion caused by changes in the distance between the pupil of the eye and the display by applying a distortion correction for each 3D eye position. Furthermore, as noted above, knowing the position of each of the user's eyes may also enable the eye-tracking subsystem to make automated adjustments for a user's IPD.

In some embodiments, a display subsystem may include a variety of additional subsystems that may work in conjunction with the eye-tracking subsystems described herein. For example, a display subsystem may include a varifocal subsystem, a scene-rendering module, and/or a vergence-processing module. The varifocal subsystem may cause left and right display elements to vary the focal distance of the display device. In one embodiment, the varifocal subsystem may physically change the distance between a display and the optics through which it is viewed by moving the display, the optics, or both. Additionally, moving or translating two lenses relative to each other may also be used to change the focal distance of the display. Thus, the varifocal subsystem may include actuators or motors that move displays and/or optics to change the distance between them. This varifocal subsystem may be separate from or integrated into the display subsystem. The varifocal subsystem may also be integrated into or separate from its actuation subsystem and/or the eye-tracking subsystems described herein.

In one example, the display subsystem may include a vergence-processing module configured to determine a vergence depth of a user's gaze based on a gaze point and/or an estimated intersection of the gaze lines determined by the eye-tracking subsystem. Vergence may refer to the simultaneous movement or rotation of both eyes in opposite directions to maintain single binocular vision, which may be naturally and automatically performed by the human eye. Thus, a location where a user's eyes are verged is where the user is looking and is also typically the location where the user's eyes are focused. For example, the vergence-processing module may triangulate gaze lines to estimate a distance or depth from the user associated with intersection of the gaze lines. The depth associated with intersection of the gaze lines may then be used as an approximation for the accommodation distance, which may identify a distance from the user where the user's eyes are directed. Thus, the vergence distance may allow for the determination of a location where the user's eyes should be focused and a depth from the user's eyes at which the eyes are focused, thereby providing information (such as an object or plane of focus) for rendering adjustments to the virtual scene.

The vergence-processing module may coordinate with the eye-tracking subsystems described herein to make adjustments to the display subsystem to account for a user's vergence depth. When the user is focused on something at a distance, the user's pupils may be slightly farther apart than when the user is focused on something close. The eye-tracking subsystem may obtain information about the user's vergence or focus depth and may adjust the display subsystem to be closer together when the user's eyes focus or verge on something close and to be farther apart when the user's eyes focus or verge on something at a distance.

The eye-tracking information generated by the above-described eye-tracking subsystems may also be used, for example, to modify various aspect of how different computer-generated images are presented. For example, a display subsystem may be configured to modify, based on information generated by an eye-tracking subsystem, at least one aspect of how the computer-generated images are presented. For instance, the computer-generated images may be modified based on the user's eye movement, such that if a user is looking up, the computer-generated images may be moved upward on the screen. Similarly, if the user is looking to the side or down, the computer-generated images may be moved to the side or downward on the screen. If the user's eyes are closed, the computer-generated images may be paused or removed from the display and resumed once the user's eyes are back open.

The above-described eye-tracking subsystems can be incorporated into one or more of the various artificial reality systems described herein in a variety of ways. For example, one or more of the various components of system 3100 and/or eye-tracking subsystem 3200 may be incorporated into any of the augmented-reality systems in and/or virtual-reality systems described herein in to enable these systems to perform various eye-tracking tasks (including one or more of the eye-tracking operations described herein).

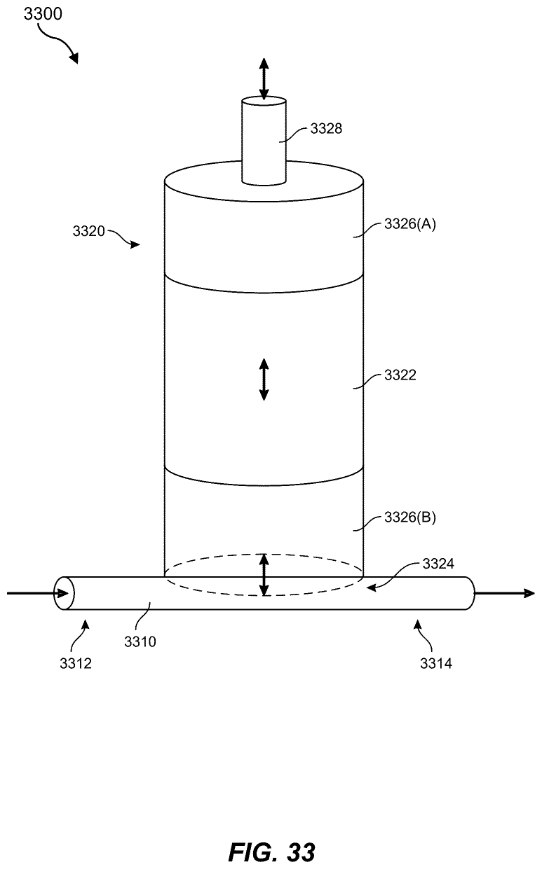

As noted above, the present disclosure may also include haptic fluidic systems that involve the control (e.g., stopping, starting, restricting, increasing, etc.) of fluid flow through a fluid channel. The control of fluid flow may be accomplished with a fluidic valve. FIG. 33 shows a schematic diagram of a fluidic valve 3300 for controlling flow through a fluid channel 3310, according to at least one embodiment of the present disclosure. Fluid from a fluid source (e.g., a pressurized fluid source, a fluid pump, etc.) may flow through the fluid channel 3310 from an inlet port 3312 to an outlet port 3314, which may be operably coupled to, for example, a fluid-driven mechanism, another fluid channel, or a fluid reservoir.

Fluidic valve 3300 may include a gate 3320 for controlling the fluid flow through fluid channel 3310. Gate 3320 may include a gate transmission element 3322, which may be a movable component that is configured to transmit an input force, pressure, or displacement to a restricting region 3324 to restrict or stop flow through the fluid channel 3310. Conversely, in some examples, application of a force, pressure, or displacement to gate transmission element 3322 may result in opening restricting region 3324 to allow or increase flow through the fluid channel 3310. The force, pressure, or displacement applied to gate transmission element 3322 may be referred to as a gate force, gate pressure, or gate displacement. Gate transmission element 3322 may be a flexible element (e.g., an elastomeric membrane, a diaphragm, etc.), a rigid element (e.g., a movable piston, a lever, etc.), or a combination thereof (e.g., a movable piston or a lever coupled to an elastomeric membrane or diaphragm).

As illustrated in FIG. 33, gate 3320 of fluidic valve 3300 may include one or more gate terminals, such as an input gate terminal 3326(A) and an output gate terminal 3326(B) (collectively referred to herein as “gate terminals 3326”) on opposing sides of gate transmission element 3322. Gate terminals 3326 may be elements for applying a force (e.g., pressure) to gate transmission element 3322. By way of example, gate terminals 3326 may each be or include a fluid chamber adjacent to gate transmission element 3322. Alternatively or additionally, one or more of gate terminals 3326 may include a solid component, such as a lever, screw, or piston, that is configured to apply a force to gate transmission element 3322.

In some examples, a gate port 3328 may be in fluid communication with input gate terminal 3326(A) for applying a positive or negative fluid pressure within the input gate terminal 3326(A). A control fluid source (e.g., a pressurized fluid source, a fluid pump, etc.) may be in fluid communication with gate port 3328 to selectively pressurize and/or depressurize input gate terminal 3326(A). In additional embodiments, a force or pressure may be applied at the input gate terminal 3326(A) in other ways, such as with a piezoelectric element or an electromechanical actuator, etc.

In the embodiment illustrated in FIG. 33, pressurization of the input gate terminal 3326(A) may cause the gate transmission element 3322 to be displaced toward restricting region 3324, resulting in a corresponding pressurization of output gate terminal 3326(B). Pressurization of output gate terminal 3326(B) may, in turn, cause restricting region 3324 to partially or fully restrict to reduce or stop fluid flow through the fluid channel 3310. Depressurization of input gate terminal 3326(A) may cause gate transmission element 3322 to be displaced away from restricting region 3324, resulting in a corresponding depressurization of the output gate terminal 3326(B). Depressurization of output gate terminal 3326(B) may, in turn, cause restricting region 3324 to partially or fully expand to allow or increase fluid flow through fluid channel 3310. Thus, gate 3320 of fluidic valve 3300 may be used to control fluid flow from inlet port 3312 to outlet port 3314 of fluid channel 3310.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A plurality of computer-implemented methods comprising:
a method for client-side route computation using a partitioned, non-atomic way comprising:
retrieving partitions from a network;
retrieving ways and nodes from a partition; and
routing on a partitioned routing graph;
a method for server-side partitioned computation of z-curve-based polyline circle covers for a road network comprising:
creating partitions and assigning roads to partitions;
building circle covers and a z-curve index; and
processing via a cloud processor and delivering to clients via the network;
a method for generating and positioning interactive virtual trophies in artificial reality environments comprising:
generating, based on an achievement by a first user in a software application, a virtual trophy that is unique to the achievement;
providing a virtual environment to the first user through a first device;
receiving an input from the first user, the input comprising a location within the virtual environment;
in response to receiving the input, positioning the virtual trophy within the virtual environment at the location within the virtual environment; and
providing the virtual environment to a second user through a second device, wherein the first user and the second user both perceive the virtual trophy to be positioned at the location within the virtual environment;
a method for interactive spatial reasoning-based mixed reality scene generation comprising:
generating, using a trained scene reasoning model, an initial scene prompt corresponding to an input intention;
generating, using a trained intention prediction model, a refined scene prompt, the refined scene prompt comprising an adjustment to the initial scene prompt;
and placing, using the refined scene prompt, a virtual object in a virtual scene; or
a method for biometric authentication comprising:
capturing image data encoding polarization contrast;
analyzing the polarization contrast to identify a pattern associated with internal structural features of a skin of a user; and
verifying an identity of the user based on comparing the identified pattern with a biometric profile of the user.

2. The method of claim 1, wherein the input is a first input and the location is a first location, the method further comprising:
receiving a second input from the first user, the second input comprising a second location within the virtual environment; and
in response to receiving the second input, positioning the virtual trophy within the virtual environment at the second location within the virtual environment, wherein the first user and the second user both perceive the virtual trophy to be positioned at the second location within the virtual environment.

3. The method of claim 1, wherein the virtual environment is a virtual reality environment.

4. The method of claim 1, wherein the virtual environment is a mixed reality environment.

5. The method of claim 1, wherein the location is a fixed location within the virtual environment.

6. The method of claim 1, wherein the location is a changing location within the virtual environment.

7. The method of claim 6, wherein the location is attached to an avatar of the first user, and the virtual trophy is a wearable item by the avatar of the first user.

8. The method of claim 1, further comprising:
providing the virtual environment to a third user through a third device;
receiving a particular interaction of the third user with the virtual trophy; and
in response to the particular interaction, performing a particular action from a plurality of actions associated with the trophy.

9. The method of claim 8, wherein the interaction comprises an interaction between an avatar of the third user within the virtual environment and the virtual trophy.

10. The method of claim 8, wherein the plurality of actions associated with the trophy comprise showing a video to the third user illustrating how the first user obtained the achievement to earn the virtual trophy.

11. The method of claim 8, wherein the plurality of actions associated with the trophy comprise determining that the third user has installed the software application on the third device, and based on that determination, launching the software application on the third device.

12. The method of claim 8, wherein the plurality of actions associated with the trophy comprise determining that the third user does not have access to the software application and based on that determination, launching a marketplace to provide the software application to the third user to install on the third device.

13. The method of claim 1, wherein the virtual trophy is generated by the software application in the virtual environment using an application programming interface.

14. A system configured for generating and positioning interactive virtual trophies in artificial reality environments, comprising:
a processor;
a memory coupled with the processor; and
instructions stored in the memory and executable by the processor, the instructions including:
instructions for client-side route computation using a partitioned, non-atomic way that cause the system to:
retrieve partitions from a network;
retrieve ways and nodes from a partition; and
route on a partitioned routing graph;
instructions for server-side partitioned computation of z-curve-based polyline circle covers for a road network that cause the system to:
create partitions and assigning roads to partitions;
build circle covers and a z-curve index; and
process via a cloud processor and delivering to clients via the network;
instructions for generating and positioning interactive virtual trophies in artificial reality environments that cause the system to:
generate, based on an achievement by a first user in a software application, a virtual trophy that is unique to the achievement;
provide a virtual environment to the first user through a first device;
receive an input from the first user, the input comprising a location within the virtual environment;
position the virtual trophy within the virtual environment at the location in response to receiving the input; and
provide the virtual environment to a second user through a second device, wherein the first user and the second user both perceive the virtual trophy to be positioned at the location within the virtual environment;
instructions for interactive spatial reasoning-based mixed reality scene generation that cause the system to:
generate, using a trained scene reasoning model, an initial scene prompt corresponding to an input intention;
generate, using a trained intention prediction model, a refined scene prompt, the refined scene prompt comprising an adjustment to the initial scene prompt; and
place, using the refined scene prompt, a virtual object in a virtual scene; or
instructions for biometric authentication that cause the system to:
capture image data encoding polarization contrast;
analyze the polarization contrast to identify a pattern associated with internal structural features of a skin of a user; and
verify an identity of the user based on comparing the identified pattern with a biometric profile of the user.

15. The system of claim 14, wherein the instructions are further executable by the processor to cause the system to receive a second input from the first user, the second input comprising a second location within the virtual environment, and in response to receiving the second input, position the virtual trophy within the virtual environment at the second location, wherein the first user and the second user both perceive the virtual trophy to be positioned at the second location within the virtual environment.

16. The system of claim 14, wherein the location is a fixed location within the virtual environment.

17. The system of claim 14, wherein the location is a changing location within the virtual environment.

18. A polarization camera comprising:
an image sensor configured to capture image data from at least one portion of a user's skin;
a processing unit configured to process the image data to identify a pattern associated with structural characteristics of the user's skin; and
an output module configured to initiate an action based on the identified pattern determined by the processing unit.

19. The polarization camera of claim 18, further comprising a polarization-sensitive image sensor configured to face away from the user.

20. The polarization camera of claim 19, wherein the polarization-sensitive image sensor is configured to capture image data from an external field of view.
